(19) United States
(12) Patent Application Publication
(10) Pub. No.: US 2004/0090950 A1
(43) Pub. Date: May 13, 2004

(54) Wireless digital/analog data telemetry system adapted for use with web based location information distribution method and method for developing and disseminating information for use therewith

(76) Inventors: Ronald Lauber, Medina, OH (US); Charles Legree, Parma, OH (US); Edward Eyerdom, Medina, OH (US); Donald Kruse, Wickliffe, OH (US); Todd Hunt, Columbus, OH (US); Feng Xiao, Weston, FL (US)

Correspondence Address: Thomas P.Liniak, Liniak, Berenato & White, Suite 240, 6550 Rock Spring Drive, Bethesda, MD, 20817, US

(21) Appl. No.: 10/666,743

(22) Filed: Sep. 22, 2003

Related U.S. Application Data
(60) Provisional application No. 60/412,011, filed on Sep. 20, 2002.

(51) Int. Cl. H04L 12/66; H04L 12/28; H04L 12/56

(52) U.S. Cl. 370/352; 370/401

(57) ABSTRACT

An economical, compact digital/analog wireless data telemetry system includes either an analog transceiver or a digital packet data (e.g. CDPD) unit coupled with a portable computing device to provide a Mobile Data messaging and location device. The wireless data telemetry system is well suited for use in many possible applications, one application, vehicle location, provides an exemplary embodiment. In broadest terms, the system utilizes a plurality of analog RF channels for transmitting Mobile Data Packet Protocol (MDPP) packets between a tower site controller or remote base and number of mobile data units. The radio links between the tower site and the mobile data units are full duplex analog RF data transmission links utilizing full duplex receivers and transmitters at each installation. The operation of the combination of elements is the novel focus of the present invention. Particularly, the mobile data unit includes a main unit comprising RF and data boards and connections for an external GPS receiver and an RF antenna for transmission of data telemetry packets to a base station. The base or dispatch station receives data in MDPP format from a plurality of mobile units and organizes that information into a database which can be readily stored and manipulated in a central web site server for access by users or customers.

### RELATED APPLICATION INFORMATION

This application claims benefit of Provisional application No. 60/412,011, filed on Sep. 20^{th}, 2002, entitled “Wireless Digital/Analog Data Telemetry System Adapted for use with Web Based Location Information Distribution Method and Method for Developing and Disseminating Information for use therewith”, the entire disclosure of which is incorporated herein by reference.

### BACKGROUND OF THE INVENTION

### Computer Program Listing Appendices

A computer program listing appendix is submitted herewith on compact disc recordable (CD-R) as Appendix A. The material on the compact disc is incorporated herein by reference. Duplicate copies of Appendix A are provided as Copy 1 and Copy 2,

The files on each disc of Appendix A are identical, and are as follows:

| File Name: | Size in Bytes: | Date of Creation: |
|---|---|---|
| 1.txt | 36,858 | Aug. 22, 2002 |
| 2.txt | 693,278 | Aug. 22, 2002 |
| 3.txt | 127,449 | Aug. 22, 2002 |
| 4.txt | 15,371 | Aug. 22, 2002 |
| 5.txt | 507,744 | Aug. 22, 2002 |
| 6.txt | 73,250 | Aug. 22, 2002 |
| 7.txt | 290,195 | Aug. 22, 2002 |
| 8.txt | 265,419 | Aug. 22, 2002 |

A second computer program listing appendix is submitted herewith on compact disc recordable (CD-R) as Appendix B. The material on the compact disc is incorporated herein by reference. Duplicate copies of Appendix B are provided as Copy 1 and Copy 2,

The files on each disc of Appendix B are identical, and are as follows:

| File Name: | Size in Bytes: | Date of Creation: |
|---|---|---|
| clsResize.bas.txt | 2,693 | Sep. 30, 2000 |
| cls.XPMenu.bas.txt | 11,098 | Jan. 17, 2002 |
| dispData.bas.txt | 3,921 | Apr. 18, 2003 |
| form1.bas.txt | 1,244 | Aug. 14, 2001 |
| formsWindow.bas.txt | 1,350 | Mar. 21, 2003 |
| frmABList.bas.txt | 2,761 | Mar. 10, 2003 |
| frmAutoHideMessage.bas.txt | 2,175 | Mar. 10, 2003 |
| frmCompressedTemp.bas.txt | 1,523 | Mar. 10, 2003 |
| frmConfig.bas.txt | 1,617 | Mar. 10, 2003 |
| frmCrap.bas.txt | 4,988 | May 21, 2003 |
| frmDBError.bas.txt | 2,789 | Jul. 2, 2003 |
| frmDefSave.bas.txt | 3,754 | Apr. 5, 2002 |
| frmDownload.bas.txt | 1,928 | Mar. 10, 2003 |
| frmFormDef.bas.txt | 98,070 | Apr. 2, 2002 |
| frmFormDefImport.bas.txt | 19,957 | Apr. 15, 2002 |
| FrmFormDefNew.bas.txt | 28,974 | Oct. 23, 2002 |
| frmFormNew.bas.txt | 62,980 | Sep. 20, 2002 |
| frmForms.bas.txt | 85,733 | Sep. 26, 2002 |
| frmFormSendDef.bas.txt | 7,439 | Jan. 17, 2002 |
| frmFormSendDefNew.bas.txt | 15,727 | Oct. 23, 2002 |
| frmGeoFence.bas.txt | 8,177 | May 27, 2003 |
| frmGPS.bas.txt | 55,928 | Jan. 17, 2002 |
| frmGPSnew.bas.txt | 101,701 | May 27, 2003 |
| frmGPSPW.bas.txt | 95,216 | Mar. 10, 2003 |
| frmGPSReq.bas.txt | 5,375 | Mar. 10, 2003 |
| frmLogs.bas.txt | 85,982 | Jul. 23, 2003 |
| frmLogs2.bas.txt | 80,062 | May 15, 2003 |
| frmLogTest.bas.txt | 1,319 | Mar. 24, 2003 |
| frmMain.bas.txt | 25,318 | Dec. 17, 2002 |
| frmMain2.bas.txt | 35,387 | Jul. 23, 2003 |
| frmMaintAge.bas.txt | 3,488 | Mar. 11, 2003 |
| frmMaintList.bas.txt | 2,347 | Mar. 10, 2003 |
| ffmMapWait.bas.txt | 1,072 | Jun. 14, 2001 |
| frmMileage.bas.txt | 15,295 | Mar. 10, 2003 |
| frmMileage2.bas.txt | 641 | Jun. 3, 2003 |
| frmNetCfg.bas.txt | 6,401 | Mar. 18, 2003 |
| frmNetMSG.bas.txt | 7,229 | Aug. 15, 2001 |
| frmNewMSG.bas.txt | 8,132 | Mar. 10, 2003 |
| frmRawlO.bas.txt | 2,348 | Mar. 10, 2003 |
| frmReportsSetup.bas.txt | 10,450 | Jul. 23, 2003 |
| frmTempSensorNames.bas.txt | 3,513 | Mar. 19, 2003 |
| frmTempStatus.bas.txt | 2,361 | Mar. 10, 2003 |
| frmViewInbox.bas.txt | 13,541 | Mar. 10, 2003 |
| frmViewOutbox.bas.txt | 13,139 | Mar. 10, 2003 |
| frmWait.bas.txt | 1,204 | Mar. 10, 2003 |
| frmWskDebug.bas.txt | 3,902 | Mar. 10, 2003 |
| frmXPMenu.bas.txt | 5,082 | Jun. 19, 2002 |
| MDData.bas.txt | 3,381 | Aug. 15, 2001 |
| modCommonFunctions.bas.txt | 2,633 | Feb. 14, 2002 |
| modFunctions.bas.txt | 8,567 | Apr. 15, 2003 |
| modHelper.bas.txt | 3,918 | Jun. 3, 2003 |
| modMain.bas.txt | 3,312 | May 13, 2003 |
| modNet.bas.txt | 11,656 | Mar. 6, 2003 |
| modPW.bas.txt | 2,858 | Feb. 4, 2003 |
| modVariable.bas.txt | 4,744 | May 13, 2003 |
| objPacket.bas.txt | 67,544 | Jul. 17, 2003 |
| tamper.txt | 24,965 | Jul. 23, 2003 |

A third computer program listing appendix is submitted herewith on compact disc recordable (CD-R) as Appendix C. The material on the compact disc is incorporated herein by reference. Duplicate copies of Appendix C are provided as Copy 1 and Copy 2,

The files on each disc of Appendix C are identical, and are as follows:

| File Name: | Size in Bytes: | Date of Creation: |
|---|---|---|
| clsCustData.cls.txt | 1,428 | Mar. 4, 2003 |
| clsCustDataStructure.cls.txt | 1,091 | Mar. 4, 2003 |
| clsPWPoint.cls.txt | 2,249 | Mar. 4, 2003 |
| clsTempPoint.cls.txt | 4,890 | Mar. 31, 2003 |
| clsUser.cls.txt | 3,721 | Mar. 4, 2003 |
| colCustData.cls.txt | 2,825 | Mar. 4, 2003 |
| dispData.cls.txt | 3,795 | Mar. 4, 2003 |
| FDData.cls.txt | 5,508 | Mar. 31, 2003 |
| FDData.cls.txt | 5,497 | Mar. 9, 2003 |
| FormsWindow.frm.txt | 1,314 | Mar. 4, 2003 |
| frmABList.frm.txt | 2,772 | Mar. 4, 2003 |
| frmAutoHideMessage.frm.txt | 2,064 | Mar. 4, 2003 |
| frmCapacity.frm.txt | 7,648 | Mar. 8, 2003 |
| frmCompressedTemp.frm.txt | 1,523 | Mar. 4, 2003 |
| frmConfig.frm.txt | 1,629 | Jun. 24, 2003 |
| frmConfigMIN.frm.txt | 9,670 | Mar. 8, 2003 |
| ffmCustTypeConfig.frm.txt | 6,198 | Mar. 8, 2003 |
| frmDownload.frm.txt | 1,939 | Mar. 4, 2003 |
| frmDriver.frm.txt | 6,518 | Mar. 4, 2003 |
| frmGeoFence.frm.txt | 8,165 | Jun. 8, 2003 |
| frmGPSnew.frm.txt | 101,701 | May 27, 2003 |
| frmGPSnew2.frm.txt | 100,945 | Jun. 19, 2003 |
| frmGPSPW.frm.txt | 94,676 | Jun. 5, 2003 |
| frmGPSReq.frm.txt | 5,386 | Jun. 24, 2003 |
| frmHover.frm.txt | 932 | Mar. 4, 2003 |
| frmImport.frm.txt | 10,761 | Mar. 11, 2003 |
| FrmImportTemp.frm.txt | 9,797 | Mar. 11, 2003 |
| frmLogin.frm.txt | 4,221 | May 14, 2003 |
| frmLogs.frm.txt | 85,340 | Jun. 9, 2003 |
| frmLogTest.frm.txt | 1,167 | Mar. 4, 2003 |
| frmMain2.frm.txt | 28,522 | Jun. 24, 2003 |
| frmMaintAge.frm.txt | 3,170 | Mar. 4, 2003 |
| frmMaintList.frm.txt | 4,948 | Mar. 4, 2003 |
| frmMileage.frm.txt | 15,306 | Mar. 4, 2003 |
| frmMinList.frm.txt | 25,447 | Jun. 25, 2003 |
| frmMinNotes.frm.txt | 1,963 | Mar. 8, 2003 |
| frmNetCfg.frm.txt | 6,514 | Mar. 4, 2003 |
| frmNewMSG.frm.txt | 8,143 | Jun. 24, 2003 |
| frmPoint.frm.txt | 499 | Mar. 4, 2003 |
| frmRawIO.frm.txt | 2,265 | Mar. 4, 2003 |
| frmReports.frm.txt | 42,357 | May 13, 2003 |
| frmRouteEdit.frm.txt | 5,787 | Nov. 22, 2002 |
| frmRouteNew.frm.txt | 4,464 | Jan. 29, 2003 |
| frmRoutePoint.frm.txt | 10,482 | Jan. 29, 2003 |
| frmRoutePoint.frm.txt | 34,000 | Mar. 20, 2003 |
| frmRouteSchedule.frm.txt | 27,764 | Apr. 30, 2003 |
| frmRouteSetup.frm.txt | 8,110 | Mar. 10, 2003 |
| frmRouteStatus.frm.txt | 48,694 | Jun. 20, 2003 |
| frmSetting.frm.txt | 18,566 | Apr. 7, 2003 |
| frmTempPoint.frm.txt | 16,790 | Mar. 31, 2003 |
| frmTempStatus.frm.txt | 2,372 | Mar. 4, 2003 |
| frmTEstGPSData.frm.txt | 11,130 | Apr. 17, 2003 |
| frmUserMan.frm.txt | 16,522 | May 14, 2003 |
| frmViewInbox.frm.txt | 13,552 | Jun. 24, 2003 |
| frmViewOutbox.frm.txt | 13,150 | Jun. 24, 2003 |
| frmWait.frm.txt | 1,204 | Mar. 4, 2003 |
| frmWskDebug.frm.txt | 3,913 | Mar. 4, 2003 |
| mDData.cls.txt | 5,359 | Jan. 27, 2003 |
| modCommonFunctions.bas.txt | 3,301 | Apr. 8, 2003 |
| modFunctions.bas.txt | 8,784 | Jun. 24, 2003 |
| modHelper.bas.txt | 2,235 | Jan. 29, 2003 |
| modMain.bas.txt | 3,049 | Jun. 16, 2003 |
| modNet.bas.txt | 11,775 | Jun. 24, 2003 |
| modNewCommon.bas.txt | 6,200 | Jun. 8, 2003 |
| modPW.bas.txt | 16,043 | Mar. 31, 2003 |
| modVariable.bas.txt | 5,173 | Jun. 5, 2003 |
| objPacket.cls.txt | 36,784 | Jun. 24, 2003 |

1. Field of the Invention

The present invention relates to transmission of data utilizing either analog Radio Frequency (RF) transceivers, or digital packet data/CDPD/GPRS wireless devices; and, more particularly, to a system and method for wireless data telemetry adapted for use with a location information distribution web site and a method for developing electronic forms and disseminating information over the wireless data telemetry system.

2. Discussion of the Prior Art

Infrared and radio frequency (RF) data transmission methods are the principal wireless communication technologies described in the prior art. Infrared beam communications systems cannot operate over distances of more than a few feet and so are limited to applications such as bar code scanning and television (or other home appliance) remote control.

As a result, most of the prior art wireless data transmission products utilize standard analog RF technology, i.e., radios, the same technology used in vehicle dispatch and police communication systems. Standard RF products are relatively simple and inexpensive to build, but licenses from the Federal Communications Commission (FCC) are usually required for operation. Spectrum licensed by the FCC is necessarily a finite and scarce commodity and so use of standard analog RF radio transceivers for wireless data telemetry has been discouraged, since, as on the internet, finite bandwidth resources are quickly exhausted with graphical user interface (GUI) or image-intensive data transmission applications.

Generally speaking, data telemetry is the transmission of short packets of (e.g., from equipment or sensors) to a remote recorder or control unit. The data packets are transferred as electric signals via wire, infrared or RF technologies and data is received at a remote control unit such as a computer with software for automatically polling and controlling the remote devices. The control unit analyzes, aggregates, archives and distributes the collected data packets to other locations, as desired, via a local area network (LAN) and/or a wide area network (WAN). Wireless data telemetry can provide several advantages over data telemetry on wired networks. First, wireless systems can be easier and less expensive to install; second, maintenance costs are lower; third, operations can be reconfigured or relocated very quickly without consideration for rerunning wires, and fourth, wireless telemetry offers improved mobility during use. It is desirable to have a wireless data telemetry radio be small, light, resistant to interference from adjacent RF noise sources, and use as little energy as possible.

In prior efforts to overcome perceived shortcomings of standard analog RF transmission methods, direct sequence spread spectrum (DSSS) was developed. DSSS radios divide or slice transmissions into small bits, thereby spreading energy from the bits simultaneously across a wide spectrum of radio frequencies. DSSS methods are relatively unreliable, however, because spreading the message across a wide spectrum greatly reduces the strength of the radio signal carrying the message on any one frequency. Since a DSSS receiver must simultaneously monitor the entire allotted spectrum, severe interference from a high energy RF source within the monitored spectrum can pose an insurmountable problem. DSSS performance also degrades quickly in shared-service environments having multiple radio systems operating simultaneously.

Frequency hopping spread spectrum (FHSS) technology was developed by the U.S. military to prevent interference with or interception of radio transmissions on the battle field and is employed by the military in situations where reliability and speed are critical. DSSS methods cannot match the reliability and security provided by frequency hopping. Instead of spreading (and therefore diluting) the signal carrying each bit across an allotted spectrum, as in DSSS, frequency hopping radios concentrate full power into a very narrow spectral width and randomly hop from one frequency to another in a sequence within a defined band, up to several hundred times per second. Each FHSS transmitter and receiver coordinate the hopping sequence by means of an algorithm exchanged and updated by both transmitter and receiver on every hop. Upon encountering interference on a particular frequency, the transmitter and receiver retain the affected data, randomly hop to another point in the spectrum and then continue the transmission, in hope that there will be a frequency somewhere in the spectrum that is free of interference. Benign producers of interference are not likely to interfere with all frequencies simultaneously and at high power radiation levels, and so the frequency hopping transmitter and receiver will usually find frequencies with no interference and complete the transmission. While some FHSS radios do perform more reliably over longer ranges than DSSS radios, until recently, FHSS communication systems were used almost exclusively in the extremely expensive robust military or government communication systems, since they are complex and expensive to produce.

The FCC has designated three license-free bandwidth segments of the radio frequency spectrum and made them available for industrial, scientific and medical (ISM) use in the United States. These three segments are nominally at 900 MHz, 2.4 GHz and 5.8 GHz. Anyone may operate a wireless network in a license-free band without site licenses or carrier fees and is subject only to a radiated power restriction (i.e., a maximum of one watt radiated power), and so range must be limited. Transmissions in the ISM bands must be spread spectrum radio signals, and since transmission in the ISM bands are and will remain license-free (and therefore without cost), users are almost certain to be confronted with a burgeoning overuse-interference problem. Ever greater numbers of users are likely to crowd the available channels, thereby creating a modern-day electronic “tragedy of the commons.”

What is needed, then, is an inexpensive, easy to use and robust data telemetry and communication system including an inexpensive transceiver, preferably operating in the less crowded FCC regulated and licensed bands which provide stable, reliable communications for a variety of users in a variety of environments.

### OBJECTS AND SUMMARY OF THE INVENTION

It is a primary object of the present invention to overcome the above mentioned difficulties by providing an economical, compact, wireless data telemetry transceiver adapted to establish and maintain stable, reliable communication links, preferably in the licensed frequency bands.

Another object is to provide a mobile wireless data exchange transmission system to support a variety of data communication applications between mobile transceivers, remote base collection points and internet-connected dispatchers.

Yet another object of the present invention is to implement a wireless data exchange transmission system to support mobile-to-mobile transmission, mobile-to-remote base transmission, remote base-to-internet connected dispatcher transmission, internet connected dispatcher-to-mobile transmission, and any other combination of these elements.

Another object is to provide a mobile wireless data exchange transmission system to support e-mail communication between and among mobile transceivers, remote base collection points and internet-connected central dispatchers.

Yet another object of the present invention is to provide a mobile wireless data exchange transmission system to support Global Positioning System (GPS) position data communication between and among mobile transceivers, remote base collection points and internet-connected dispatchers.

Another object is to provide a mobile wireless data exchange transmission system to support message and form-based communication between and among mobile transceivers, remote base collection points and internet-connected dispatchers.

The aforesaid objects are achieved individually and in combination, and it is not intended that the present invention be construed as requiring two or more of the objects to be combined unless expressly required by the claims attached hereto.

In accordance with the present invention, an economical, compact wireless data telemetry system includes a transceiver coupled with a portable computing device to provide a Mobile Data messaging and location device.

The wireless data telemetry system is well suited for use in many possible applications; one application, Global Positioning System (GPS) based vehicle location, provides an exemplary embodiment. In broadest terms, analog operation utilizes a plurality of analog RF channels for transmitting Mobile Data Packet Protocol (MDPP) packets between a remote base system and a number of mobile units. Each remote base system transmitter operates in a continuous full duplex mode. Each mobile transmitter operates in a half duplex mode, transmitting only when new data needs to be sent. Both base and mobile transceivers utilize 4-Level or Audio Frequency Shift Keying (AFSK) modulation.

The operation of the combination of elements is one of the novel focus areas of the present invention. The mobile unit includes a main unit comprising RF and data boards and connections for an external GPS receiver and an RF antenna for transmission of data telemetry packets to a remote base system. The remote base system receives data in MDPP format from a plurality of mobile units and sends this data to a central controller, where that information is then routed by an internet controller via the internet or by RF or telephone company circuits to a customer dispatch center, where the information is organized into a database which can be readily stored and manipulated by the customer. Each customer's data is stored on his or her own dispatch center computer or server. Customers can prepare reports based on information they receive from mobile units in their fleet via the remote base system, central controller and Internet controller.

Digital operation is similar, but it utilizes packet data/CDPD/GPRS wireless mobile units that operate on existing wireless telecommunication digital networks, thus replacing the analog components described above. As in the above example, mobile GPS data in MDPP format is routed through these digital networks directly to the internet, where it is then sent to the same internet controller as above. From there it is processed by the central controller and routed to the proper customer dispatch center.

In the exemplary embodiment, the mobile data telemetry system is utilized in conjunction with a GPS receiver to provide location information on a substantially continuous basis for a plurality of customer vehicles in the field. The dispatch center includes, for example, Microsoft's Map Point™ software or comparable mapping software, used in conjunction with data received from the mobile units to display vehicle location. The mobile unit continuously polls an attached mobile GPS receiver or other data input devices for status changes and communicates with various RS-232 compatible devices such as a Palm Pilot™ brand computing device or a laptop computer located near the vehicle's driver, and then periodically assembles MDPP packets for transmission back to the remote base system. In a preferred embodiment, telemetry information is transmitted approximately once every thirty seconds and so the latency of any location data is approximately sixty to ninety seconds. Additional sensors may be used to gather information for transmission over the mobile unit, for example, a temperature sensor might be mounted within a refrigerated food storage truck and compliance with food storage regulations might be ensured by reviewing the periodically transmitted temperature readings at the dispatch center.

The mobile unit automatically scans the plurality of RF channels, in both analog and digital operation, thereby defining a decentralized radio controlled network and providing efficient transmitter frequency reuse. When a mobile unit travels out of range of an analog remote base system, or a digital network service area, the mobile unit's data telemetry information is stored for eventual forwarding once contact with the remote base system is re-established.

The wireless data telemetry system of the present invention includes a dispatch software algorithm comprising a process for permitting either users of the mobile unit or users of the dispatch center to (1) create new, custom-designed forms, (2) store the new forms and (3) distribute the new forms to all other units in the customer's network, whereupon any user in the customer's network can (4) update information on the stored forms.

A unique advantage of the form creation software algorithm of the present invention is that once a form has been created, data can be entered into selected fields of the form, either in the mobile unit or in the dispatch unit, and forwarded to selected mobile unit or dispatch center destinations. Only new information entered in the form is transmitted over the air. This is to be contrasted with less bandwidth efficient prior art systems wherein an entire form image is transmitted periodically; typically, a form defined in a graphical user interface (GUI) is transmitted frame by frame such that the entire image of the form must be transmitted, whether changes or entries have been made or not.

In the method of the present invention, only changes or data entered into selected fields of the form are transmitted. Since only network participants of a specific network will have a given custom form's identification information stored in memory, only those network participants will be able to correctly decode and utilize the entered information. The entered information is, in a sense, context sensitive, and since only that portion of the form which has new data entered is included in the transmitted MDPP message packets, that data is more secure than prior art GUI form data which must be transmitted with the remainder of the form definition information.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a block diagram of the overall system showing a mobile units with integrated GPS or AVL (automated vehicle location) capability, central and internet controllers, a remote base, a dispatch center, and associated connection points to the world wide web, in accordance with the present invention.

FIG. 2 is a block diagram of a regional mobile wireless data exchange transmission system, (e.g., for a particular geographic area), adapted to support a variety of data communication applications between mobile transceivers, remote base collection points and dispatchers connected via an internet controller and the worldwide-web, in accordance with the present invention.

FIG. 3 is a block diagram of a mobile data central controller portion and an internet controller portion of the mobile wireless data exchange transmission system of FIG. 1, in accordance with the present invention.

FIG. 4 is a block diagram of the remote base system portion of the mobile wireless data exchange transmission system of FIG. 1, in accordance with the present invention.

FIG. 5 is a detailed block diagram of the remote base system of FIG. 4, in accordance with the present invention.

FIG. 6 is a block diagram of the mobile unit of the mobile wireless data exchange transmission system of FIGS. 1 and 2, in accordance with the present invention.

FIG. 7 is a detailed block diagram of the mobile unit of FIG. 6, in accordance with the present invention.

FIG. 8 is a diagram illustrating the data fields in the MDPP packet structure and shows a typical packet sent from the mobile unit of FIG. 7, in accordance with the present invention.

FIG. 9 is a diagram illustrating the data fields in the MDPP packet structure and shows a typical packet sent from the central controller of FIG. 3, in accordance with the present invention.

FIG. 10 is a diagram illustrating a sequence of delimiters in compressed MDPP GPS/time/status format for a typical data block, showing the first part of many, in accordance with the present invention.

FIG. 11 is a diagram illustrating the sequence of delimiters in compressed MDPP GPS/time/status format for a typical data block, showing the second part of many, in accordance with the present invention.

FIG. 12 is a diagram illustrating the sequence of delimiters in compressed MDPP GPS/time/status format for a typical data block showing the third part of many, in accordance with the present invention.

FIG. 13 is a diagram illustrating the sequence of delimiters in compressed MDPP GPS/time/status format in a typical data block, showing the last part of many, in accordance with the present invention.

FIGS. 14a-14c are diagrams illustrating the sequence of delimiters in an MDPP packet in a typical command string from the central controller to the 1700MDPPX, in accordance with the present invention.

FIGS. 15a-15d are diagrams illustrating the sequence of delimiters used in an MDPP packet in a typical command string from the 1700MDPPX to the central controller, in accordance with the present invention.

FIGS. 16a and 16b are diagram illustrating the sequence of delimiters used in an MDPP packet in a typical command string from the 1700MDPPX to the central controller, in accordance with the present invention.

FIG. 17 is a perspective view of a monitored vehicle showing mounting locations for a mobile unit, a control head and a GPS receiver, in accordance with the present invention.

FIG. 18 user interface screen for dispatch center software showing a form interface and current location map, in accordance with the present invention.

FIG. 19 is a user interface screen for dispatch center software showing a form interface and new form template, in accordance with the present invention.

FIG. 20 is a user interface screen for dispatch center software showing a mapping interface control panel for mapping current position, in accordance with the present invention.

FIG. 21 is a user interface screen for dispatch center software showing a mapping interface control panel for mapping monitored vehicle travel, in accordance with the present invention.

FIG. 22 is a user interface screen for dispatch center software showing a map and the mapping interface control panel of FIG. 20 for mapping monitored vehicle current position, in accordance with the present invention.

FIG. 23 is a user interface screen for dispatch center software showing a map for plotting monitored vehicle travel, in accordance with the present invention.

FIG. 24 is a user interface screen for dispatch center software showing a map and the mapping interface control panel of FIG. 21 for mapping selected speed-related information about monitored vehicle travel, in accordance with the present invention.

FIG. 25 is a flow chart diagram illustrating the method steps followed in handling form-related events, namely, generating or searching for an appropriate form and entering data into selected fields, in accordance with the present invention.

FIG. 26 is a flow chart diagram illustrating the optional method steps followed in handling form-related events, namely, listing forms, editing forms or processing user preferences related to form data, in accordance with the present invention.

FIG. 27 is a flow chart diagram illustrating the method steps followed in editing forms, in accordance with the present invention.

FIG. 28 is a flow chart diagram illustrating the method steps followed in listing forms, in accordance with the present invention.

FIG. 29 is a flow chart diagram illustrating the optional method steps followed in adding form data, namely, identifying the desired form or identifying a new form, identifying the record data to be stored in the form, and populating a record with the form data, in accordance with the present invention.

FIG. 30 is a block diagram of the overall system showing a mobile units, a plurality remote base systems, the main or central controller, an internet controller and associated connection points to the world wide web, in accordance with the present invention.

FIG. 31 is a central controller software component breakdown diagram illustrating the interconnections between the major components of the system control software, in accordance with the present invention.

FIG. 32 is a central controller software data flow diagram illustrating the method and timing for processing an MDPP packet or an e-mail in the system, in accordance with the present invention.

FIGS. 33a and 33b are central controller software data flow diagrams illustrating the method for receiving an MDPP packet or an e-mail in the system, in accordance with the present invention.

FIGS. 34a and 34b are central controller software data flow diagrams illustrating the method and timing for sending an MDPP packet or an e-mail in the system, in accordance with the present invention.

FIGS. 35a and 35b are central controller software data flow diagrams illustrating the method for sending an an e-mail in the system, in accordance with the present invention.

FIG. 36 is a block diagram of the overall system showing a mobile units, a plurality remote base systems, the internet controller and associated connection points to the world wide web, in accordance with the present invention.

FIG. 37 is a main controller and central controller software component breakdown diagram illustrating the interconnections between the major components of the system control software, in accordance with the present invention.

FIGS. 38a and 38b are internet controller software data flow diagrams illustrating the method and timing for processing an MDPP packet, in accordance with the present invention.

FIG. 39 is an internet controller software data flow diagram illustrating the socket finding method for sending and receiving a MDPP packets from a connected dispatch center, in accordance with the present invention.

FIG. 40 is an internet controller software data flow diagram illustrating the method for sending and receiving a MDPP packets from a connected dispatch center, in accordance with the present invention.

FIG. 41 is a detailed block diagram of an alternative embodiment of a mobile unit, in accordance with the present invention.

FIG. 42 is a user interface screen for dispatch center software, with annotations, showing vehicle or user location and route status for a selected number of tracked vehicles.

FIG. 43 is a user interface screen for dispatch center software, with annotations, showing vehicle or user location and route status for a selected number of tracked vehicles.

FIG. 44 is a user interface screen for a new forms method embodiment which illustrates use of a new forms program executed on a Palm™ personal digital assistant, in accordance with the present invention.

FIG. 45 is a user interface screen for a new forms method embodiment which illustrates use of data fields in the forms program executed on a Palm™ personal digital assistant, in accordance with the present invention.

FIG. 46 is a user interface screen for a new forms method embodiment which illustrates use the forms program “drop down box” feature executed on a Palm™ personal digital assistant, in accordance with the present invention.

FIG. 47 is a user interface screen for a new forms method embodiment which illustrates use of the forms program “fixed field” feature executed on a Palm™ personal digital assistant, in accordance with the present invention.

FIG. 48 is a user interface screen for a new forms method embodiment which illustrates use of the forms program free field feature executed on a Palm™ personal digital assistant, in accordance with the present invention.

FIG. 49 is a user interface screen for a new forms method embodiment which illustrates use of the forms program SQL query feature executed on a Palm™ personal digital assistant, in accordance with the present invention.

FIG. 50 is a user interface screen for a new forms method embodiment which illustrates use of the forms program clock time stamp feature executed on a Palm™ personal digital assistant, in accordance with the present invention.

FIG. 51 is a user interface screen for a new forms method embodiment which illustrates use of the forms program check box feature executed on a Palm™ personal digital assistant, in accordance with the present invention.

FIG. 52 is the main flow chart diagram illustrating the method steps followed in creating, changing and saving form page data, in accordance with the present invention.

FIG. 53 is a flow chart diagram illustrating the method steps followed in responding to events when creating or changing form page data, in accordance with the present invention.

FIG. 54 is a flow chart diagram illustrating the method steps followed in form initiation, in accordance with the present invention.

FIG. 55 is a flow chart diagram illustrating the method steps followed in adding list data to a form, in accordance with the present invention.

FIG. 56 is a flow chart diagram illustrating the method steps followed in getting form page data including the “build list” subroutine of FIG. 55, in accordance with the present invention.

FIG. 57 is a flow chart diagram illustrating the method steps followed in adding form page data to a new or updated form, in accordance with the present invention.

FIG. 58 is a flow chart diagram illustrating the method steps followed in saving form page data, in accordance with the present invention.

FIG. 59 is a flow chart diagram illustrating the method steps followed in parsing controls used in creating or changing form page data, in accordance with the present invention.

FIG. 60 is a flow chart diagram illustrating the method steps followed in creating or changing text fields and check boxes in form pages, in accordance with the present invention.

FIG. 61 is a flow chart diagram illustrating the method steps followed in adding a button to form page data, in accordance with the present invention.

FIG. 62 is a flow chart diagram illustrating the method steps followed in adding a trigger to form page data, in accordance with the present invention.

FIG. 63 is a flow chart diagram illustrating the method steps followed in adding a date to form page data, in accordance with the present invention.

FIG. 64 is a flow chart diagram illustrating the method steps followed in adding a list to form page data, in accordance with the present invention.

FIG. 65 is a flow chart diagram illustrating the method steps followed in adding a label to form page data, in accordance with the present invention.

FIG. 66 is a flow chart diagram illustrating the method steps followed in adding a text field to form page data, in accordance with the present invention.

FIG. 67 is a flow chart diagram illustrating the method steps followed in adding a check box to form page data, in accordance with the present invention.

FIG. 68 is a block diagram of another embodiment of the mobile wireless data exchange transmission system of the present invention, illustrating links to the Mobile device database containing the forms data, in accordance with the present invention.

### DETAILED DESCRIPTION OF THE PREFERRED EMBODIMENTS

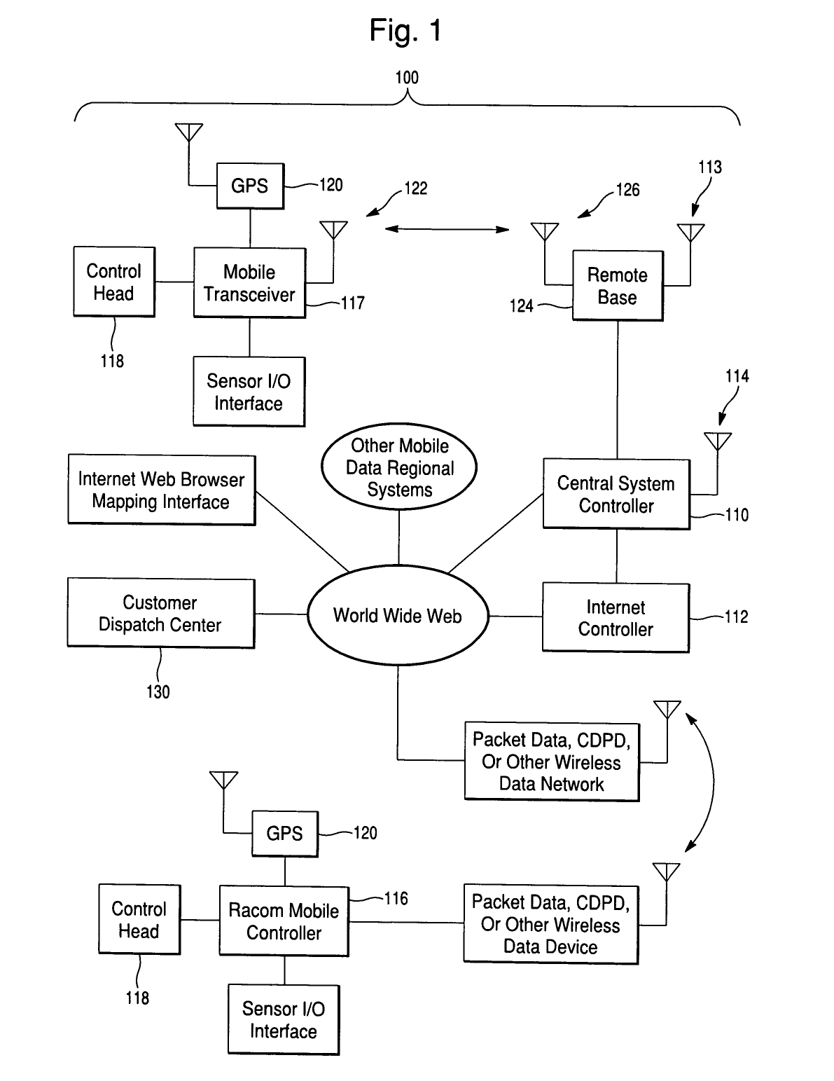

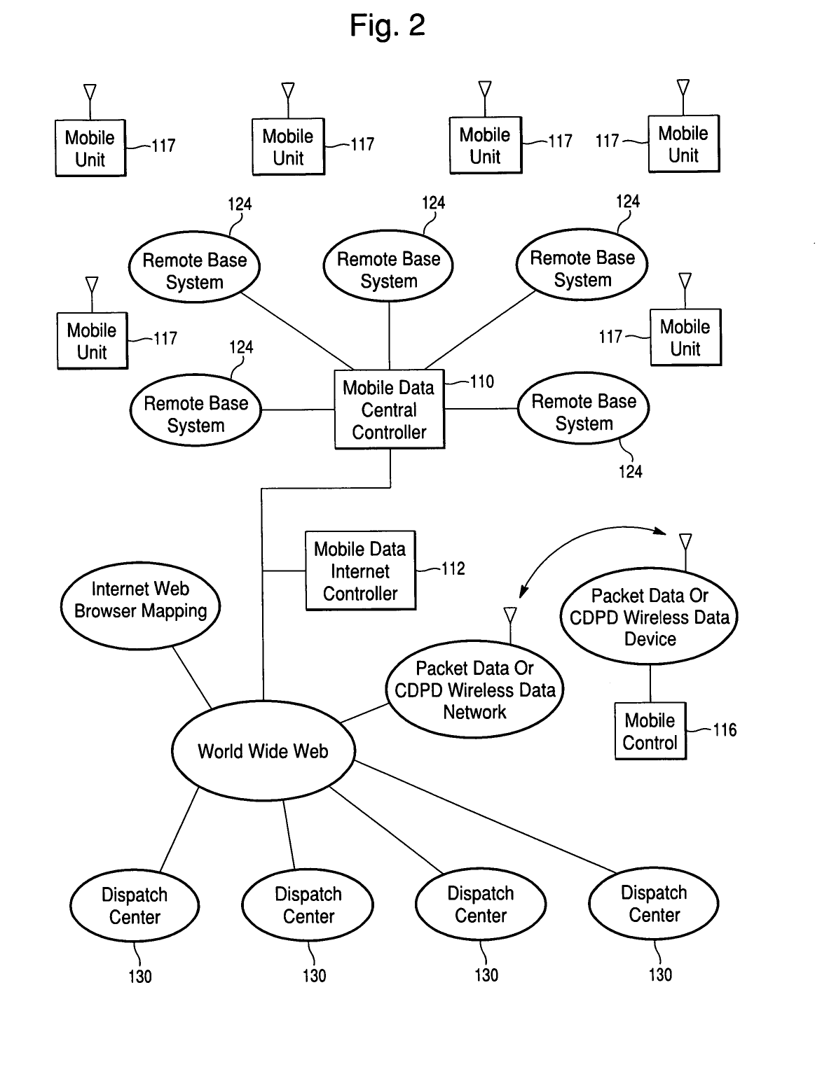

Referring now to FIGS. 1 and 2, a mobile wireless data exchange transmission system 100 supports a variety of data communication applications between one or more analog mobile units 117 through one or more remote base system units 124, one or more digital mobile controllers 116 through one or more packet data/CDPD/GPRS wireless service networks, and one or more dispatch centers 130, These components are connected via the Internet, RF or telephone company services by the mobile data central controller 110 and the mobile data Internet controller 112, The system 100 and the major components of the system will be described in greater detail in the subsections that follow.

### I. System Overview

Mobile wireless data exchange transmission system 100 transmits Mobile Data Packet Protocol (MDPP) packets and provides a variety of data communication applications between analog mobile units 117, remote base system collection points 124, digital mobile controllers 116, and internet connected MDPP customer dispatcher centers 130, as shown for the overall system diagram in FIG. 1. A plurality of digital mobile controllers 116, analog mobile units 117, remote base systems 124, and dispatch centers 130 are connected via the mobile data central controller 110, the mobile data internet controller 112, and the world-wide-web, as shown for a regional system diagram in FIG. 2.

Communication modes include mobile to mobile, mobile to fixed remote, mobile to internet based dispatch, fixed remote to internet based dispatch, internet based dispatch to mobile, dispatch to fixed remote, mobile to email, fixed remote to email, email to mobile, email to fixed remote and dispatch to email. In addition to the transmission and reception of MDPP packet data transmissions, continuous GPS positioning data is monitored by each analog mobile unit 117 and digital mobile controller 116 via an MDPP microcontroller 162, Mobile units transmit the GPS information on regular intervals, to provide vehicle location, speed, direction, and data to the Internet based customer operated dispatch centers 130, For vehicles carrying mobile units, an optional MDPP customer configurable sensor accessory package is adapted to monitor a variety of remote functions such as vehicle weight, tank level indicators, fixed telemetry applications, alarm monitoring, and the status of most electrical and mechanical applications. As shown in FIGS. 1-7, an MDPP system 100 consists of a mobile data central controller 110 with a mobile data internet controller 112, a multi purpose mobile/fixed analog unit 117 or digital unit 116 controlled by an MDPP microcontroller 162, and a single or multi-site analog RF network controlled by an MDPP Racom 1700 mobile data base controller located at each analog site for mobile units 117, or an existing/future packet data/CDPD/GPRS wireless network for digital units 116, The MDPP system can be utilized on a variety of different half/full duplex base and mobile radio analog communications systems. These radio systems can operate on private business frequencies, public safety channels, SMR systems, RCC systems, MAS systems or existing/future digital packet data/CDPD/GPRS radio networks that operate on Cellular, GSM, PCS and G2-G3 wide area systems. These radio systems which can be utilized for data transmission are not restricted to any one frequency or frequency band. An MDPP wireless data system can be used on any narrowband analog FM radio communication system capable of using F1D, F2D and F3D emission with channel spacing as low as 6 kHz, or existing digital packet data/circuit data networks, all operating between 30 MHz and 2.4 GHz.

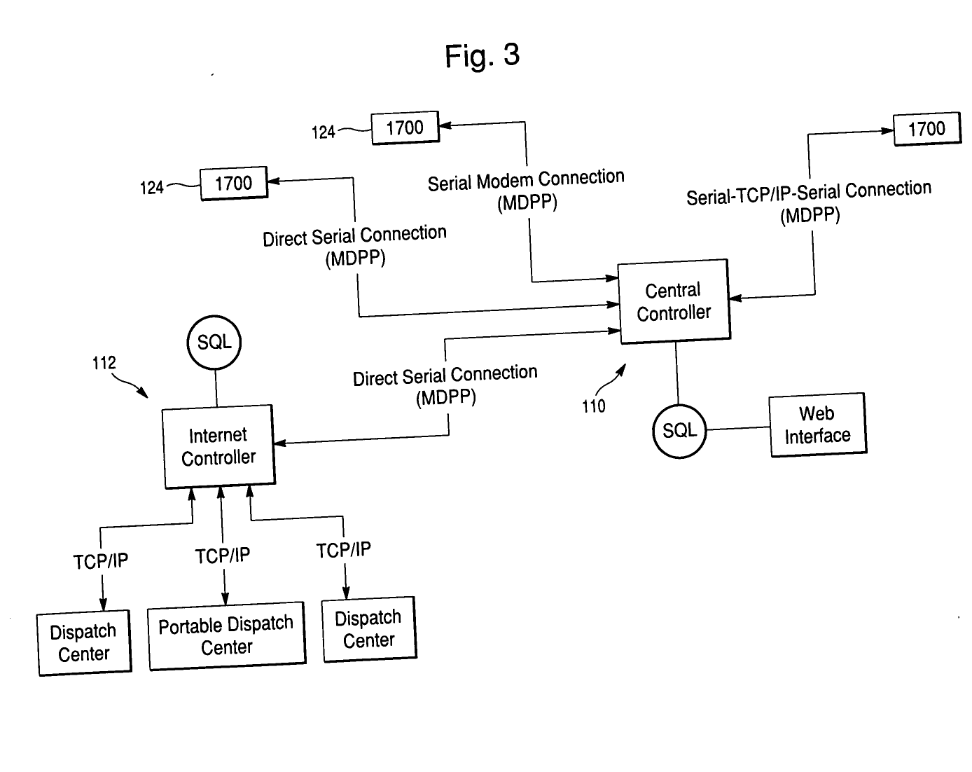

The mobile data central controller 110 defines the “hub” of system 100, meaning that there is only one central controller 110 per regional system 100, All regional subscriber traffic is processed and routed through the common control point provided by central controller 110, Central controller 110 performs subscriber validation, service level programming, fleet management, Internet gateway, and optional customer-specific functions. Central controller 110 is a multiport device and can control input/output (I/O) ports using TCP/IP and MDPP protocols, through a combination of fixed or dial-up modems, TCP/IP connections and dedicated RS-232 connections to expansion and auxiliary devices, as shown in FIG. 3. A companion mobile data Internet controller 112 uses an RS-232 connection and is an integral part of the “hub” 110, Internet controller 112 is used to interface the central controller 110 to dispatch centers 130 and fixed/mobile telemetry units 116, Mobile data central controller 110 also uses an exchange server to connect to the Internet through the use of email.

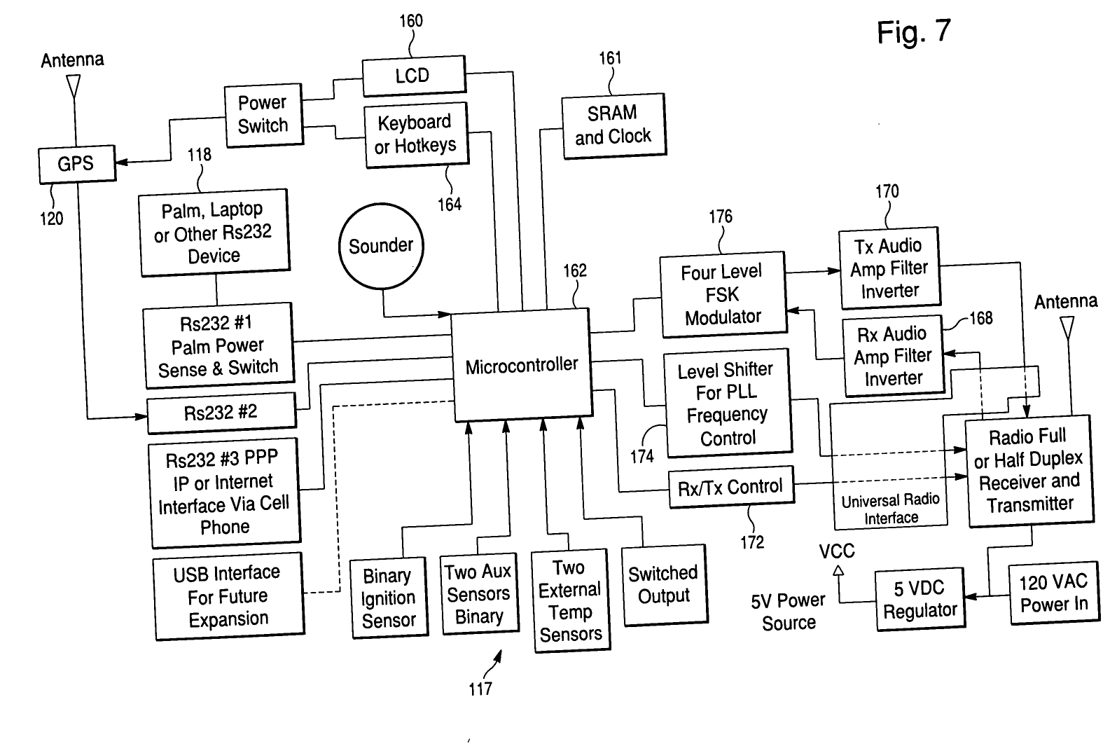

As best seen in FIG. 7, the MDPP Racom mobile controller 116 can transform a two-way radio transceiver into a mobile data terminal capable of two-way messaging, vehicle location, remote alarms/sensor monitoring, and free form business exchange processing. The MDPP mobile logic universal radio interface is model specific and provides connections to a transmit and receive modem 4 level or Audio Frequency Shift Keying (AFSK) circuit, a transmit carrier control circuit, a vehicle power monitor circuit and an ignition key monitor circuit for each transceiver. The MDPP mobile logic also directly controls the selection of transmit and receive frequencies by directly interfacing to the transceiver's synthesizer control lines. An MDPP mobile logic electronic interface provides RS-232 interface connection (RS-232 #1) for local unit programming and to allow messaging or other custom features through the addition of a handheld PDA, lap top computer, or any other RS-232 compatible device functioning as a control head 118, In Addition, the MDPP custom logic control processor provides an RS-232 connection for a GPS receiving unit 120 (RS-232 #2), and up to three customized remote alarm/sensor connections. MDPP firmware provides total control of transceiver operation, RS-232 data control, GPS data storage, base station selection, custom timing functions, and sensor relay inputs. The firmware is also configured for over-the-air programming, allowing a service provider to make over-the-air changes to the units.

The MDPP Racom 1700 mobile data base controller 140 utilizes a micro controller which interfaces to Frequency Modulation (FM) continuous duty full duplex base transceivers that have audio input and output ports for transmit and receive of 4 level or Audio Frequency Shift Keying (AFSK) modem audio.

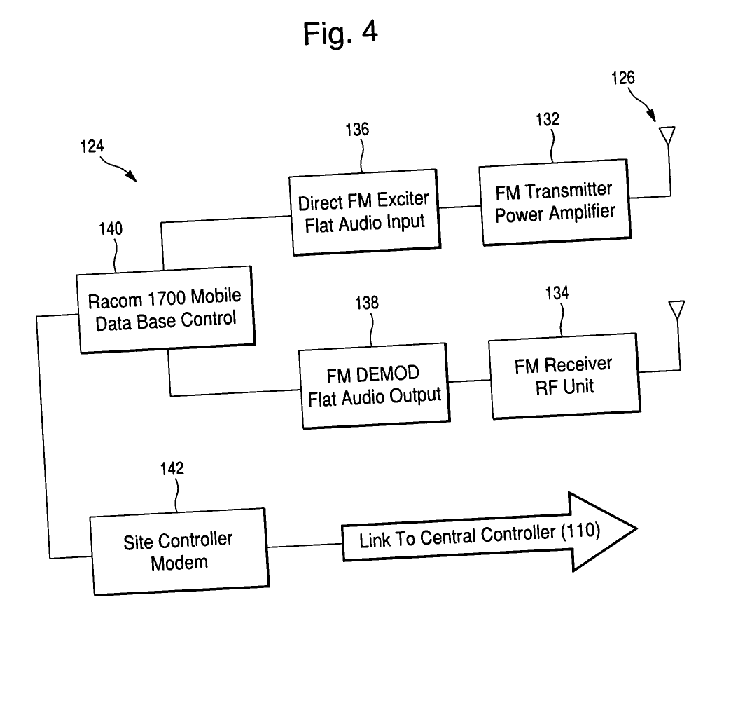

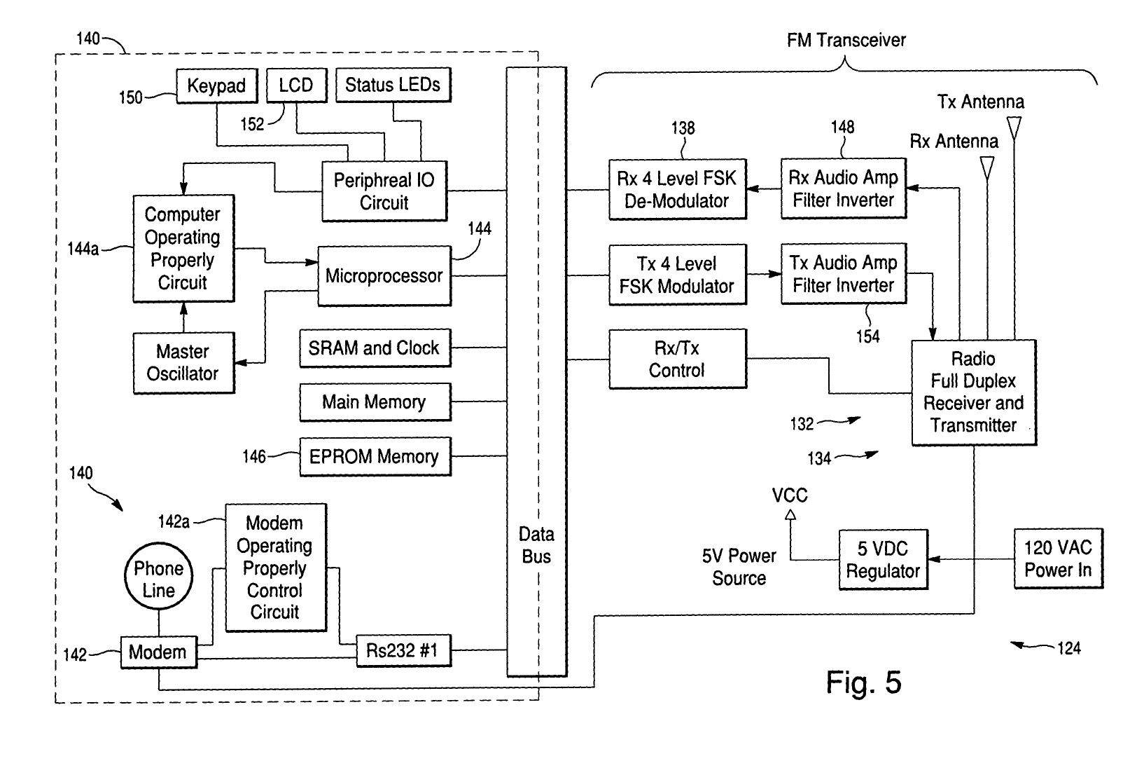

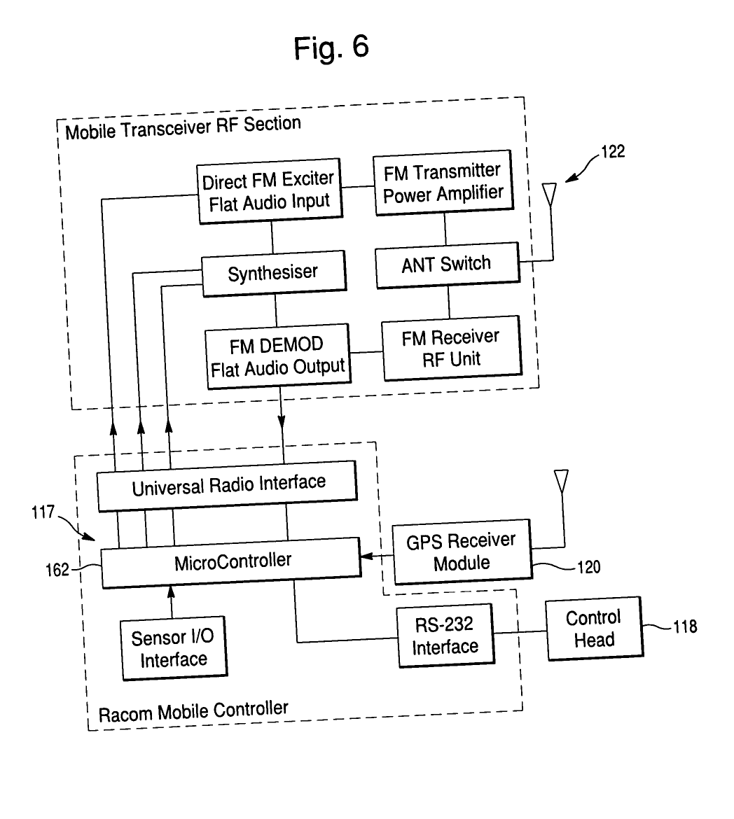

The base logic package utilized in remote base systems (of FIGS. 4 and 5) mirrors the mobile logic package utilized in mobile units (of FIGS. 6 and 7) as far as the radio interface, except that base station frequency control is not needed. Additional logic for data confirmation, mobile clock setting, over-the-air mobile programming, modem control via RS-232, data communication protocol to the central system controller, and alarm control is all contained in the base logic/control package utilized in remote base systems 124 (of FIGS. 4 and 5). The MDPP Racom 1700 mobile data base controller 140 is a self-contained unit that incorporates its own power supply, and the interface to the base station involves little or no modification to the base station equipment.

One novel feature is that the MDPP Racom mobile controller 116 resides inside the housing of mobile unit 117 as shown in FIG. 7 and provides direct control of transmitter frequency, modulation, & keying functions. The Racom mobile controller 116 can also function as a self contained external data controller that connects to a mobile accessory jack or data jack of an existing or future digital packet data/CDPD/GPRS system.

The principal physical devices designed specifically for system 100 include the Racom mobile controller 116, the mobile data central controller (110), the mobile data internet controller 112, dispatch centers 130, and the remote base system controller 140 (also known as the 1700MDPPX) included within remote base system 124 (FIG. 4).

The principal Windows® based software components include: a MDPP Dispatcher component, a MDPP Internet Dispatcher component, a MDPP Consumer Web-Based Finder component, a MDPP Central Controller component, a MDPP GUI Form Creator component, a MDPP Message System component, and a MDPP Mapper component.

The principal Remote Terminal and personal digital assistant (PDA) OS and CE based software components include an MDPP Data Trak software component, a MDPP Mobile Forms component, a MDPP Remote Terminal Database component and a MDPP MDscan Inventory Control Software component.

The principal Firmware-based software components include a MDPP Mobile Interface Firmware component, a MDPP Base Station Firmware component and a MDPP firmware converter for use in connection with Cellular and GSM systems

Turning now to Protocols and Procedures, MDPP system 100 is a decentralized multi-site remote controlled network, featuring hands-off, roaming, radio frequency selection, data storage; AVL, status updates, and MDPP packet generation functions which are controlled by the following components: A number of Racom mobile controllers (116), a number of Racom 1700 mobile data base controllers (140), a mobile data central controller (110), a mobile data internet controller (112), and a number of dispatch centers (130).

The system 100 provides a frequency indifferent system technology. Other features include automated cascade on undelivered messages to optional devices, custom data compression for optimum efficient use of carrier resources, customer based data storage and processing, an MDPP-specific information retrieval system, an MDPP-specific TCP/IP transfer protocol, a MDPP GPS data comparator to detect vehicle movement and speed, MDPP extended store and forward for use when a given mobile user is out of the Remote Base Unit coverage area, MDPP Forms, MDPP Form templates, MDPP form update protocol for wireless, MDPP Form stage retrieval, MDPP remote and master database sync and MDPP firmware converter for Cellular and GSM systems.

### II, System Theory of Operation

Communication between mobile units and the central controller can be accomplished by one of two methods. Analog operation involves mobile units 117 communicating to the central controller via a single or multi-site, multi-frequency analog regional radio network, such as SMR, MAS, RCC-UHF, or RCC-VHF systems, utilizing separate transmit-receive (Tx/Rx) frequency pairs at each remote base system site. Digital operation involves mobile controllers 116 using a packet data/CDPD/GPRS device communicating to the central control via an existing/future digital packet data/CDPD/GPRS network and the Internet

In analog operation, each remote base system 124 transmits and receives in full duplex mode, transmitting a continuous 4 Level or AFSK modulated carrier. A variety of background information is transmitted during ‘idle’ times to all mobile units 117 within range of any remote base system 124, Part of this background information contains time update signals and synchronization (“sync”) information that mobile units use to stop channel scanning, lock on to a remote base system, register, and await further instructions. At various intervals, each mobile unit 117 will send registration data packages, which also include GPS and sensor information, to the remote base system 124, The remote base system 124 receives this data and analyzes the MDPP packet transmitted from the mobile unit 117, If the packet is complete, a confirmation signal is returned to that mobile unit 117 in response, indicating that the base system 124 received a “good” MDPP data packet. If confirmation is not received after a preset time interval, the mobile unit 117 will retransmit the data packet until confirmation is received. After several unsuccessful retries, the mobile unit 117 will seek another base system 124 and restart the entire process. Once received at the base system 124, the MDPP data packages are reformatted and then sent using the MDPP packet protocol from the remote base system controller 140 to the mobile data central controller 110, The connection to the central controller (110) can be comprised of a variety of links or paths including dedicated modem Telephone Company (“Telco”) circuits, dial-up modem Telco circuits, radio links (e.g., using antennas 113 & 114 as shown in FIG. 1), DSL, T-1, or TCP/IP links.

MDPP message packets from the mobile unit 117 are processed in a similar manner. With the addition of a control head 118 (such as a handheld PDA), or an RS-232 mobile terminal, the mobile unit can send messages and user-defined forms to another mobile unit and to a dispatch center (130), along with e-mails through the Internet. When a message or form is sent via the mobile unit, the mobile logic will receive the message from control head 118 via RS-232 port #1 and attempt to communicate with a remote base system 124, If the mobile is within the regional RF coverage of a remote base system 124, it will lock on to the nearest base station and transmit the message to the base. If successful, remote base system 124 acknowledges to mobile unit 117, the reception of the message. The mobile logic next sends an acknowledge signal to the control head 118 confirming that the message was successfully received by the remote base system 124, Attached to each message is a time-stamped GPS data and sensor line status log. If the mobile unit 117 is outside of the regional coverage and no remote base system 124 can be found, the mobile logic will store the message along with subsequent time-stamped GPS/sensor data, and continue to scan for an available base station until the mobile unit re-enters a region covered by a remote base system 124, Once locked on to a remote base system 124, the mobile unit 117 will repeat its attempt to send the message and all stored GPS/sensor data that has been accumulated since the last successful data transfer to a remote base system 124, Once the remote base system controller 140 has received an MDPP message packet, that packet is transmitted to the mobile data central controller 110 for processing.

At the mobile data central controller 110, a mobile-to-mobile MDPP message packet is routed to the at the last known remote base system 124 that received any communication from the target mobile unit, whereupon the MDPP message packet is transmitted from the remote base system controller 140 through the remote base system 124 to the target mobile unit 117, If the MDPP message packet is successfully received, the central controller 110 (FIG. 3) receives an acknowledge signal transmitted by the mobile unit 117, If the desired mobile unit cannot be found, the MDPP message packet is returned to central controller 110 for storage until a future registration is received from the desired or target mobile unit 117 at any remote base system 124 in the system 100, When the desired mobile unit 117 is finally located, the stored MDPP message packet is delivered; attempts are repeated until delivery is successful.

If the MDPP message packet path is mobile-to-dispatch console or mobile-to-base, the MDPP message packet will be sent by the mobile data central controller 110 via the internet, to a computer controlled dispatch center 130 usually located at the end user's, customer's or subscriber's office. Through MDPP custom software, the user located at a dispatch center 130 can send and receive messages between and among any unit in the subscriber's fleet. In addition to messages, the dispatch console receives continuous updates of mobile unit location and sensor status. Mobile unit GPS location data is converted in the MDPP dispatch software to a database file. This database is then automatically plotted into mapping software (e.g., Microsoft®) Map Point® or comparable mapping software). The dispatcher can display information at dispatch center 130 in a variety of ways, showing location, speed, direction, and status of the mobile units. GPS and status information is also stored at the dispatch center 130, so a location history can be displayed on the map; a user may select any reference time and so may display current location or any location for any previous period.

If the MDPP message packet path is mobile-to-email, the MDPP message packet is processed in a similar manner as for mobile-to-internet. Instead of the MDPP message packet being routed to a dispatcher, it is converted by the mobile data central controller 110 and routed via the mobile data Internet controller 112 as a standard email. Inbound emails are converted in the mobile data central controller 110 to MDPP packet format data and are processed in a similar manner to other MDPP message packets targeted to a given mobile unit. The mobile data central controller 110 will continuously update the last location of the target mobile and route all MDPP message packets destined for that mobile to the proper remote base system 124,

In digital operation, the mobile controller 116 is connected to a wireless packet data/CDPD/GPRS device instead of an analog transceiver. When connected to this network, messages, forms and GPS data from the mobile controller 116 is then routed to the central controller via a packet data/CDPD/GPRS wireless network, the internet, and internet controller 112, Digital mobile controller 116 then performs the same message handling routines as described above for the analog mobile unit 117, with the exception of the digital wireless network replacing the remote base system 124 described above for analog operation.

### Ill. Remote Base System and Tower Site Controller

A remote base system 124, as shown in FIGS. 4 and 5, includes a base controller 140 (also known as a 1700MDPPX unit) which is installed at each tower site in conjunction with a full duplex four level or AFSK Frequency Modulation (FM) transceiver transmitter 132 and receiver 134, System 100 usually includes a plurality of remote base systems 124, and each is adapted to communicate with one or more mobile units (FIG. 7), which can also be fixed units, preferably operating on FCC licensed private business frequencies or public safety channels, SMR systems, MAS systems, or existing packet radio networks.

The primary features of the remote base operating software executed on the base controller 140 include automatic tower site MDPP registration; guarantied delivery of data of information packets; custom data compression; MDPP compression; transmission of date, time, and vehicle status bits. Controller 140 also collects GPS data from mobile units, performs remote (RF) automatic setting of real time clocks in the mobile units, detects power failures and provides an alarm reporting protocol. Controller 140 also provides remote RF, Telco, or TCP/IP electronically programmed memory, programming and confirmation checking of download to units, remote RS-232 or TCP/IP programming and confirmation of tower site controller software, as well as MDPP (Mobile unit Data Packet Protocol) data formatting used in all mobile units, remote base systems, and the system controller. Controller 140 MDPP data formatting permits RS232 data compatibility.

The base controller (140) (known as model 1700MDPPX) presently includes firmware version “MDBASE.asm” and is readily adapted for future upgrades or changes to firmware. The remote base firmware is installed at the tower site for use in conjunction with a full duplex receiver 134 and transmitter 132, as shown in FIGS. 4 and 5, The remote base system 124 can send and receive MDPP Informational packets from mobile units 117 and from a mobile data central controller 110, Base controller 140 sends an MDPP formatted confirmation packet to the sender when information packets are received. Base controller 140 additionally sends an acknowledgment upon receiving an MDPP formatted confirmation packet after an information packet sent by controller 140 is received by the receiving unit.

A typical system 100 consists of several 1700MDPPX base controllers 140, each included within a remote base system 124 operating on a different frequency and strategically located throughout a given geographic region. The common server-based mobile data central controller 110 controls all base controllers 140, The mobile data central controller 110 has a separate RS232 or TCP/IP connection for each base controller 140, and each connection uses MDPP formatted data. The base controller 140 sends MDPP formatted confirmations to the mobile units 117 and the central controller 110 when information packets are received or delivered. As mobile units 117 move around the coverage area, they will automatically scan to other remote base system tower sites if signal strength decreases and will register at the new remote base system tower using a MDPP packet registration. The 1700MDPPX base controller 140 will then forward the MDPP packet registration to the MDPP system controller 110 updating the mobile unit's communication path.

The 1700MDPPX base controller 140 preferably includes up to 8,388,608 Bytes of static RAM, a 32 KB EPROM, a 8 KB EEPROM, a Z80 Processor having a Processor frequency of 19,660,800 Hz. Modulation is preferably 4-level FSK and the Modulation rate is preferably 9600 symbols/second. The 1700MDPPX Tower Site radio mode is Full duplex and the Power requirements are 120 VAC +/−10%, 50/60 Hz, 70 watts maximum. The housing for the 1700MDPPX base controller 140 is gray in color, is 17¼″ wide×5 1/4″ high×12¾″ deep, weighs approximately 19 pounds and is adapted for use on a desk top or in a 19″ rack mount. An RS-232 port is adapted for processing MDPP formatted data and includes a RS232 RX Buffer (32,768 bytes) and a RS232 TX Buffer (also 32,768 bytes).

Turning now to the functional, circuit and firmware description, the 1700MDPPX can contain up to five plug-in circuit boards or cards. There is one Unit Data Base Transmit Board 154, one Unit Data Base Receive Board (including a FSK demodulator 138 and an audio amplifier filter and inverter 148), a Dynamic Random Access Memory (DRAM) board (or, optionally, a Static RAM board) and a RS232 board. There is also one MDPP microprocessor circuit board. This board contains the Z80 microprocessor 144,

The firmware is programmed in the EPROM 146, (an AM27C128). The Z80 microprocessor fetches instructions from EPROM 146 and runs all circuit components. For typical operation the receiver 134 is connected to the 1700MDPPX at the input to the Rx audio amp filter inverter circuit board 148 and the transmitter is connected to the 1700MDPPX at the output of the Tx audio amp filter inverter circuit board 154, The modem 142 is connected to the 1700MDPPX at a port named Rs232 #1, The modem 142 connects the 1700MDPPX to the system controller 110 via modem 142 and telephone lines.

The firmware program has two primary processing loops. One loop is interrupt generated at 1700 Hz. This loop performs all time-critical functions such as RS232 reading, RS232 writing, transmitting of headers & data and receiving of headers & data. The other loop is all non-time-critical functions such as processing of data, loading the buffers and reading the buffers.

All data in and out of the 1700MDPPX is buffered in two 32 K Byte buffers. One buffer is for received RS232 data and the other is for transmitting RS232 data. These buffers eliminate buffer overflow problems.

The receive signal from the radio is connected to the Rx audio amp filter inverter circuit board 148, this circuit filters, amplifies and provides signal inversion if needed (it may be jumpered for inversion). The receive signal then goes to the Rx 4 level FSK modulator 138 for demodulation.

For the following description, the numbers shown in parenthesis correspond to the line number of the source code for the function described. Rx 4 level FSK modulator 138 is run by the microprocessor 144 and is continuously searching for a header block (source code line number 1289) in the received signal from a mobile unit 117, When microprocessor 144 finds a header block, it is decoded (source code line number 1289) and the microprocessor 144 determines which mobile unit the received signal is from (source code line number 2690) and reads the data blocks. Then the CRC for these data blocks is checked (source code line number 2699) and microprocessor 144 determines what to do with the data (source code line number 3851). The data is sent out via the RS232#1 port to the modem 142 and on to central controller 110 in MDPP format. Reception is usually followed with a transmission back to the mobile unit indicating that the data has been received without errors (source code line number 3384).

The MDPP GPS data is also received from the mobile unit and is processed by the microprocessor; the GPS data is then sent out via the RS232#1 port (source code line number 1535) to the central controller 110 in MDPP format.

The 1700MDPPX contains a real time clock that will transmit a date time signal to all mobile units 117 at a preset remotely programmed date and time (source code line number 1044).

Some model 1700MDPPX's have a keypad 150 (source code line number 325) and a Liquid Crystal Display (LCD) 152 (source code line number 288). These are used to set up and test the unit.

MDPP packets to be transmitted are received on the RS232 and or TCP/IP connections from the system controller 110, This data is first buffered in the RS232 input buffer (source code line number 297). Then it is processed and sent to one of many transmit buffers (source code line number 1837). The data is transmitted as a transmit slot becomes available (source code line number 765). At this point the data is held in the transmit buffer waiting for a reception acknowledgment from the unit. If the unit does not acknowledge the data as being received with out errors then it will be transmitted again. This will be repeated about 30 times, ending with an Informational packet being sent to the system controller 110 that the data could not be delivered (source code line number 4185). If the unit does acknowledge the data as being received without errors (source code line number 3257), the transmit buffered will be freed (source code line number 3248) and an Informational packet will be sent to the system controller 110 indicating that the data has been delivered (source code line number 3294).

Transmit signal processing is done with the Tx audio amp filter inverter circuit board 154, The transmit audio signal comes from the Tx 4 level FSK modulator circuit. This circuit is run by the microprocessor 144 (source code line number 765) and is continuously sending header blocks (source code line number 1072) and data (source code line number 1129). If all data has been sent then only header blocks (source code line number 979) are sent. The transmit audio signal is amplified, filtered and inverted if needed by the Tx audio amp filter inverter circuit 154,

The 1700MDPPX base controller unit 140 has an on-board clock-RAM integrated circuit used for storing operating characteristics of the site. This device can be programmed with via the RS232 connection (source code line number 2310), via TCP/IP or over the air (source code line number 2257). It also contains date/time information. The 1700MDPPX transmits (source code line number 1044) the date/time information to mobile units about once an hour. This keeps all mobiles units on the same time.

The 1700MDPPX has a “computer operating properly” circuit 144a that will automatically reset the microprocessor 144 (source code line number 232) if it is not operating properly. There is also a “modem operating properly” circuit 142a (source code line number 2807). This circuit is controlled remotely (source code line number 2554) and will automatically reset the modem 142 if it is not communicating properly (source code line number 2807).

The 1700MDPPX base controller unit 140 has remotely programmable operating characteristics and date/time which are contained in the SRAM and CLOCK 144b of the 1700MDPPX. These operating characteristics and date/time are normally programmed into the 1700 MDPPX base controller 140 via the RS-232 port using the MDPP protocol. Table 1, below, provides programming commands which will set the clock and operating characteristics of the 1700MDPPX. These characteristics can be programmed remotely with the “M” command. “00M301110F33338300” is the correct string as of Jul. 1, 2002. This string should be sent to the 1700MDPPX as part of a MDPP Informational packet. The clock is set with the “K” command. For the commands of Table 1, Commands go in the subject or message area MDPP Informational packet.

TABLE 1
RS232 commands to the 1700 controller

| | |
|---|---|
| K | This command will set the clock in the 1700 to the date/time specified |

Kyymmddhhmmss

| | |
|---|---|
| Xhhhhhh | This command will Set full hex bytes starting at address 4060h |
| | Only Clock control addresses 4061 & 4062 & 4063 are used. See below. |
| | Dd = day @4061h |
| | hh = Hour @4062h to Tx date/time |

33 = every hour
34 = change to 33 when day is reached

mm = Minute @4063h of hour for transmission

X00ddhhmm0000 is a typical string

| | |
|---|---|
| M | This command will Sets low order hex bytes starting at address 4070h |
| | Check sum byte is set automatically. |

00M301110F33338300 is a the correct string

The 1700MDPPX base controller unit 140 is programmed to receive program commands over the air from a mobile unit 117, This is useful if the RS232 connection has failed. Table 2, below, provides program commands which will set the clock and operating characteristics of the 1700MDPPX. For the commands of Table 2, Commands go in the subject or message area. The protocol requires that a subject not be sent if commands are in the message area and that a “destination min” not be sent, alternatively, “destination min” can be 1 digit at the most, as more digits will put the “X” past position “53 h”. The protocol requires that the first “X” must be at buffer address “+53 h”, “X” may repeat several times

TABLE 2
Over the Air Program Commands from a Mobile Unit to a 1700MDPPX

| | |
|---|---|
| XcrK | This command will set the clock in the 1700 to the date/time specified |

XcrKyymmddhhmmss

| | |
|---|---|
| XM | This command will Set 1700 mode bytes Use upper case only |

XM301110F33300000000000000000

| | |
|---|---|
| XR | This command will Reset the 1700 |
| XZ | This command will Zero counters in the 1700 |
| Xcrf?00000 | This command will Access 1700 Rs232 commands |

| | |
|---|---|
| ? is the command letter it can be 0 to z | Rs232 commands M, K & X not valid |

Table 3 provides the addresses of the RAM variables for the 1700 MDPPX base controller 140, the values shown are in hex. These RAM variables are contained in the SRAM and CLOCK 144b of the 1700, They control the operating characteristics and the date/time of the 1700, These can be programmed remotely with the “M” command. M301110F33338300 is the correct string as of Jul. 1, 2002.

TABLE 3
Addresses of 1700 RAM variables

| Position | Actual | |
|---|---|---|
| After the “M” | RAM Adr | Description |
| 1 | 4070 | Set to 3 for No Hdr Ack and No Hdr Reg |
| | | Ack |
| 2 | 4071 | Set to 0 for MDpp out and RF ack |
| 3 | 4072 | Set to 1 for Tx Mode from mdpp packet |
| 4 | 4073 | Set to 1 for Tx header dump |
| 5 | 4074 | Set to 1 for Auto Modem reset of 0 for none |
| 6 | 4075 | Set to 0 for default password. Other value |
| | | will set password to 1, 2 or 3 |
| 7 | 4076 | Set to F for Msg tx repeat count of 30 |
| 8 | 4077 | Set to 3 for a tx acknowledgment |
| | | repeat count of 3 |
| 9 | 4078 | Set to 3 for a tx repeat count of 3 |
| | | for the date/time data |
| 10 | 4079 | Spare |
| 11 | 407A | Spare |
| 12 | 407B | Set to 8 for Modem reset value. |
| 13 | 407C | Set to 3 for time from 1700 |
| | | registration over MDPP |

As noted above, communication between the 1700mdppx and the mobile unit 117 is through the use of 4 level FSK modulation. This modulated transmission consists of header blocks and data blocks. A transmission between the 1700mdppx and a mobile unit 117 will start with a header block followed by zero to 85 data blocks.

The header block consists of ten bytes and are defined as set forth in Table 4.

TABLE 4
Header Block Definition

| Location | Description |
|---|---|
| 00 | Number of data blocks following this header |
| | A value of 00 indicates no data follows (Header only) |
| 01 | Mode of operation (From the Mode bytes of the MDPP |
| | Packet) |
| 02 | Serial number of Informational packet from (and to) |
| | 1700MDPPX |
| | This is from the serial number bytes of the MDPP |
| | Informational packet |

The next 3 items are from the 6 digit MIN number of the MDPP
Informational packet

| | |
|---|---|
| 03 | Unit number BCD High (MIN From MDPP Packet) |
| 04 | Unit number BCD (MIN From MDPP Packet) |
| 05 | Unit number BCD Low (MIN From MDPP Packet) |
| 06 | Mode code returned to mobile unit from 1700MDPPX |
| | C5 = Mobile Unit Specific Addressing |
| | C6 = Erase mobile Unit Buffers & Load |
| | C7 = Erase all Buffers & Load |
| 08 | Status bits from Mobile Unit to 1700MDPPX |
| | If Bit7 = 1 then Mobile's ignition is off |
| | If Bit6 = 1 then PDA is out |
| | If Bit5 = 1 then RX is Nak |
| | If Bit3 = 0 then RX is ok |
| | If Bit1 = 0 and Bit0 = 0 then Mobile Rx is full |
| 09 | Serial number of Informational packet from |
| | 1700MDPPX to mobile unit |

The data blocks are 12 bytes in length and contain the complete MDPP Informational packet which is divided or broken up into as many as 85 blocks, each block containing 12 bytes of data.

### IV. Mobile Unit

The complete mobile unit 117 can be vehicle mounted or can work in a fixed location and can receive and send Informational packets from other units, a dispatcher or email. Mobile transceiver unit 117 sends a confirmation to the sender when Informational packets are received and displays a confirmation when Informational packets it sends are received by the system. The complete mobile unit 117, as best seen in FIGS. 6 or 7 has a universal radio interface which consist of the four level FSK modulator, Tx Audio Amp filter inverter, Rx Audio Amp filter inverter, level shifter for PLL frequency control and Rx/Tx control circuit blocks. These circuits allow the RACOM circuit board 116 to connect to several different types of full or half duplex receiving and transmitting radios or transceivers 115, Micro controller 162 operates RACOM circuit board 116,

(A) Firmware—Model MJ06CK.asm: The RACOM circuit board 116, as best seen in FIG. 7 includes a microprocessor or micro controller 162 and, optionally, can be used with a GPS receiver 120 and can be programmed to report the position of a vehicle carrying the unit to a dispatch center 130, Mobile unit 117 under the control of micro controller 162 can scan several remote base systems 124 or transmitters seeking the best signal and uses the MDPP data packet format.

Mobile unit 117 provides automatic frequency scanning of multiple tower site controllers, compression and storage of GPS data, compression and storage of date, time GPS data and vehicle status bits. Four vehicle status input bits, remote temperature sensor connections and switched outputs are also provided. These four status input bits, remote temperature sensor connections and switched outputs also have applications in fixed location equipment, building and security monitoring applications. A good example being a vending machine where they could monitor temperature, product supply and alarm status.

Three RS232 connectors are employed as follows: RS232 #2 is available for connection with a GPS receiver, RS232 #1 is available for connection with a laptop computer or PDA and RS232 #3 is available for future expansion.

In mobile unit 117, (FIG. 7) GPS receiver data is double buffered for fast delivery and comes in via connector RS232 #2, A Palm, Laptop or other RS232 device can be connected to Rs232#1. 1 MB of RAM is available in the unit. An LCD display 160 and connector for a PC keyboard 164 are used to send and receive text Informational packets. Keyboard 164 is hex buffered. A sounder 166 gives an alert tone when Informational packets are received, and an optional USB connector is available for future expansion.

The mobile transceiver unit 117 preferably includes up to one megabytes of RAM, a 32 KB EPROM, a 8 KB EEPROM, a PIC18C452 Processor having a Processor frequency of 19,660,800 Hz. Modulation is 4-level FSK and the Modulation rate is preferably 9600 symbols/second. The radio mode is Simplex or half duplex and a 12 VDC power source is required. The housing is adapted for use in a vehicle or on a desk top.

(B) Circuit Description and Operation—As above, the numbers shown in parenthesis correspond to line number of the source code for the function described. The firmware is in the PIC18C452 microprocessor 162 and runs all circuit components. For typical operation, the radio is connected at the Tx audio Amp filter inverter circuit, Rx audio Amp filter inverter circuit, Level shifter for PLL or Rx/Tx control circuits. In addition a PC keyboard is connected 164 and LCD 160 may also be connected. A laptop computer, PDA or mobile terminal 118 may be connected to Rs232#1 and GPS receiver 120 may be connected to port Rs232#2.

Most of the Mobile unit's circuitry shown in FIG. 7 is included on a single printed circuit (PC) board except for the Radio, the GPS unit 120, and the Control head 118,

The received signal from the radio is filtered and amplified by the Rx audio amp filter inverter circuit 168, This circuit may be jumpered for signal inversion. The receive signal then goes to the four level FSK modulator for demodulation. This is run by the microprocessor 162 and is continuously searching for a header block (source code line number 01728) in the receive signal. When it finds one it is decoded (source code line number 01734) and the microprocessor determines if it is for this unit (source code line number 01794). If it is not, the header block search will continue (source code line number 01708). If no header blocks are being detected then the microprocessor will change the channel of the radio (source code line number 01718).

If the header indicates the packet is for this receiving unit, then the data blocks will be decoded (source code line number 01942). Then CRC for these data blocks is checked (source code line number 02044) and microprocessor 162 determines what to do with the data (source code line number 02053). The data may be sent to the LCD 160 and/or out RS232#1 to a PDA, computer or other device 118, Reception is usually followed with a transmission indicating that the data has been received without errors. GPS data may be included in the transmission (source code line number 02668).

GPS receiver 120 is connected to port RS232#2, The microprocessor 162 reads (source code line number 00352) and double buffers GPS data (source code line numbers 00499 ). Double buffering of GPS data allows the most recent GPS data to be sent without delay. Micro controller 162 continuously monitors GPS data and when vehicle movement is detected the data is time stamped, buffered and transmitted to the remote base unit. GPS information may also be requested by the remote base unit 140 and sent in the next transmission.

GPS data is evaluated to detect vehicle movement and speed (source code line number 01505). GPS data is combined with the date/time compression and stored before being transmitted (source code line number 04479). When the vehicle is out of range of a tower site controller, the GPS and clock data is stored in the mobile unit memory (source code line number 04929). This stored data is transmitted when the vehicle is back in range of a tower site controller 140,

Mobile unit 117 contains a real time clock that continues to keep time when the unit is without power. The date and time information stored within mobile unit 117 is periodically synchronized with the clock in the tower site controller 140,

A PC keyboard 164 and LCD 160 may be connected to the mobile unit. The microprocessor 162 reads the keyboard (source code line number 00508) and hex buffers the data. During idle periods of receive header activity, microprocessor 162 reads the key board buffers (source code line number 05556) and displays characters on the LCD 160 (source code line number 05701).

A laptop computer or PDA 118 may be connected via port Rs232#1, The microprocessor continuously reads RS232 data from Rs232#1 (source code line number 00607). The data must be in MDPP packet format and is buffered by the microprocessor (source code line number 00621). When an end of the MDPP packet is detected (source code line number 00703) the data is processed (source code line number 02905) and marked for transmit (source code line number 02936).

Mobile unit transmission is controlled by the reception of polling header blocks which are sent from the tower site controller 140, Transmissions may occur when the tower site controller 140 requests a transmission via a polling header block or when specific header block is received.

The tower site controller 140 will usually request a transmission after it sends an information packet to the mobile unit 117, This transmission indicates that the Informational packet has been received without errors. GPS data may be included in the transmission.

When the mobile unit has data to send from the keyboard or computer connection, the microprocessor 162 will set a transmit flag (source code line number 00337). The microprocessor will then watch the receive headers for an polling header (source code line number 01829). When this header is detected, the transmit program code is executed (source code line number 03144). After transmitting, the microprocessor 162 will expect to receive a header from the tower site controller 140 indicating that the data has been received without errors (source code line number 02277). Receiving this data has been received without errors header from the tower site controller 140 will clear the transmit flag in the mobile unit (source code line number 02284). Otherwise the transmit flag (source code line number 00337) will continue to be set and this procedure will repeat. The procedure described under “receiving” is used in conjunction with this procedure to receive the signal and change channels.

When a transmission occurs, microprocessor 162 sends the transmit frequency assignment to the radio (source code line number 05957) via the PLL circuit. The Rx/Tx control circuit will key the transmitter (source code line number 03396). The four level FSK modulator modulates the data from microprocessor 162 (source code line number 03575) and generates the audio to be transmitted with the Tx Audio Amp filter inverter circuit 168, The Tx Audio Amp filter inverter circuit 168 filters this audio and also provides signal inversion if needed.

When the transmission is done, the transmitter is release the transmitter (source code line number 03380). The microprocessor 162 sends the receive frequency assignment to the radio via the PLL circuit (source code line number 03382) and the receiver is activated.

The mobile unit also has circuitry to automatically power down the radio, GPS 120 and other circuitry 164, 160, 118 to conserve battery power when these items are not needed.

The mobile unit 117 has an on board EEPROM 162a that contains operating characteristics of the unit. This EEPROM 162a can be programmed via one of the RS232 ports, through the keyboard 164 or over the air. The most important characteristics of the mobile unit is the MIN. The MIN is a six digit mobile identification number. Each mobile must have a different MIN.

Table 5 provides mobile unit addresses of variables in EEPROM 162a and typical values, the addresses and values are listed in hex format:

TABLE 5
Addresses of EEPROM variables

| Name | Addr | Typical Value | ;Description |
|---|---|---|---|
| RemPrg | 0x80 | 00 | ;Data Must be >= RemPrg to program eeprom 00 will always program |
| MINUper | 0x88 | 55 | ;First two digits of mobile identification number |
| MINHigh | 0x89 | 55 | ;Next two digits of mobile identification number |
| MINLow | 0x8a | 55 | ;Last two digits of mobile identification number |
| RadType | 0x8b | 00 | ;Radio type: 00 = Maxon 01 = Jonhson unit |
| EpChk | 0x8c | 56 | ;Set to ‘V’ check for valid eeprom read |
| ChAdder | 0x8d | 00 | ;Base number added to EpChans for channels above FFh |
| EpPasWd | 0x8e | 00 | ;Eeprom password |
| EpVersn | 0x8f | 02 | ;Firmware version |
| EpTXRty | 0x90 | 8F | ;Number of TX Retrys for Informational packets must be greater |
| | | | ;than 81h Set to 8F for 14 retrys |
| EpSigLs | 0x91 | 2F | ;RX Signal loose period for channel change |
| | | | ;Set to 1F for about 1 sec between channel changes |
| EpTWait | 0x92 | 0A | ;Wait time in second between TX attempts |
| | | | ;If B7 = 1 then add MIN low to EpTWait |
| EpPowDn | 0x93 | 08 | ;Wait time (30 s in increments) before RX & TX power down |
| RegIdle | 0x94 | 08 | ;Wait time (30 s increments) before registration repeat when not moving |
| EpRgChg | 0x95 | 03 | ;Wait time (30 s in increments) before registration after channel change |
| EpRgRty | 0x96 | 84 | ;Number of TX Registration attempts —80. Must be greater than 81h |
| | | | ;This number is doubled if it is an ignition off transmission |
| EpTXTryC | 0x97 | 03 | ;Number of TX Retrys before channel change |
| | | | ;B7 = No Preset on RX Ch Chg B6 = No TX after TX Ch Chg |
| OptBits | 0x98 | 82 | ;B7 = 1 No RX full B5 = 0 Power Sw on B4 = 1 No GPS |
| | | | ;B3 = 0 Initialize B2 = 1 GPS in Hdr9 B1 = 1 No Palm |
| TstBits | 0x99 | 08 | ;B7 = 1 Rg On PortA bit change B3 = 1 Speed & Dir |
| | | | ;B2 = 1 RX Full NAK B1 = 1 No RXRs232 B0 = 1 60 sec |
| RegMov1 | 0x9A | 02 | ;Wait time (30 s) before registration with GPS movement B7 = 1 Never |
| RegMov2 | 0x9B | 04 | ;Wait time (30 s) before registration after GPS movement B7 = 1 Never |
| RgTXCnt | 0x9C | 02 | ;Count of buffered registrations or GPSs this for a |
| | | | ;batched transmission to be attempted |
| GpslOff | 0x9D | 07 | ;Wait count in 30 min multiples for GPS power off after ignition off & RX off |
| GPStWt | 0x9E | 06 | ;GPS wait time (30 s) with high memory B7 = 1 When high mem is in use |
| GPSand | 0x9F | FC | ;Anded with GPS for movement detection Set to FC or 00 for none |
| EpPolAA | 0xA0 | 0F | ;Polling Bits: B7 = 1 Cmp 8 bit MIN low |
| EpPolBB | 0xA1 | 00 | ;B6 = 1 Cmp 4 bit MIN low |
| EpPolCC | 0xA2 | 0F | ;B5 = 1 Not a Registration TX |
| EpPolDD | 0xA3 | 0F | ;B4 = 1 Channel has changed |
| EpPolEE | 0xA4 | 0F | ;B3 = 1 A Registration TX |
| EpPolFF | 0xA5 | 00 | ;B2 = 1 Third & above retry |
| EpPolBC | 0xA6 | 00 | ;B1 = 1 No REG on 4 bit MIN low |
| EpPolBD | 0xA7 | 0F | ;B0 = 1 All TX allowed |
| EpChans | 0xB0 | | ;Up to 8 FCC channels numbers in hex |

Turning now to the mobile unit RS232#1 commands and configuration the following commands (in quotes) are sent from or received by the mobile unit 117 on the RS232#1 connection. The RS232#1 connection can also receive and send MDPP formatted informational packets as well as program and verify the EEPROM 162a.

The following commands are sent out of the mobile unit 117 on the RS232#1 connection. These messages give operational status of the mobile unit 117 and the status of messages in it.

TABLE 6
Command Strings from unit

| Command string | Result |
|---|---|
| “,Rv0s11m61.” | An Informational packet is waiting in buffer 0, |
| | 11 is the serial number and 61 is the mode. 0 |
| | can be 0, 4, 8 or C |
| | You must read the buffer with Rx0 command then |
| | Erase the flag with the Rz0 command. |
| “,TX0s11m21.” | An Informational packet in TX buffer 0 is being trans- |
| | mitted, 11 is the serial number and 21 is the mode. 0 |
| | can be 0, 4, 8 or C |
| “,Ti0s11m21.” | Transmit time out in TX buffer 0, 11 is the serial |
| | number and 21 is the mode. 0 can be 0, 4, 8 or C |

The following commands are sent to the mobile unit 117 on the RS232#1 connection. These command are used to check the status of, retrieve or verify messages in the mobile unit 117 RS232#1 connection.

TABLE 7
Command Strings to unit

| Command string | Result |
|---|---|
| “Rz0” | Erases Informational packet flag in buffer 0 0 |
| | can be 0, 4, 8 or C |
| “RX0” | Sent Informational packet in receive buffer 0 |
| | out RS232#1 in MDPP format |
| | 0 can be 0, 4, 8 or C |
| “Rs0” | Sent Informational packet in transmit buffer 0 out in |
| | MDPP format out Rs232#1 0 |
| | can be 0, 4, 8 or C Watch for ok or Ti (TX Time out). |
| “HH0” | Send the values of the on board memory |
| | of the micro controller 162 out on Rs232#2 |
| | This command in used to verify the values in the |
| | EEPROM 162a. |

Programming the on-board EEPROM 162a through RS232#1 port is set forth in Table 8; the command “>SPhhdddddddddddddddd” programs 8 bytes in the EEPROM at a time. The two hex digits “hh” must be the starting Address to be programmed (must be 80, 88, 90, 98, A0, A8, B0 or B8). These are follow by exactly 16 hex digits of data. Eight addresses must be programmed at one time. The RS232#1 command “HH0” may be used to check the programming results.

TABLE 8
EEPROM programming with RS-232#1

| | |
|---|---|
| >SP = | Set eeprom |
| hh = | Address to program (must be 80, 88, 90, |
| | 98, A0, A8, B0 or B8) |
| dddddddddddddddd = | 8 bytes of data entered as |
| | 16 hex digits of data |
| >SPB00AD0F1F7 00000000 | |

The above will program the addresses between B0 and BF to the values of 0A D0 F1 F7 00 00 00 00,

The problem with RS232#1 commands is that they must be done at the mobile unit. Over the air commands can be done remotely. Table 9 provides over-the-air command strings. These commands can do over-the-air inquires, GPS locations, programming and even disable the mobile unit.

TABLE 9
Other over-the-air command subject strings (in quotes)

| Command string | Result |
|---|---|
| “,.,qQqStDa07” | Send an acknowledgment usually used |
| | with GPS |
| “,.,qQqStDh07” | Hex dump of address 07 other address |
| | may replace the 07 |
| | This is used to verify the EEPROM in the mobile |
| “,.,qQqStDr07” | Send a registration usually used |
| | with GPS |
| “,.,qQqStDz07” | Erase buffer flags this will fix buffer |
| | full problems |
| “,.,qQqStDp07” | This will set the date/time clock in |
| | the mobile unit |
| | The message part of the Informational packet must be |
| | “@>SPst”!I533” to set the clock in the unit |
| “,.,qQqStDp07” | This will program the eeprom 162a |
| | in the mobile unit |
| | The message part of the Informational packet must be |
| | “@>SPhhdddddddddddddddd” Where “hh” is |
| | the address in the EEPROM. “hh” can |
| | be 80, 88, 90, 98, A0, A8, B0 or B8. |

The 8 bytes starting at address “hh” will be set to 16 hex digits which replace the “dddddddddddddddd” in the string.

When programming the on-board EEPROM 162a over the air, the command program steps set forth in Table 10 are used.

TABLE 10
EEPROM programming steps (over the air)

1) Send a short Informational packet to the unit with a subject
of: “,.,qQqStDp07”
2) The message portion of Informational packet of must contain the string:
“@>Sphhdddddddddddddddd” Where “hh” is the address in the
EEPROM. “hh” can be 80, 88, 90, 98, A0, A8,
B0 or B8. The 8 bytes starting at address “hh” will be set
to 16 hex digits which replace the “dddddddddddddddd” in the string.
3) The command “@>SPhhdddddddddddddddd” may be followed by
a sequence of “>SPhhdddddddddddddddd” to program
more eeprom addresses.
4) A Informational packet message of: “@>SPB80123456789ABCDEF”
will set address B8 to the value “01234567890ABCDEF”.
5) The unit will return a hex dump of the eeprom memory after it is
programmed. This should be used to verify that programming
has properly taken place.

When programming the mobile unit on-board EEPROM with keyboard 164, two hex digits must be entered for the address and 16 hex digits of data. The addresses must be 80, 88, 90, 98, A0, A8, B0or B8, Table 11 gives some EEPROM programming examples with keyboard.

TABLE 11
EEPROM programming example with keyboard

| | |
|---|---|
| 1) | To program channels 10, 208, 241 and 247 do the following: |
| | Press F2 then enter “>SPB00ad0f1f700000000”, then press F1; |
| 2) | To program MIN of channels 456789 do the following: |
| | Press F2 then enter “>SP884567890056000001”, then press F1; |
| 3) | An 8 addresses starting with 80, 88, 90, 98, A0, A8, B0 or B8 may |
| | be programmed in this way. |

### V. MDPP Packet Structure and Command Strings t

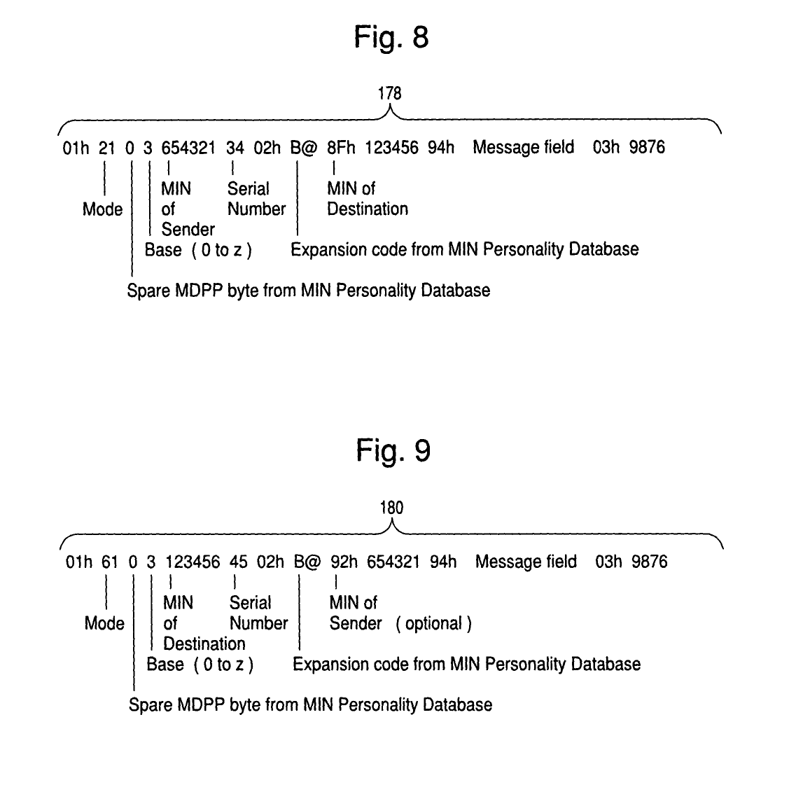

MDPP packets are data packages of up to 950 bytes in length, that contain a series of commands, delimiters, source & destination codes, message & GPS data information, and utility codes that are transmitted between mobile units/controllers (116 and 117) and the mobile data central controller 110, The MDPP packet structure is illustrated in FIG. 8 showing a mobile originated packet 178, and in FIG. 9 showing a controller originated packet 180, These packets are routed through remote base systems 124 to the central controller 110 for analog operation.

Each packet may include any number of fields of alpha-numeric and hex data. Referring to mobile generated packet 178 in FIG. 8, the “01 h”, “02 h” and “03 h” are hex bytes with exactly 12 bytes residing between “01 h” and “02 h”. The first field of the packet contains hex byte “01 h” indicating the start of the packet This is followed by a two byte “mode” field, a “spare” one byte field, and a one byte “base” identifier (0 to z) field. In analog operation, the remote base unit that carries the packet, also modifies the packet by inserting its own unique base identifier code into this location. This modification is performed by the associated Racom 1700 mobile data base controller 140 located at this remote base 124,

The identity of the sender is in the next field which is six bytes in length. This identifier is referred to as the “MIN”, or mobile identification number, and is a unique six digit number between 000000 and 999999, The last field before “02 h” hex byte is the serial number field. An incremental counter generates the next serial number, to be assigned to this new packet, and it is placed into this serial number field which is two bytes in length. Following the “02 h” hex byte is a “B@” expansion code, and a delimiter “8Fh” which indicates that the next six bytes contain the destination MIN. After the MIN, delimiter “94 h” indicates the start of the “message/GPS data field. This field can be of variable length up to a maximum of approximately 900 bytes. Hex byte “03 h” then immediately follows the message field. Finally a two byte checksum field completes the packet.

A controller generated packet 180 is shown in FIG. 9, It is similar in structure to the mobile generated packet 178, except that the destination MIN resides between hex bytes “01 h” and “02 h” and the sender's MIN resides after the “B@” expansion code and is designated as a sender MIN by delimiter “92 h”. For either packet 178 or 180, other delimiters indicating further information may be inserted at this point, after the MIN which follows the “B@”, prior to the message delimiter “94H” and after the message field.

Within the MDPP packets shown in FIGS. 8 and 9, a pre-defined set of delimiters provide a guide to permit the receiving unit to parse the packet data and take only that which is needed. Some delimiters are only used in certain contexts. In Table 13, the master list of all delimiter codes, and the following tables, the Usage codes are defined as: “B”—Sent by both unit and controller, “M”: Sent by unit to controller, and “C”: Sent by controller to unit.

The following codes are used in the two byte “mode” field found immediately after the “01 h” start byte in the MDPP packet description above.

TABLE 12
Mode Codes

| Unit Generated Applications | 1700MDPPX & Unit Mode Code |
|---|---|
| Unit to unit short messaging | 21H |
| Unit e-mail | 22H |
| Unit Binary | 23H |
| Unit Check Verification | 24H |
| Unit Credit Card | 25H |
| Unit fax | 26H |
| Unit Inventory Check | 27H |
| Unit Invoice sent | 28H |
| Unit GPS polled | 29H |
| Request for Directions sent to unit | 29H |
| Unit Form Definition | 2AH |
| Unit Form Field Definition | 2BH |
| Unit Form Content | 2CH |
| Spare | 2EH |
| Unit Registration with GPS if available | 2FH |
| Unit is asking controller to acknowledge | 31H |
| Unit Programming | 32H |
| Unit multiple part Informational message (see delimiters FC & FD) | 34H |
| Acknowledgment of received Informational MDPP packet | 36H |
| Stop transmitting acknowledgment of RX'd packet | 37H |
| Acknowledgment of low level MDPP packet | 38H |
| Request time slot assignment | 3AH |
| Negative Ack of RX'd Info packet (RX Error) | 3BH |
| Applications Received By Unit | 1700MDPPX& Unit Mode Code |
| Unit to unit short messaging: | |
| Unit to controller | 21H |
| Controller to unit | 61H |
| E-mail to unit | 62H |
| Binary to unit | 63H |
| Check approval to unit | 64H |
| Credit Card Approval | 65H |
| Fax to unit | 66H |
| Inventory Check to Unit | 67H |
| Invoice sent to unit | 68H |
| Directions sent to unit | 69H |
| Form Definition | 6AH |
| Form Field Definition | 6BH |
| Form Content | 6CH |
| Spare | 6EH |
| Registration with GPS if available to Dispatcher | 6FH |
| Controller is asking unit to acknowledge | 71H |
| Over the Air Programming | 72H |
| Unit Controller Programming | 73H |
| Multiple part message (see delimiters FC & FD) | 74H |
| Acknowledgment of received packet | 76H |
| Stop transmitting ACK of RX'd packet | 77H |
| Time sync - Sets RT clock in all units | 78H |
| (Hdr2 += Yr Mn Day Hr Min Sec) | |
| Assign time slot | 7AH |
| Negative ACK of RX'd packet (RX Error) | 7BH |
| Acknowledgment of low level packet | |
| Dump memory 070h to 0EFh to sites@. . . | 7DH |
| 1700MDPPX needs to limit number Txs | |

Table 13 shows the master list of all delimiter codes used in MDPP packet construction.

TABLE 13
MDPP field delimiters (master list of all delimiter codes)

| Delimiters in the Info packet field | Description | Usages |
|---|---|---|
| 8Fh Destination | MIN follows | M |
| 90h Destination | Friendly name follows | M |
| 91h Start of first field - Destination | Email address follows | M |
| 92h Start of second field - from | Return email adr is here during RX | C |
| 93h Start of third field - subject | | B |
| 94h Start of fourth field - message | | B |
| 95h Start of fifth field - data | | B |
| 96h Start of GPS data field - | GPS data | M |
| 97h Reply to email address | | C |
| 98h Email sent from address | | C |
| 99h Date Time email stamp | | C |
| 9Ah Min of message sender | For email A00123 | C |
| 9Bh Compressed date & time field - Date/Time Data | | M |
| 9Ch Start of GPS compressed data field - GPS Data | | M |
| A0h Form fields #1 | | B |
| A1h Form fields #2 | | B |
| A2h Form fields #3 | | B |
| A3h Form fields #4 | | B |
| A4h Form fields #5 | | B |
| A5h Form fields #6 | | B |
| A6h Form fields #7 | | B |
| A7h Form fields #8 | | B |
| A8h Form fields #9 | | B |
| A9h Form fields #10 | | B |
| AAh Form fields #11 | | B |
| ABh Form fields #12 | | B |
| ACh Form fields #13 | | B |
| ADh Form fields #14 | | B |
| AEh Form fields #15 | | B |
| AFh Form fields #16 | | B |
| B0h Form fields #17 | | B |
| B1h Form fields #18 | | B |
| B2h Form fields #19 | | B |
| B3h Form fields #20 | | B |
| B4h Form fields #21 | | B |
| B5h Form fields #22 | | B |
| D0h End of field, message, GPS or data | | B |
| D1h 1 Byte follows | | B |
| D2h 2 Bytes follows | | B |
| D4h 4 Bytes follows | | B |
| D6h 6 Bytes follows as with MIN | | B |
| D7h 2 Bytes follows and loaded into header position 7 | | B |
| D8h 8 Bytes follows as with MIN + Serial | | B |
| DEh End of GPS data not locked (Done) | | M |
| DFh End of message field, GPS data or data area (Done) | | M |
| E6h GPS Error | | M |
| EDh GPS Overflow error | | M |
| EEh Other error | | B |
| F0h Raw 8 data bytes will follow; next two bytes are the data byte count | | B |
| F1h 128 bytes of 8 bit data follow | | B |
| F2h 256 bytes of 8 bit data follow | | B |
| F8h 256 bytes of unit personality data follow | | C |
| F9h Personality Character follows; next two bytes are personality of unit | | B |
| FAh Number of packets in message field; Next two bytes are the byte count | | B |
| FBh Exact Packet length; next 3 hex bytes are packet length | | B |
| (Delimiters FCh & FDh are for a multiple part message) | | |
| FCh Packet number N of many; next bytes are the packet number | | B |
| Used with GPS storage FCh 01 = First of several parts | | |
| FCh zz = Last of several parts | | |
| FDh Total packet count; next 2 hex bytes are the total count | | B |

Table 14, below, is an example of the delimiters that may be in a short message being sent from a mobile unit 117 into the system 100, This is mode code type “21H”—Unit to controller short messaging.

TABLE 14
Info packet field delimiters (Application Sent By Mobile Unit)

| Delimiters in the Info packet field | Description | Usage |
|---|---|---|
| 8Fh Destination | MIN follows | M |
| 90h Destination | Friendly name follows | M |
| 93h Start of third field - subject | | B |
| 94h Start of fourth field - message | | B |
| field | | |
| 96h Start of GPS data field - | GPS data follows | M |
| D5h End of message field | | B |
| D6h End of message field, GPS data or | | M |
| data area (Done) | | |
| E6h GPS Error | | M |
| EDh GPS Overflow error | | M |
| EEh Other error | | B |

Note:
Destination is 8Fh or 90h but not both

Table 15, below is an example of the delimiters that may be in a short email message sent from a mobile unit into the system. This is mode code type “22H”—unit to email short messaging.

TABLE 15
Info packet field delimiters(Application Sent By Mobile Unit)

| Delimiters in the Info packet field | Description | Usage |
|---|---|---|
| 91h Start of first field - Destination | Email address follows | M |
| 93h Start of third field - subject | | B |
| 94h Start of fourth field - message | | B |
| 96h Start of GPS data field - | GPS data follows | M |
| DEh End of GPS data not locked | | M |
| (Done) | | |
| DFh End of message field, GPS data or | | M |
| data area (Done) | | |
| E6h GPS Error | | M |
| EDh GPS Overflow error | | M |
| EEh Other error | | B |

Table 16, below, provides an example of the delimiters that may be in a short message being received by a mobile unit from the system. This is mode code type “61 H”—Controller to Mobile Unit short message packet

TABLE 16
Info packet field delimiters (Application Received by Mobile Unit)

| Delimiters in the Info packet field | Description | Usage |
|---|---|---|
| 92h Start of second field - from | Friendly name or MIN | C |
| | follows | |
| 93h Start of third field - subject | | B |
| 94h Start of fourth field - message field | | B |
| 9Ah Min of message sender | | C |
| D5h End of message field | | B |
| EEh Other error | | B |

Table 17, below, is an example of the delimiters that may be in a short email message being received by a mobile unit from the system. This is mode code type “62H”—Email to Mobile Unit.

TABLE 17
Info packet field delimiters (Application Received by Mobile Unit)

| Delimiters in the Info packet field | Description | Usage |
|---|---|---|
| 92h Start of second field - from | Return email follows | C |
| 93h Start of third field - subject | | B |
| 94h Start of fourth field - message field | | B |
| D5h End of message field | | B |
| EEh Other error | | B |

For transmission of MDPP packets including compressed date and time data, the following delimiters are described in the table 18.

TABLE 18
Compressed date/time Info packet delimiters

| Delimiters | Description | Usages |
|---|---|---|
| 9Bh | Compress date & time field - Date/Time data | M |
| Byte 1 | 2 bytes of month in binary + 20 h | (2 Bytes Compressed Into 1) |
| Byte 2 | 2 bytes of day in binary + 20 h | (2 Bytes Compressed Into 1) |
| Byte 3 | 2 bytes of hour in binary + 20 h | (2 Bytes Compressed Into 1) |
| Byte 4 | 2 bytes of minute in binary + 20 h | (2 Bytes Compressed Into 1) |
| Byte 5 | 6 bits of unit status in binary + 20 h | (2 Bytes Compressed Into 1) |
| | 1Fh = Full | |
| | 1Eh = Error | |
| | 1Dh = Power off | |
| | 1Ch = Power on | |

For transmission of MDPP packets including compressed GPS data, 10 bytes (as follows) are provided after the delimiter.

TABLE 19
Compressed GPS Info packet delimiters

| Delimiters | Description | Usages |
|---|---|---|
| 9Ch | Start of GPS compressed data field - GPS data | M |
| Byte 1 | 2 bytes of latitude degrees in binary + 10 h | (2 Bytes Compressed Into 1) |
| Byte 2 | First 2 bytes of latitude minutes in binary + 10 h | (2 Bytes Compressed Into 1) |
| Byte 3 | Next 2 bytes of latitude minutes in binary + 10 h | (2 Bytes Compressed Into 1) |
| Byte 4 | 2 bytes of longitude degrees in binary + 10 h | (2 Bytes Compressed Into 1) |
| Byte 5 | First 2 bytes of longitude minutes in binary + 10 h | (2 Bytes Compressed Into 1) |
| Byte 6 | Next 2 bytes of longitude minutes in binary + 10 h | (2 Bytes Compressed Into 1) |
| Byte 7 | Speed as presently transmitted | |
| Byte 8 | Direction as presently transmitted | |
| Byte 9 | Next byte of latitude and Next byte of longitude in binary + 10 h | |
| Byte 10 | Minutes of time in binary + 20 h. These minutes are based on the last | |
| | 9Bh (Compress date & time field) sent. Except with multiple part stored GPS. | |
| | If the hour should change another 9Bh (Compress date & time field) will | |
| | be inserted into the data stream at the proper point. | |

The delimiter may or may not repeat after the 10ₜₕ byte. Selected GPS storage situations may require use of multi-part delimiters. In those situations, the delimiter “FCh” indicates that GPS storage has multiple parts. The delimiter “FCh” can occur at the beginning of the GPS data field as part the letters “MobR”, but “Mob” can not be used as a look up. The R may be used if needed. The delimiter “FCh” can also occur in the GPS data field, in which case it has the actual part number, as shown in Table 20, below.

TABLE 20
Compressed GPS Info packet delimiters for Multi-part GPS storage

| | |
|---|---|
| MobR(FC)01 | First part of many |
| MobR(FC)12 | Second part of many |
| MobR(FC)23 | Third part of many |
| MobR(FC)zz | Last part of many |
| (FC)01 | Part 1 |
| (FC)02 | Part 2 |
| (FC)03 | Part 3 |

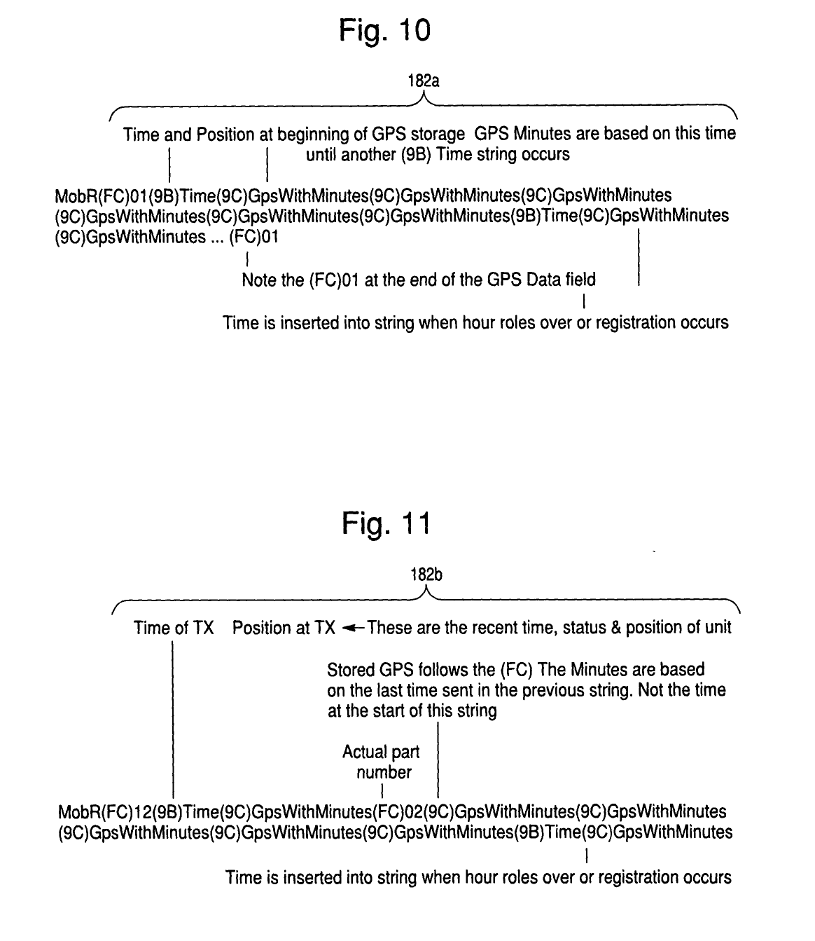

When transmitting MDPP packets including multiple-part GPS storage sub-parts, the GPS data is arranged with delimiters in what may be considered a typical or exemplary packet string format, as illustrated in FIGS. 10, 11, 12 and 13 which show a sequence of a first string part of many, a second string part of many, a third string part of many and a last string part of many, respectively. Referring to the string 182a of FIG. 10, for a typical string, the first part of many is shown. Time and Position data at beginning of the GPS storage process are included in the string and data in the GPS Minutes field are based on this time until another (9B) Time string occurs.

Referring next to FIG. 11, the second part of many, a string 182b including the delimiter “MobR(FC)12” includes “Time of TX” data and “Position at TX” data which comprise the recent time, status & position of unit and Stored GPS follows the (FC). The minutes data are the based on the last time sent in the pervious string. Not the time at the start of this string.

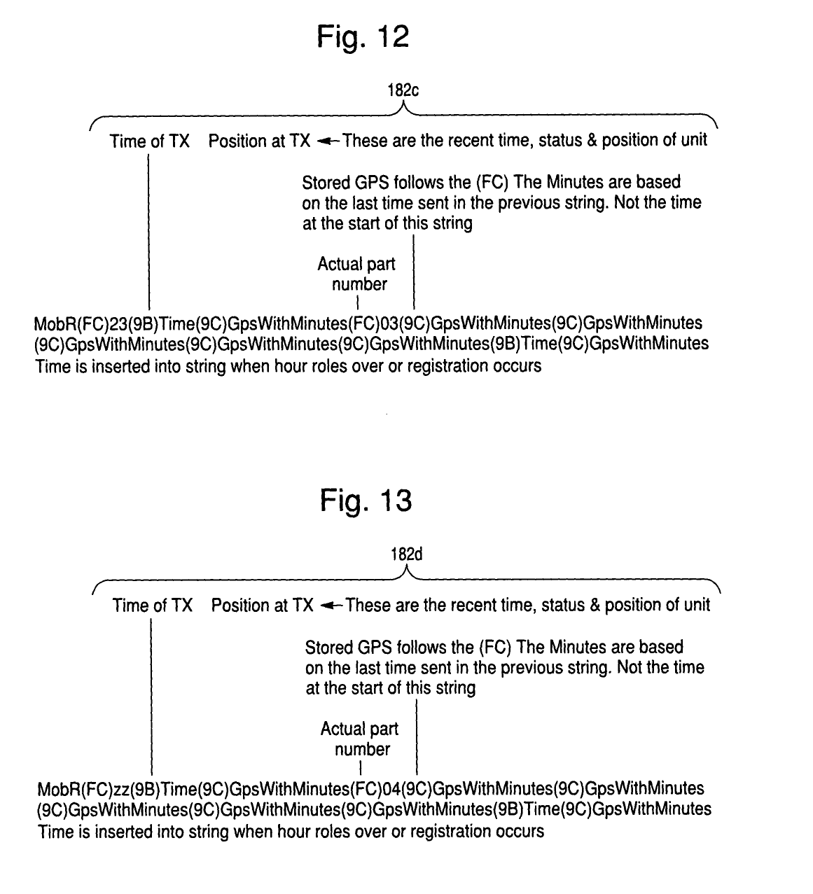

Referring next to FIG. 12, the third part of many, a string 182c including the delimiter “MobR(FC)23” also includes “Time of TX” data and “Position at TX” data which again comprise the recent time, status & position of unit and Stored GPS follows the (FC). As before, the minutes data are the based on the last time sent in the pervious string. Not the time at the start of this string. Typically, many more strings like this would be expected before reaching the string 182d including “the last part of many”, as shown in FIG. 13, a string including a delimiter in the form of “MobR(FC)zz” (where zz are variables corresponding to the delimiter number reached by incrementing the delimiter count field using the method shown in Table 14, above). As before, the string of FIG. 13 includes “Time of TX” data and “Position at TX” data which again comprise the recent time, status & position of Mobile unit and Stored GPS follows the (FC). As before, the minutes data are the based on the last time sent in the pervious string. Not the time at the start of this string. For each of the strings shown in FIGS. 10-13, a value for “Time” is inserted into the command string when the hour rolls over or when registration occurs.

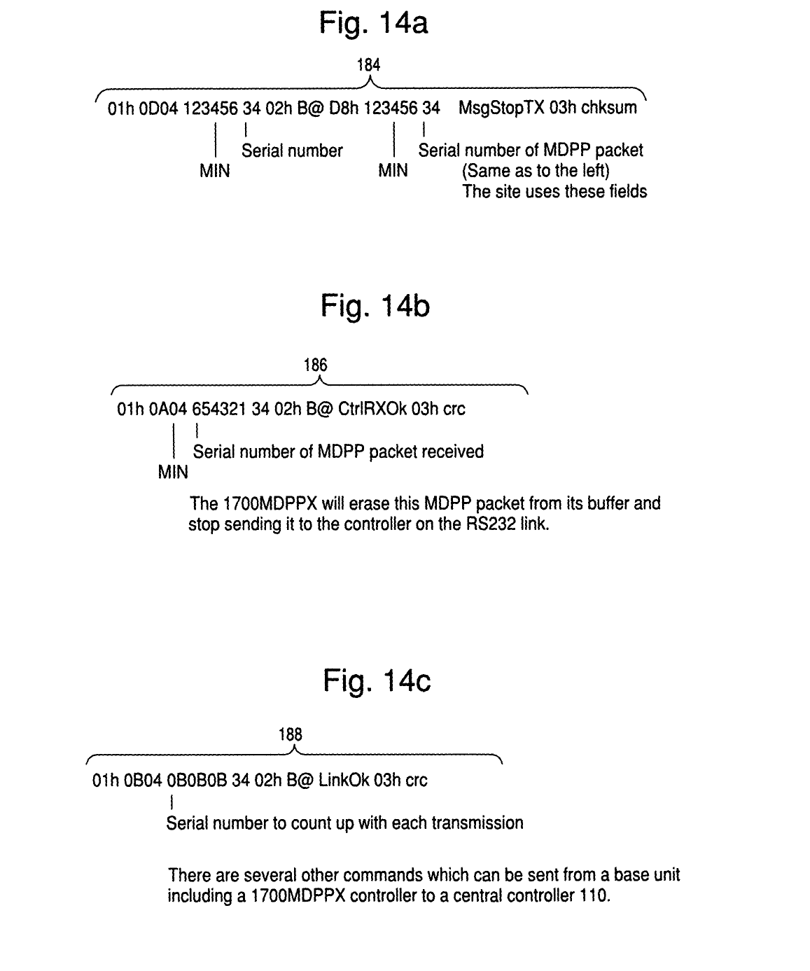

There are several other commands, which can be sent from central controller 110 to other units such as a base unit including a 1700MDPPX controller. FIGS. 14a-c, 15a-d and 16a and b illustrate a number of exemplary command strings. Referring specifically to FIGS. 14a-c, a string corresponding to “1”, a selected character (represented by the variable “x”), and then “h”, can be used to relay a command to stop transmitting an MDPP packet (0Dh) as shown in command string 184, Similarly, “0Ah” can be used to relay a command to acknowledge that an error-free MDPP packet was received by central controller 110 as shown in command string 186, and “0Bh” can be used to relay a command to send an MDPP utility packet every two minutes and keep the 1700MDPPX working, as shown in command string 188, in which case the 1700MDPPX will erase this Informational packet from its buffer and stop sending it to the controller 110 on the RS232 link.

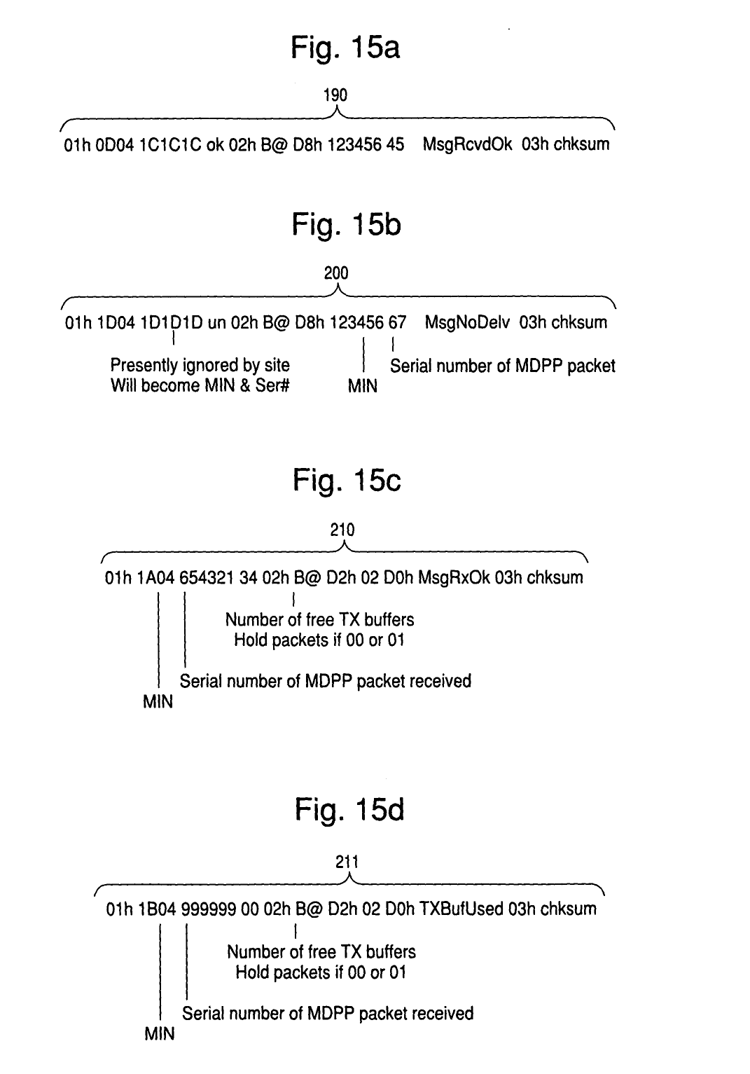

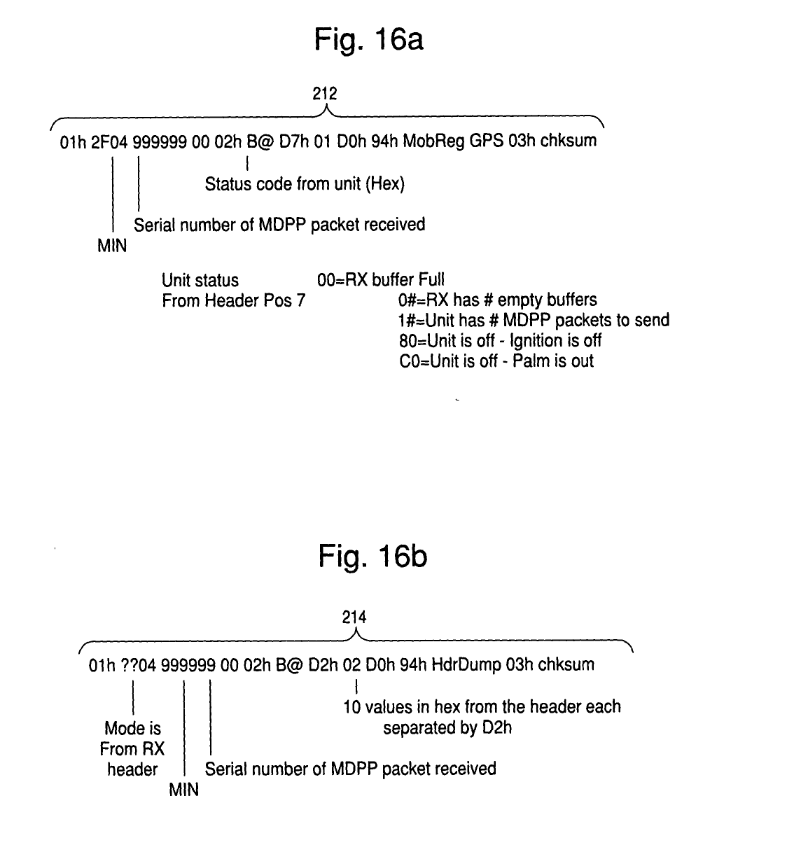

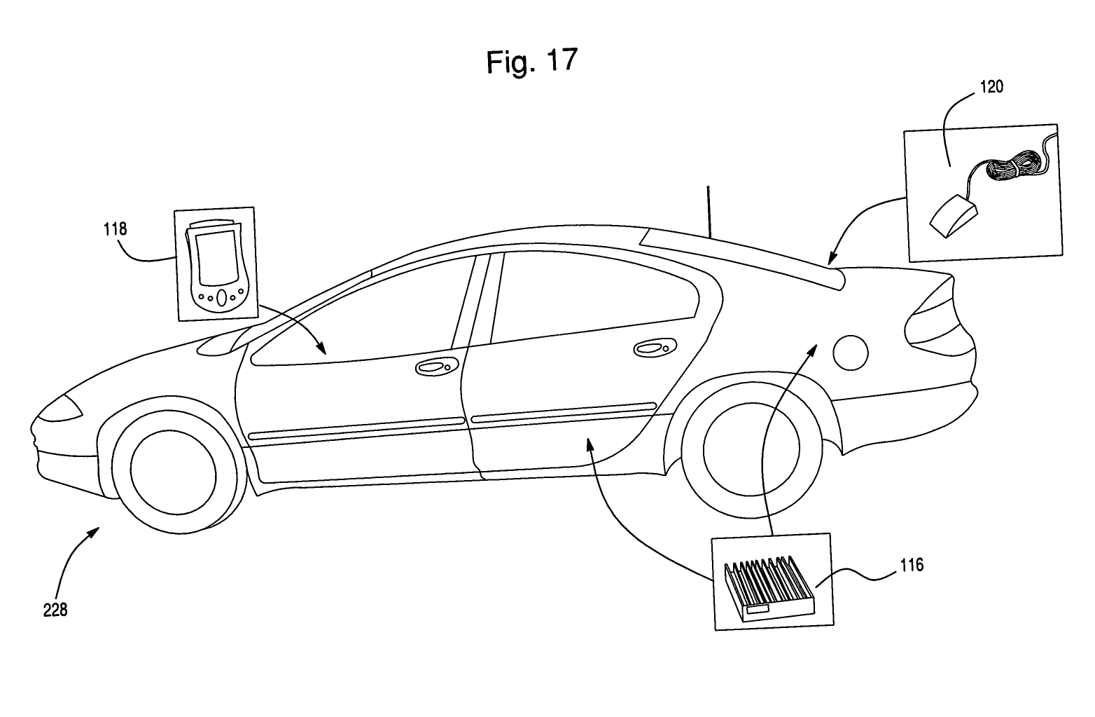

There are several other commands, which can be sent from a base unit including a 1700MDPPX controller to a central controller 110, FIGS. 15a-d illustrate four exemplary command strings 190, 200, 210 and 211, FIGS. 16a and b illustrate two exemplary command strings, 212 and 214, Referring now to FIGS. 15a-d, command string 190 “1Ch” can be used to relay that an MDPP packet has been delivered. Command string 200 “1Dh” can be used to relay a that an MDPP packet has not been delivered. Command string 210 “1Ah” can be used to acknowledge that an error-free MDPP packet was received from central controller110. Command string 211 “1Bh” can be used to relay a reported number of transmit buffers identified as “free”, this report is sent every thirty seconds.

Referring now to FIG. 16a, command string 212 “2Fh” can be used to relay a unit registration that is sent when a given unit is powered up or periodically (e.g., every selected number of minutes) or when a tower is changed. FIG. 16b shows command string 214 in the format of “??”; this command string can be used to relay that some other header mode code was received.

The mobile unit transceiver with LCD unit 160 can be used to send an MDPP message using the following four step procedure:

1) Press F9 and type in the message.

2) One can send the message to a MIN, friendly name or email address.

3) Press F2, F3 or F4 and then enter the MIN, friendly name or email address.

4) Press F1 to send the message to the MIN, friendly name or email address specified.

The system display will now be shown.

The mobile unit 117 or mobile transceiver preferably includes a keyboard 164 with unit function keys which can be used to make entering selected commands more convenient.

TABLE 21
UNIT FUNCTION KEYS

| FUNCTION KEY | DESCRIPTION OF ITEM |
|---|---|
| F1 | Send the MDPP message entered with F9 to F2, F3 or |
| | F4 |
| F2 | Enter designation MIN |
| F3 | Enter designation friendly name |
| F4 | Enter designation friendly email address |
| F5 | Scan channels |
| F6 | Lock on channel |
| F7 | View last received message on LCD |
| F8 | View system utility message on LCD |
| F9 | Enter and view message to send on the LCD |

### VI. Mobile Data Central & Internet Controllers

(A) Mobile Data Central Controller, Overview

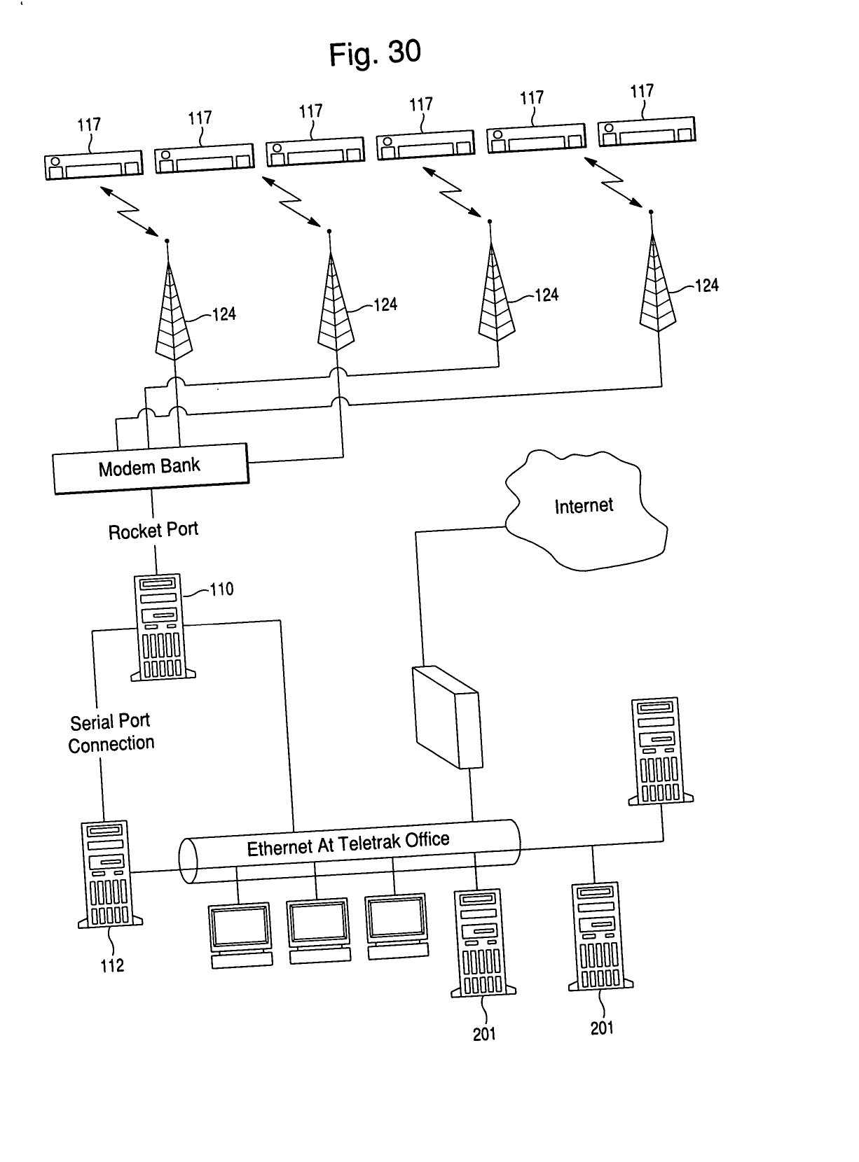

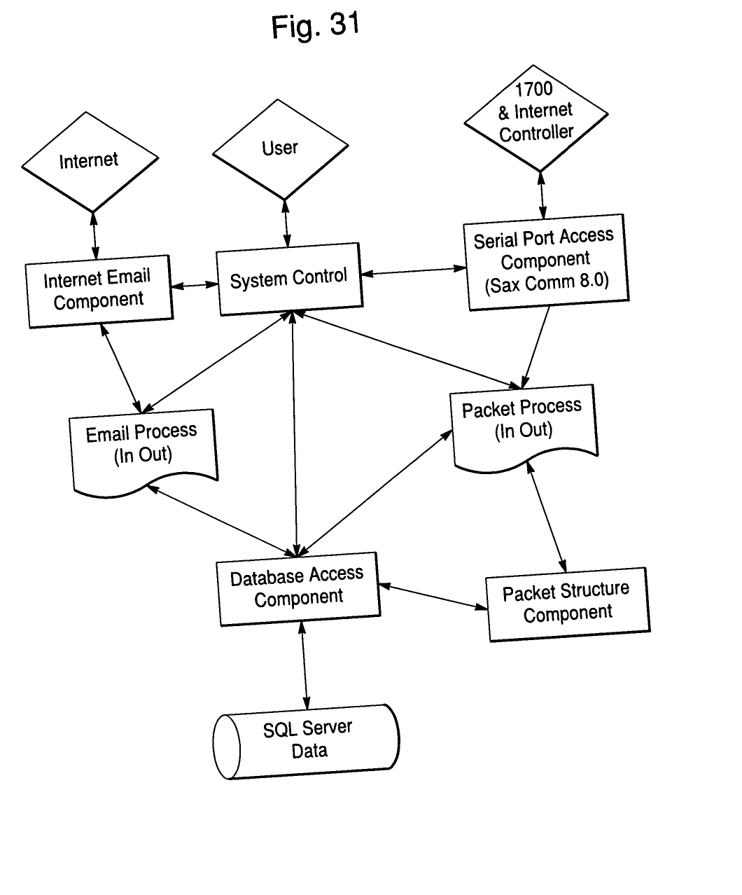

Referring now to FIG. 30, mobile data central controller 110 is a multi-function computer, located at the hub of each regional system, that provides data routing, storage, and overall system control via our MDPP control software. It interfaces with all remote base systems 124, Dispatch centers 130, SQL database 201, and the mobile data internet controller 112, Central controller 110 also incorporates an Email processor to send and receive MDPP message packets as email via the internet.

The MDPP control software of the exemplary embodiment is completely written in Microsoft® Visual Basic 6.0, One additional third party software component “Sax Comm 8.0” is also used and was chosen because of it's capability of handling more than 16 RS232 ports simultaneously, a feature not supported by the “MsComm” component in Microsoft Visual Basic. A proprietary database access component and email component in Visual Basic for the Main controller are also included, as shown in FIG. 31 the Software Component Chart.

The primary function of the Central Controller 110 is to send and receive various MDPP message packets via serial communication between several remote base systems 124, and the internet controller 112, Central controller 110 analyzes, validates, stores, and forwards these message packets to the destination remote base systems 124 and dispatch centers 130, Central controller 110 also performs message routing decisions based upon criteria found in stored fleet/mobile configuration tables and based on last known location of each target unit. This information is processed and stored in the SQL server databases as each packet flows through the system.

Microsoft SQL server 2000 was chosen for this implementation because of its price performance ratio. System 100, however, can work with any other comparable database server engine such as Oracle®, Db2®, or Sybase® with minimum code change because of the object oriented design of the software code of the present invention. All data read from or written to the database is done through the Data Service Component. Throughout the system, as much data as possible is stored without serious impact on performance, thus enabling the other systems (such as the WWW server) to provide additional functions on the system.

(B) Data Flow in Main Controller

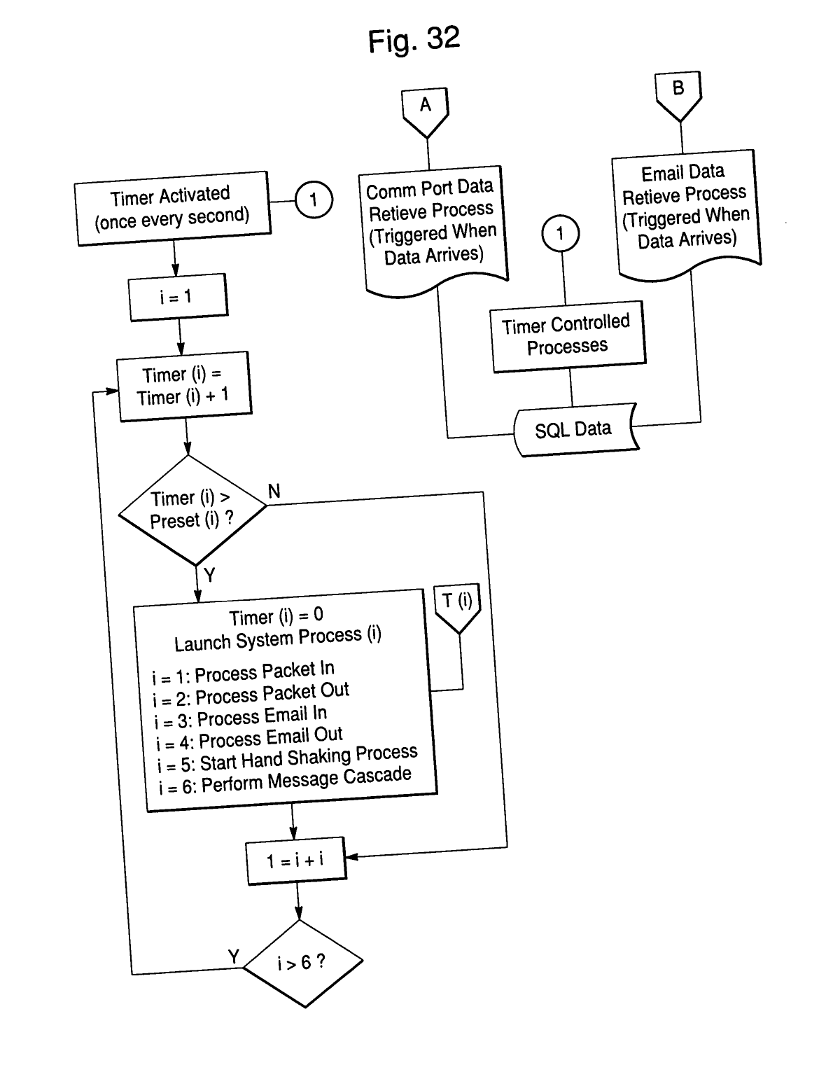

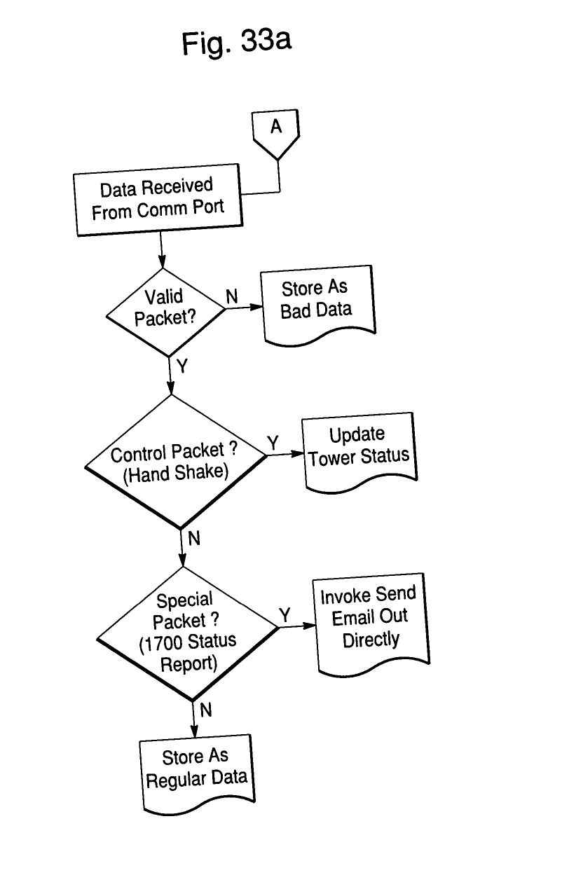

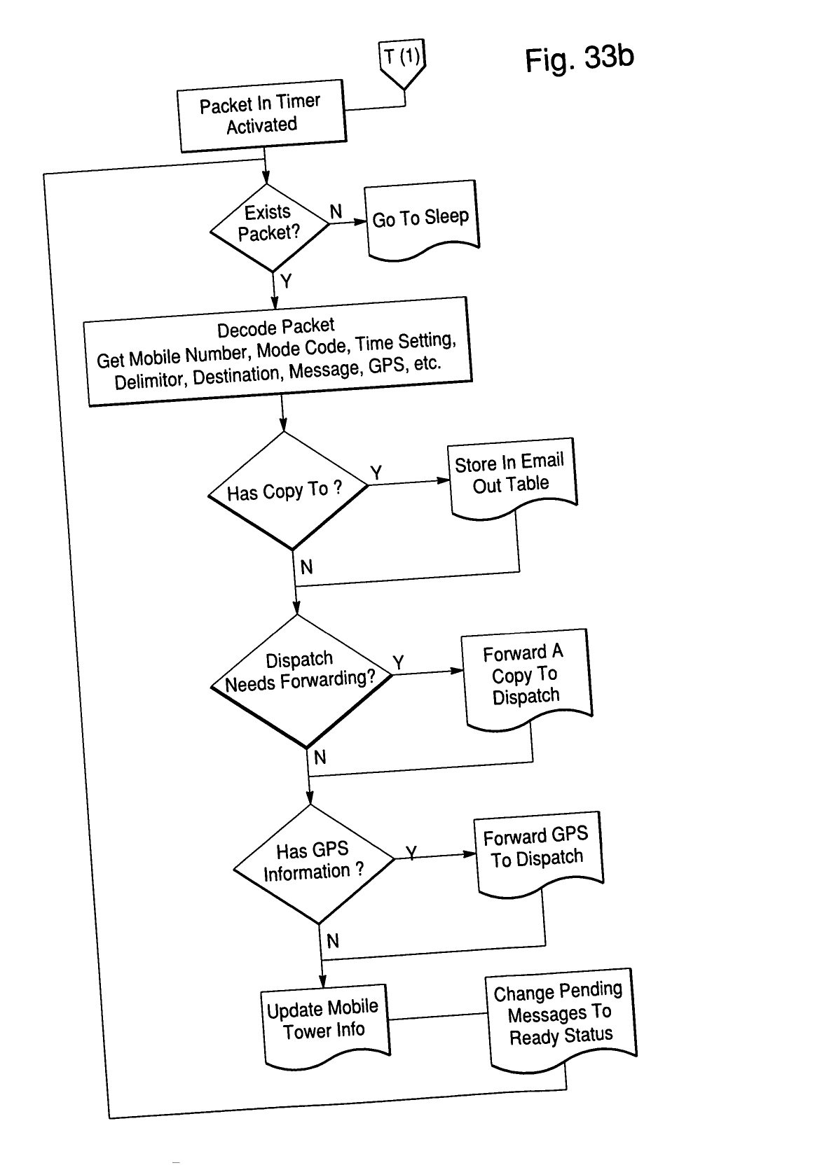

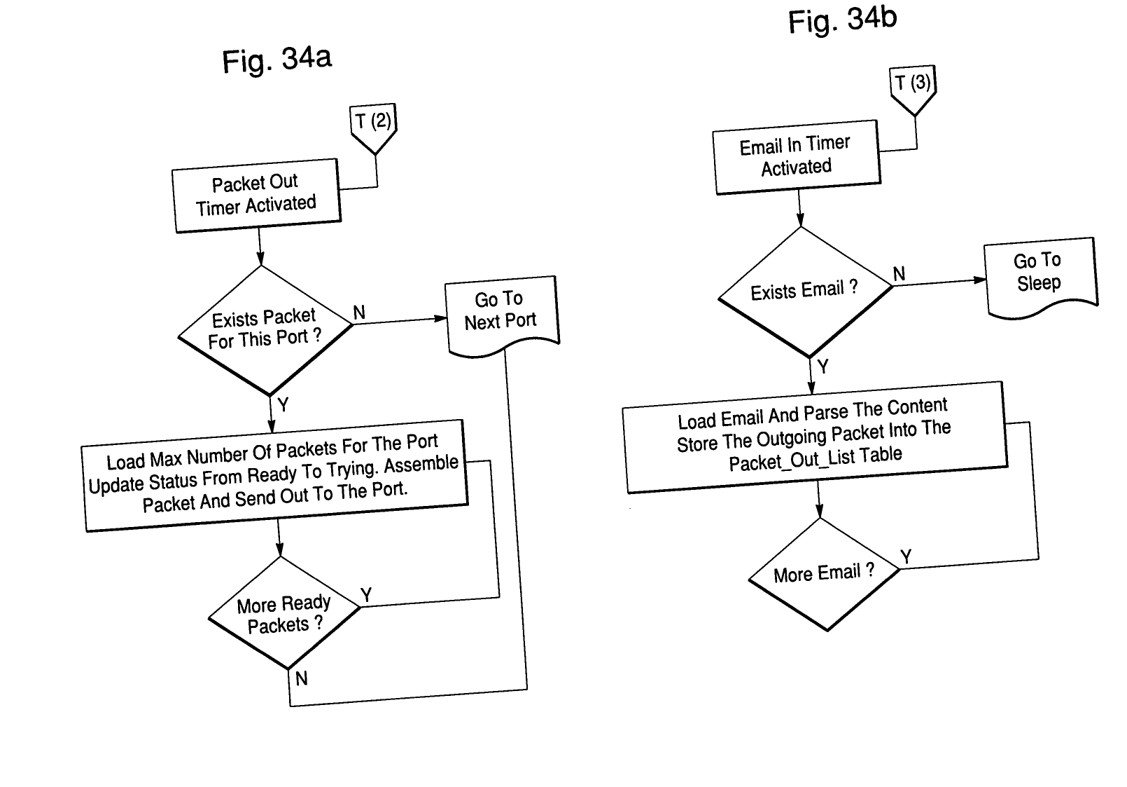

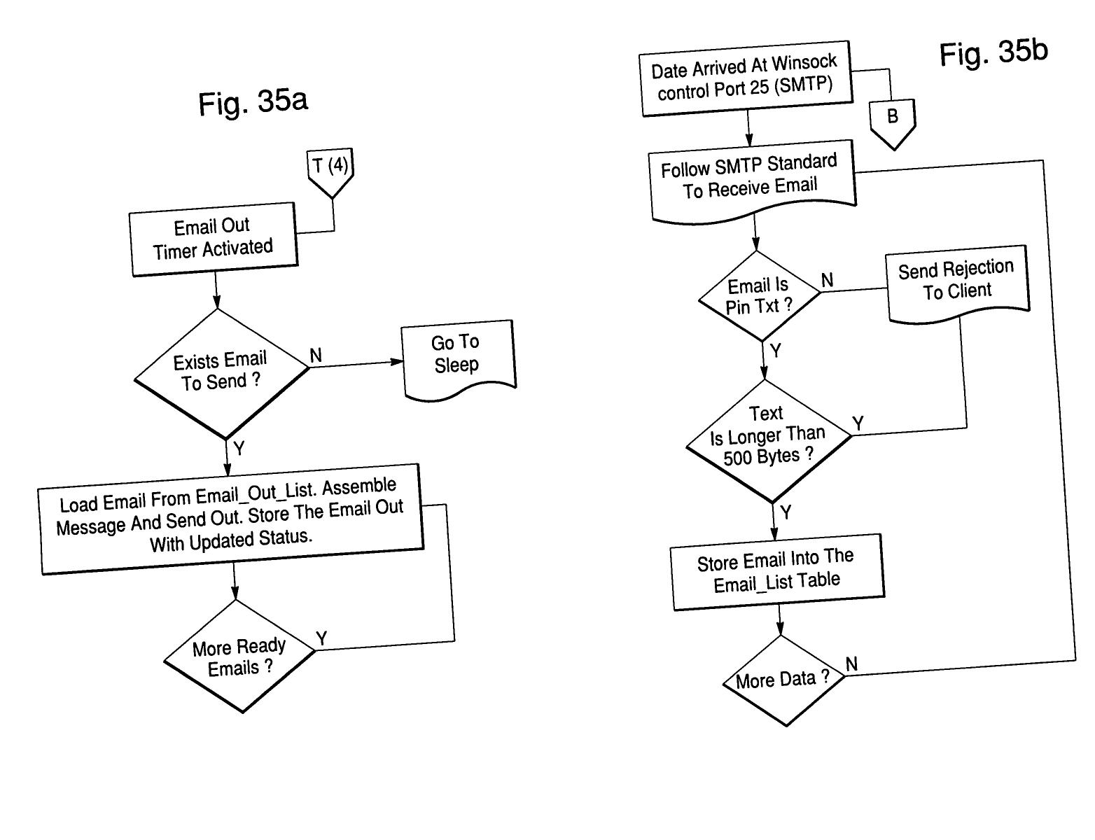

The entire MDPP system operates around the SQL database. As best seen in the Data Flow Charts of FIGS. 32 through 35, most system processes start by checking to see if there is anything waiting to be processed in the database. If so, the data is then read and processed, putting the results into the corresponding tables for the next process to pick up. Instead of a linear design, where a message would be received and completely processed before the program would attempt to perform another task, this design offers a far more flexible and efficient system. If a message requires that multiple actions need to be performed, the system responds by creating multiple entries in the corresponding outgoing table. These actions will then be performed in turn as each individual process is subsequently invoked.

(C) Physical Implementation

The system is implemented on a Dell® PowerEdge®) server equipped with a dual Intel® 1.2 GHz CPU, 256 MB of RAM and an 18 GB Hard Disk. To increase the number of serial ports used on this server/computer, a Rocket Port 32™ brand 32-port expansion card was added. To incorporate a system design that required a separate SQLserver, a 100Baset-T Ethernet network card is used. Windows 2000™ is the operating system used in this embodiment.

For the pure purpose of being able to run our software, any computer that can support a 32-bit windows application can be used. We decided to operate our system using the Dell PowerEdge since it contains a large amount of excess computing power. This will provide each regional controller with maximum expansion capabilities in terms of increased subscriber and remote base capacity, along with greater message handling ability without sacrificing speed and performance.

The Rocket Port 32™ card can be replaced by any similar serial port multiplier product. The system will automatically attempt to open all communication ports configured in the SQL table, and it is not dependent upon any specific communication product. If another multi-port communications interface is used, it is a simple matter to changing the content of the SQL table and to redefine the port parameters. (This table is called “Base_List” in the SQL server).

The network card is necessary if the SQL server is being operated on a different computer. It is possible for both the controller software and the SQL database to reside on the same computer but it is not recommended. For both the scalability and performance issues, a separate computer was chosen for the SQL database.

(D) System Software Component Break Down

The Main Controller software consists of the following major components:

Database Access Component: This Racom designed application was written to simplify the database accessing process. Almost every other component in Main Controller uses this application to read from and write to the SQL database. This component also allows access to different database engines with very little effort.

Packet Structure Component: This component was written to facilitate MDPP packet construction and decoding. MDPP message packets containing the necessary commands, delimiters, source/destination codes, and message data, are constructed by this component. In the reverse scenario, raw incoming MDPP packets are analyzed with each data field being parsed out of the entire packet string. The resulting commands, source/destination codes, and message data are then saved into corresponding locations in the system database.

Internet Email Component: This component was written to provide a simple text-only email server and listens on TCP/IP port #25 (Standard SMTP Port), accepting incoming emails destined for MDPP subscribers. Once the email structure and destination is validated, the email is then stored into appropriate location in the SQL server and is ready for processing. This application also sends email from MDPP subscribers by converting MDPP message packets to standard outgoing email protocol.

Serial Port Access Component: An array of 32 Sax Comm 8.0™ serial ports is controlled by this component. It is initiated upon start-up of the main controller. Each port corresponds to a modem that is linked to a remote base system 124, or to the internet controller 112, This component is a 3rd party product written by Sax Comm™ and it is used to provide control and system expansion of up to 32 serial ports. Although Sax Comm 8.0 was chosen for this illustrative implementation, any other component that allows serial data communication through standard RS-232 serial ports can be used.

(E) Packet Process (In/Out)

This process starts when the timer from the system control interface is initiated. It checks to see if the “Packet_List” table in the SQL database is empty. If it is found to contain existing data, it reads this data from the table and proceeds to construct an MDPP packet by inserting the appropriate commands, delimiters, & source/destination codes into the MDPP packet field along with message data. Once constructed, the data contained in the packet is stored and the packet is then placed into the “Packet_Out List” table for pending transmission of the MDPP Packet.

(F) Email Process (In/Out)

This process also starts when it's associated timer is activated in the system control interface. The email-in process checks to see if anything is contained in the Email_List table. If a message is found, this process reconstructs the email into MDPP format and then places the message into the Packet_Out_list table. Similarly, the Email_Out process reads messages contained in the Email-Out table and sends them via the internet in standard email format.

(G) System Control Interface

The Email component and the serial port component are event driven applications (e.g., they are activated only when data is received or if the system explicitly calls the application to start). The server interface uses a timer to start the packet and email processing applications. Each of the timers work on a different interval for better overall performance. All timer intervals are configurable by the administrator. There are other configurable settings such as port speed, control sequence frequency, stored control sequencing to database, etc. This information is usually stored in the operating system registry.

FIGS. 30, 31, 32, 33a, 33b, 34a, 34b, 35a and 35b show the general data flow of the system. One may refer to the SQL database documentation for additional information on how the packets are processed through the system. In general, there are 2 type of processes in the main controller: (1) Event driven processes are activated when data arrives (A & B), and (2) timer controlled processes which can be adjusted for any particular system depending the system load (T1 to T6).

Timer controlled events are called from the main form as follows:

See Source Code Section 1:

The Email Component is programmed in a way so that it will raise an event called “packet complete” to notify the main controller that it has received an email completely. The code is as below:

See Source Code Section 2:

The function “SendMail” can be used to send a text email to any valid email address. The function “SendMail” is used in the mobile data central controller 110 for sending outgoing emails and alerts. Because the email component actually hides the detail of reading an email from the calling software, the main controller needs only to respond to the “packetcomplete” event and then save the message into the “email_List” table using our “clsEmail” object:

See Source Code Section 3:

The “clsEmail” object is implemented as follows:

See Source Code Section 4:

A Serial port data arrived event is handled as follows:

See Source Code Section 5:

Once data is arrived, the Sax Comm component raises a “Receive” event used to keep reading data from the port until a complete packet is received. If the packet is of mode 1A or 1B, “port alive” status is also updated. This function basically stores the incoming packets into rawdata and parsed packet into “Packet_List” table. If the incoming packet is of mode 1C or 1D (Comfirm delivery or non-delivery), it then also updates the “packet_Out_List” table to reflect the status change on the indicated packet.

The code for Processing Received Email is Listed as Follows:

See Source Code Section 6:

Because it is already parsed in the database, the destination is read and it is translated from the email address format into the digital mobile number format and then it is stored into the “packet_out_List” table. A comfirmation email is also sent back to the originator.

The Code for Processing Received Packets is Listed as Follows:

See Source Code Section 7:

A packet is fully analyzed and parsed here, down to the delimitor level, to retrieve GPS information. The data is then stored in the appropriate section of the SQL server. Depending the mode code, a SQL table is used to translate the outgoing mode code, attach time stamp, forward message to dispatcher, write to “email_out_List” . . . etc. Once the packet is completely processed, it is then removed from the queue.

The Code for Processing Outgoing Packets is Listed as Follows:

See Source Code Section 8:

A remote base system 124 reports its status by sending the “1B” message. The highest priority data contained in this message is the number of Tx buffers free. When a 1B message is received, the TxFree count is updated for that port. When a packet is sent back through the port to the remote base system, the TxFree count is or reduced by 1, When a “1C” or “1D” message is received on a port, the TxFree count is increased by 1,

When sending packets to the remote base systems, first, the TxFree count is read for the corresponding port and only the number of packets that can be processed by the port at that time are selected for retrieval from the SQL server (where the TxFree count equals the number of packets that can be processed by the port at that time).

This precaution is necessary so that the TX message buffers in the base controller 140 at the remote base system 124 are not overloaded. As message transmission is being attempted, message status and number of retries are continually updated. Message transmission will stop when the “1C” or “1D” message is received.

The code for Processing Outgoing Emails is Listed as Follows:

See Source Code Section 9:

All pending emails are read, constructed and passed on to the next available socket. The Email component has a “sendmail” function that encapsulates all detailed commands to make this operation very easy to perform.

The Code for Handshake All Ports is Listed as Follows:

See Source Code Section 10:

To insure that all base controllers 140, at all remote base systems, are working properly, 1B test messages are routinely sent to these units at regular intervals and the proper response is awaited.

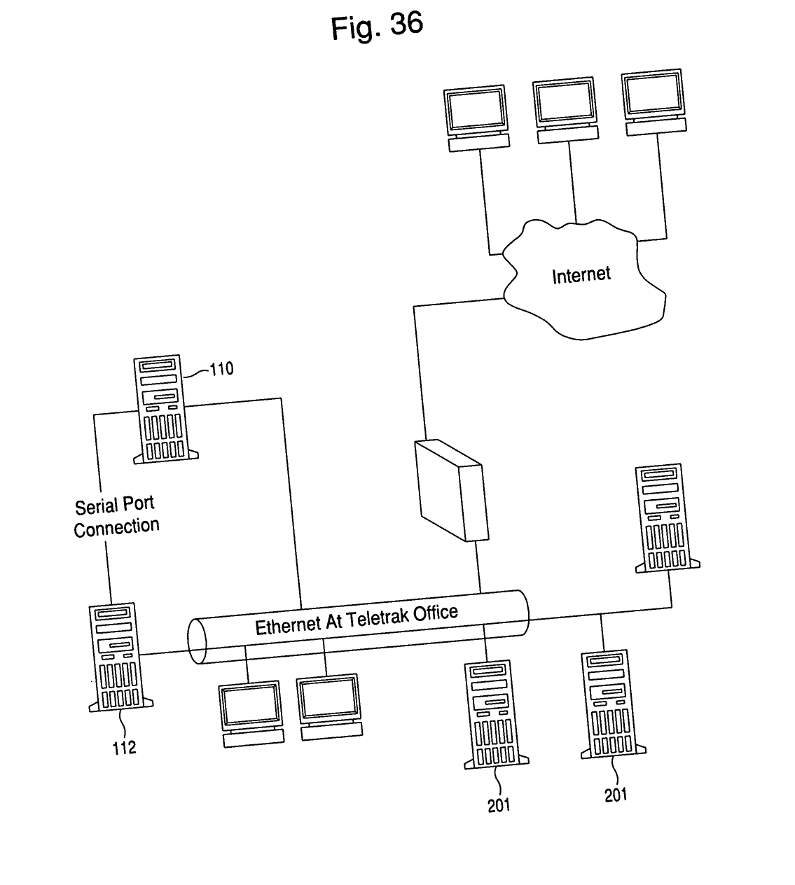

(H) Internet Controller, Overview As best seen in FIG. 36, the Mobile Data Internet Controller 112, routes all data traffic between the central controller 110, and the dispatch centers 130, Internet delivery was chosen over wireless delivery due to the high volume of traffic sent to each dispatch center.

Internet Controller 112 communicates with the main controller 110 through a dedicated RS-232 port with a null modem direct connection. All MDPP data received on that port by internet controller 112 is immediately acknowledged and confirmed as delivered. The actual or final delivery may not take place until the target dispatch center 130 checks in, so the MDPP messages are held in internet controller 112 pending delivery. This temporary delivery at the internet controller 112, removes a large traffic load from the central controller 110, thereby increasing it's efficiency. This link can be easily modified to use other type of communication methods other than RS232 serial connection. Using a local area network would be an alternate method, which would also have the advantage of utilizing a higher bandwidth.

The internet controller 112, communicates with the dispatch centers 130 using TCP/IP protocol. The exemplary implementation uses port number 3732, A protocol similar to SMTP was designed to facilitate transmission between the Internet Controller and the Dispatch program.

Unlike the Main Controller, the internet controller is mostly event driven. MDPP data is processed and routed between the RS232 port and the TCP/IP sockets, as it arrives at either input. In a sense, the Internet Controller acts as a broker agent and courier between the main controller and dispatch centers.

The entire program is written in Visual BasicTM. The Sax Comm 8.0™ object is used for serial port communication, & the Database access component from the Main Controller is reused for the internet controller.

(I) Internet Controller Physical Implementation

Internet controller system 112 is implemented on a Dell™ PowerEdge™ server. It is equipped with single Intel™ 900 MHz CPU, 256 MB of Ram, 18 GB of Hard Disk. To incorporate a system design that required a separate SQLserver, a 100 Baset-T Ethernet network card was included and Windows 2000 server™ is the operating system.

For the pure purpose of being able to run the selected software, any computer that can support a 32-bit windows application can be used. The Dell PowerEdge was selected since it contains a large amount of excess computing power and will provide internet controller 112 with maximum expansion capabilities in terms of increased subscribers and greater message handling ability without sacrificing speed and performance.

The network card is necessary if the SQL server is being operated on a different computer. It is possible for both our controller software and the SQL database to reside on the same computer but it is not recommended. For both the scalability and performance issues, a two computer configuration was selected for the SQL database.

(J) Internet Controller System Software Component Break Down

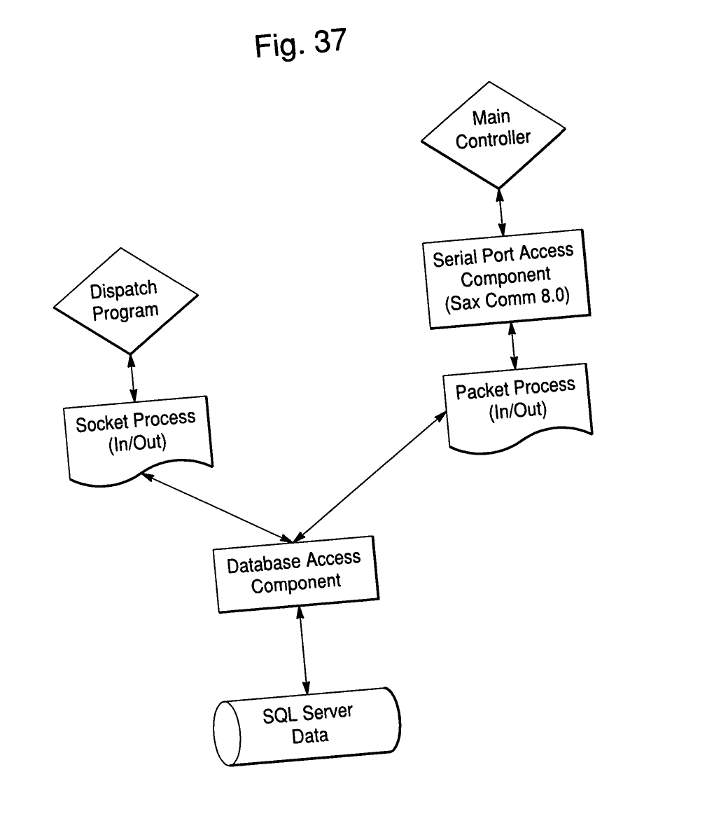

The Internet Controller software consists of the following major components as shown in FIG. 37:

Data Access Component

This Racom designed application was written to simplify the database accessing process and it is very similar to the same component developed for the central controller 110,

Socket Process (In/Out)

An array of windows TCP/IP sockets are created to communicate simultaneously with multiple dispatch centers. It uses a protocol similar to SMTP which was designed to communicate over the internet on port number 3732,

Serial Port Access Component

One Sax Comm 8.0 componenet is used to send and receive data from the serial port, which is linked directly to the Main Controller

Packet Process (In/Out)

Activated when MDPP data arrives on the Sax Comm object from the central controller or when data arrives from the dispatch centers via the TCP/IP sockets.

System Control Interface

Allows the administrator to reload all connections, switch Databases, change RS-232 port configuration, etc.

(K) Data Flow in Internet Controller

The Internet Controller uses a separate SQL server to store and process its own data. One important factor is the design that accommodates multiple dispatchers with an added parent-child dispatching scenario. In the database, every dispatcher ID is stored with its parent Dispatcher ID. Each dispatcher also has a “type” code associated with it to identify it as either a primary or one of many secondary dispatchers. Whenever an MDPP packet arrives for a dispatcher, its parent dispatcher is sought and a copy of the packet is stored for that parent until the end of the secondary dispatcher list is reached. This search method enables implementation of a very flexible solution for different types of dispatching needs, especially for larger fleets using several secondary dispatchers.

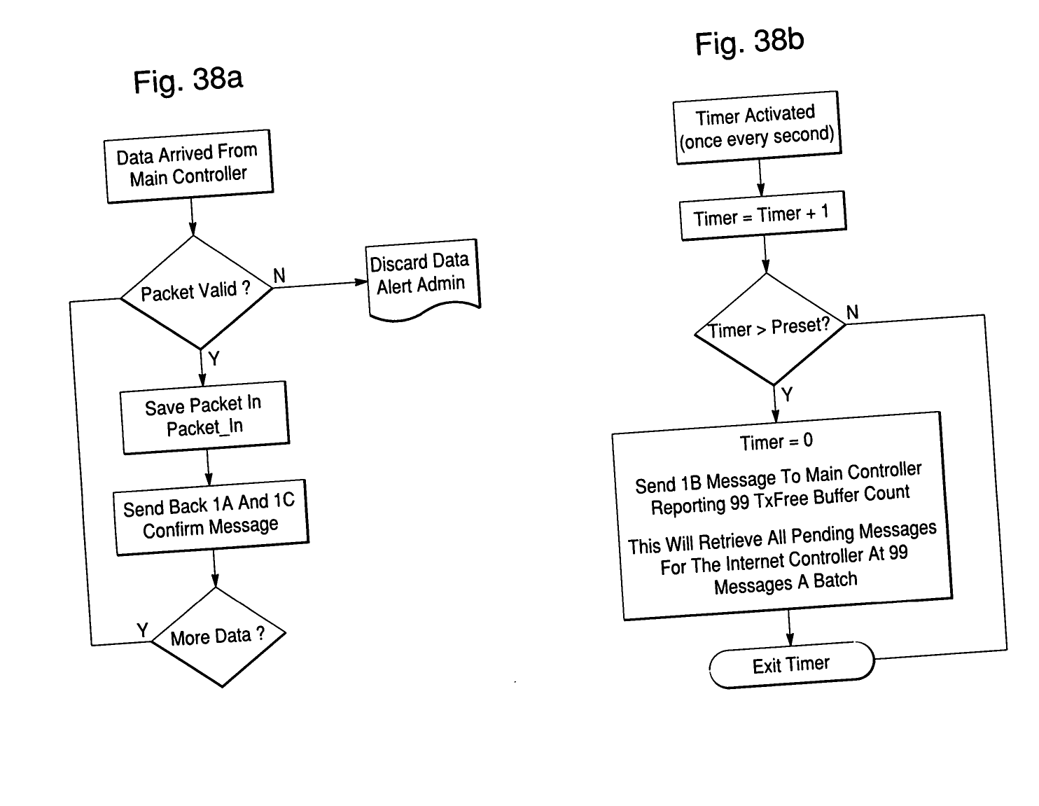

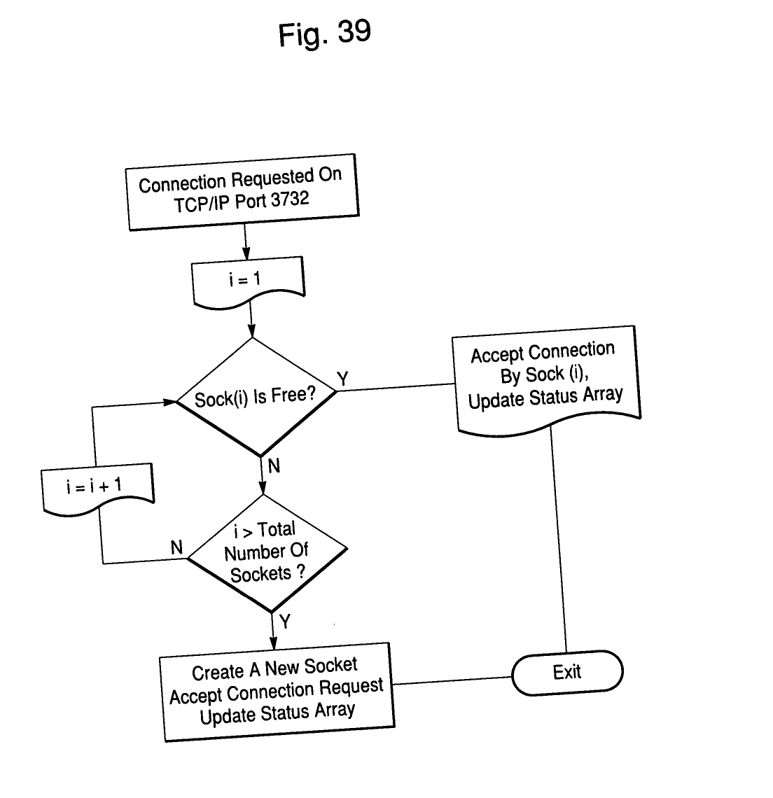

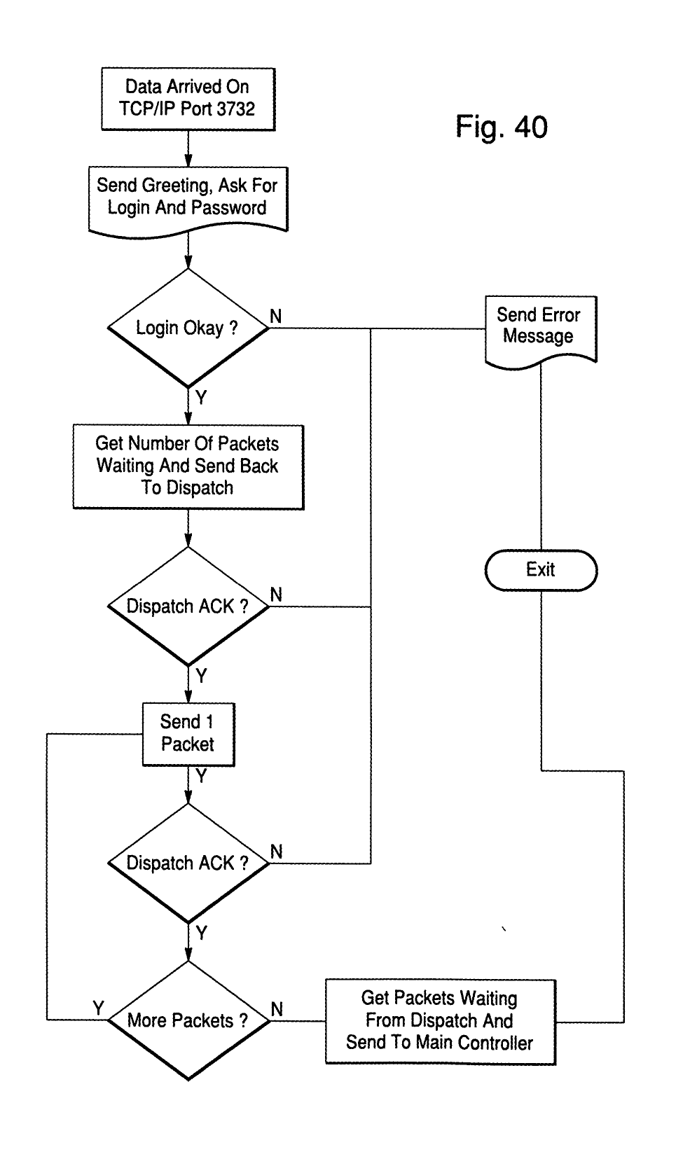

As one can see in the flow charts in FIGS. 38a, 38b, 39 and 40 data flow in Internet Controller 112 is simpler than for the Central Controller 110, There is only one process controlled by a timer, namely, sending a “1B” handshake message to the Central Controller and report a 99 TxFree Buffer Count. Because every message delivered by the Main Controller into our own Database is saved and immediately acknowledged as a confirmed delivery, the workload on the main controller is reduced. Source code for this process is as follows:

See Software Source Code, Section 1.

The system controls serial port communication by a similar process used in the central controller. Once the Receive event is fired by the Sax Comm component, (which means a data packet has arrived.) the complete packet is analyzed to decode the destination and mode types. It is then is stored into the database and an acknowledgement packet is sent back to the central controller. Source code is as follows:

See Software Source Code, Section 2.

When a dispatch center attempts to connect to the Internet Controller on port 3732, (The only port the Internet Controller is listening on), the existing opened socket list is examined to check for an available path. If an available path is found, the connection request is accepted by the free socket and the status array is updated. Otherwise, a new socket is opened to accept the connection request. Source code is as follows:

See Software Source Code, Section 3.

Once the socket has connected to the remote dispatch center, a receive event is started upon arrival of the new data. (The socket on the Dispatch program does the same.) A protocol similar to SMTP is used to exchange status and data between the two nodes. In general, a three digit number is sent in front of every packet to identify the current status of the sender. Source Code is as follows:

See Software Source Code, Section 4.

### VII. MOBILE TEXT MESSAGING AND VEHICLE LOCATION

Referring now to FIGS. 17-24, an exemplary embodiment of system 100 includes a plurality of analog mobile units 117 used in connection with Global Positioning System (GPS) receivers 120 to generate automated vehicle location (AVL) reports, whereby GPS information is transmitted from the mobile units through mobile data central controller 110 and to selected customer dispatch centers 130 for mapping the location of one or more monitored vehicles. In the embodiment illustrated in FIGS. 17-24, Control Point™ software is used for mapping, messaging, dispatching and mobile business form generation. A short messaging service (SMS) is also incorporated whereby short text messages are sent through the wireless data telemetry links provided by the elements of System 100, Another term for mobile unit 117 is TRMD; each TRMD or mobile unit 117 is preferably adapted to mount under one seat or in the trunk of a monitored vehicle 228, The software for the system which provides GPS and AVL mapping and location plotting is known as “Mobile-Trak™”. An additional service can be incorporated whereby the short messaging service (SMS) and business short forms are available for transmission from vehicle to vehicle within a fleet and can be sent by wireless email and this software package known as “Total-Trak™”.

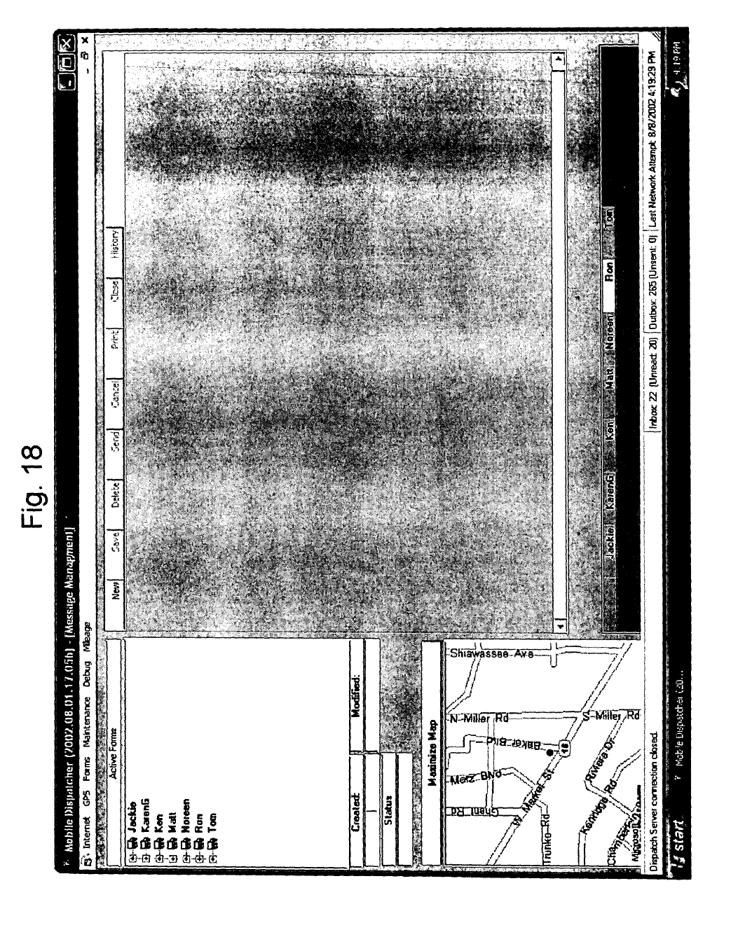

Mobile-Trak's Control Point software is incorporated in the mobile dispatcher's software for use in each customer dispatch center 130, Before starting the Control Point software, the dispatch center user must be connected via the internet to mobile data central controller 110 via the dispatch center user's internet service provider. Once connected, the control point dispatcher icon and main interface screen (as shown in FIGS. 18,19, 22, and 24) will provide the dispatch center user with options for using System 100,

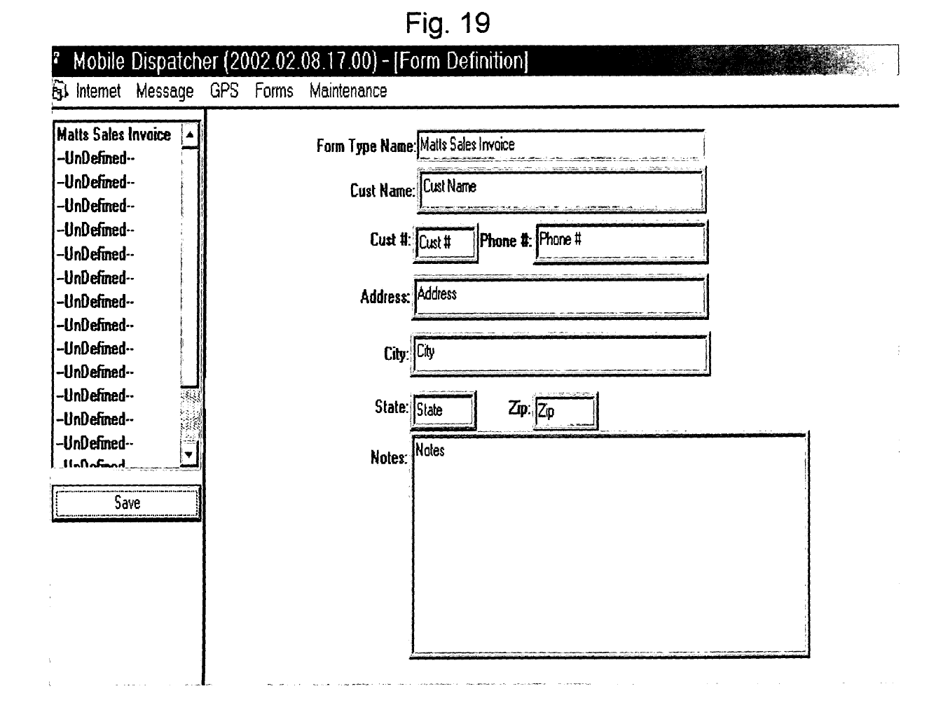

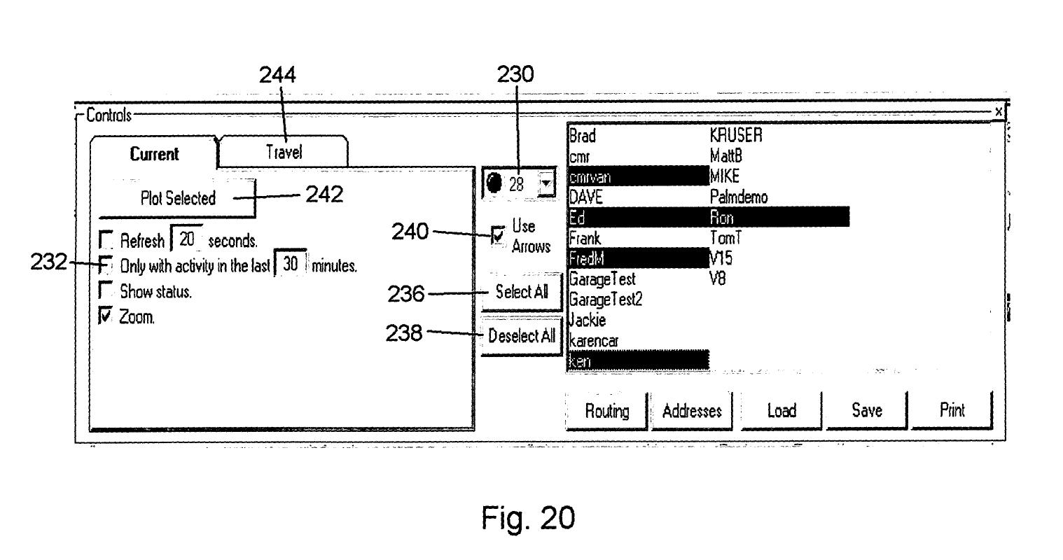

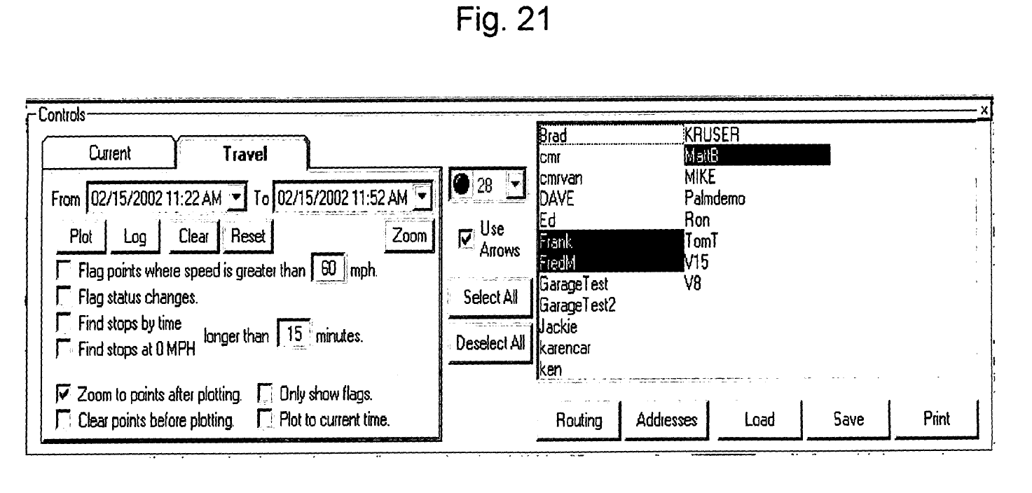

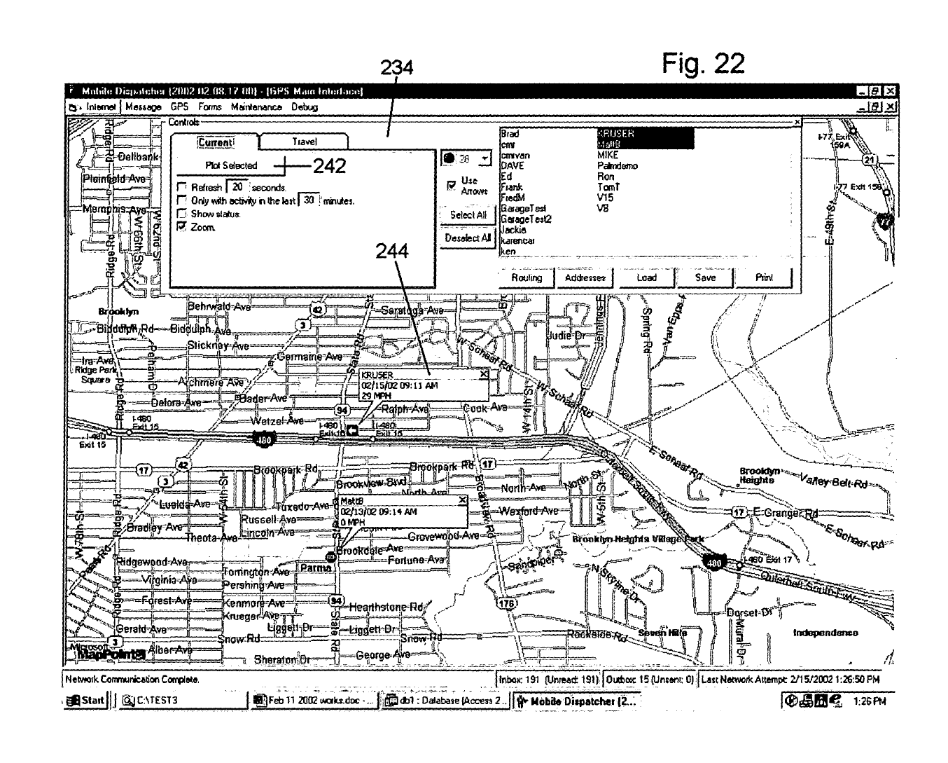

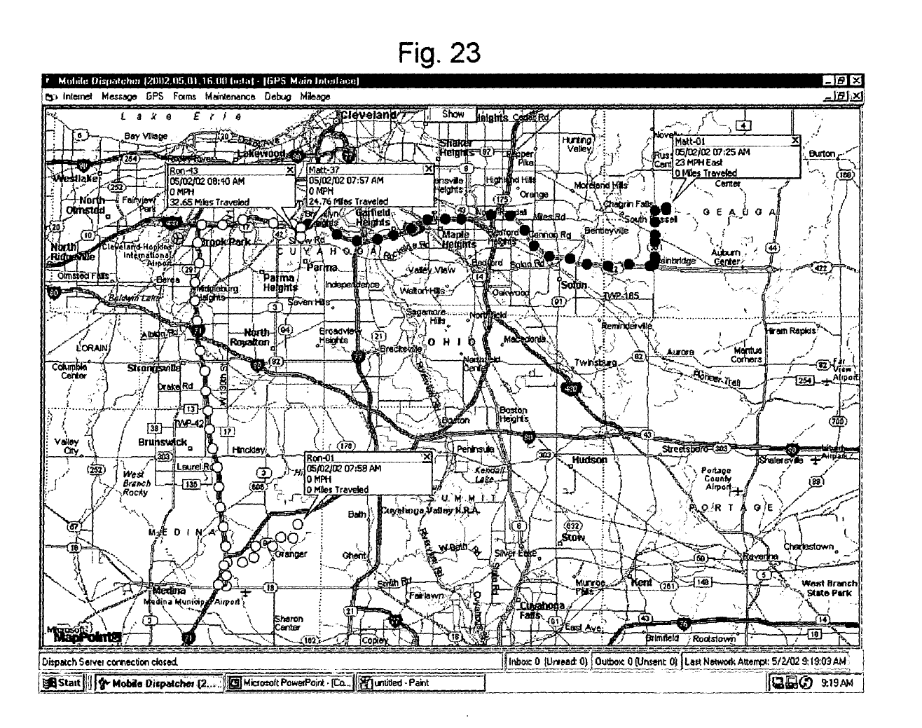

In the event GPS mapping is desired, the user and dispatch center 130 selects the GPS icon shown (e.g., in FIGS. 19 or 22) which then brings up the control point GPS mapping control panel shown in FIGS. 20 and 21, The user may then select the monitored vehicles to be mapped showing the last known location by using the “select all” button 236, “deselect all” button 238 or individually highlighting selected units (e.g., such as “CMRVAN”) as shown highlighted in FIG. 20. In the event the user wants to change the color or shape of the plot markers, drop box 230 is selected to view the different options and the marker shown will then be assigned to the first highlighted unit such that each sequential marker will be assigned to the next unit in the sequence. The “Use Arrows” box 240 is selected or checked only if the dispatch user wants to display an arrow to indicate the position of a monitored vehicle (e.g., as shown in FIG. 22) instead of colored markers (e.g., as shown in FIG. 23).

As shown in the left most portion of the screen of FIG. 20, the user also must select desired check boxes for the appropriate last known location map and then use the “plot selected” button 242, whereupon a map will be created. If the “Refresh” box is checked, the map will be re-plot or re-generate at a user-selected time interval. Placing a check in the Refresh box will also cause the program to re-plot the last known position map with any new information at the selected time interval. Once the Refresh box is checked, the current position map will continually refresh until the Refresh box is unchecked, the Travel tab 244 is selected or the Mobile-Trak control point software program is closed.

Also shown in the left portion of the screen of FIG. 14 is a checkbox 232 entitled “Only with activity in the last_minutes”; placing a check in checkbox 232 will cause the program to plot only those vehicles that have some activity within the user's selected time frame (e.g., 30 minutes).

Placing a check in the “Show Status” box will cause the program to provide a current vehicle status within each monitored vehicle's “last known location” flag data field (e.g., as shown in the “KRUSER” flag data field 246 in FIG. 22). Available current status reports include “on”, “off”, “stop” and any data available from external sensors such as temperature sensors.

Referring again to FIG. 20, placing a check in the “Zoom” box causes the program to automatically size the last known location map to include all selected vehicle plots. Zoom will continue to resize the center of the map if “Refresh” is checked as well. The Zoom box is checked by default since it is often used.

Turning now to FIG. 22, an example of a “Last Known Position” map is illustrated with a control panel 234 centered at the top of the screen. When the “Last Known Position” map is created, mobile units are shown with appropriate markers and flags 246 showing name, date, time, speed, direction and status if selected. As shown in the middle portion of FIG. 22, the selected mobile units “KRUSER” and “MattB” are identified along with date, time and speed information in their respective flags. Mobile units “KRUSER” and “MattB” are shown as highlighted in control panel 234, Additional mobile units may be added or removed to the display when with check boxes are changed or updated in the control panel 234, The existing map will remain on the screen until “plot selected” 242 is clicked again or until “Refresh” is checked. Control panel box 234 shown in FIG. 22 can be minimized by clicking the small “x” (in the upper right hand corner of the control panel) as is customarily done with Microsoft® Windows® applications. A minimized control panel 234 can be opened or maximized by clicking a “control” button (not shown) displayed in the middle of the upper most edge of the map when control panel 234 is minimized.

Referring now to FIG. 21, the Control Point GPS mapping control panel can also be used for travel mapping by selecting the Travel tab 244 on the left side of control panel 234, whereupon the desired date and time frame for a monitored vehicle's history is used to create an appropriate travel map. A user may conveniently expand the time frames to capture all of the information on the map by making appropriate entries in the “From” and “To” fields. By next selecting the “Plot” button, a map is created with the first and last flags and any other appropriate flags, based upon the check boxes selected in the control panel.

Referring again to FIG. 21, it is also possible to map travel with selected features by checking appropriate boxes selected from those shown along the left side of the control panel. For example, a dispatch center user can identify points where a monitored vehicle's speed is greater than a selected velocity (e.g., 60 MPH) and can identify flag status changes, find stops by time or find stops where the monitored vehicle has been stopped for longer than a selected period (e.g., 15 minutes).

Placing a check in the box labeled “Flag points where speed is greater than” box causes the program to plot the map with a flag for each plot that exceeds the selected velocity. Choosing “Flag status changes” causes the program to plot all flags with information for each vehicle where a “status” (as defined above) has changed; this function may also be used with optional external sensors such that if, for example, a temperature sensor in a refrigerated trailer has detected a change in the temperature of the trailer contents, then that flag status change would be reported through the software using the status change box feature.

Placing a check in the “Find stops by time” box, causes the program to flag any plot including a time difference greater than the selected time between two plots. The status flag will show at the first of the two plots as this will reflect the stop most accurately.

Checking the box “Find stops at zero MPH” causes the program to flag, and displays within the flag, the time differential between the first zero mph plot and the next greater than zero plot having a time difference of greater than the selected interval entered into the dialogue box (e.g., 15 minutes, as shown in FIG. 21). It is also possible to use the control screen shown in FIG. 21 to control how the travel map is plotted; for example, selected “Zoom to points after plotting” causes the program to automatically size the travel map to include all selected vehicle plots. As noted above, the Zoom box (e.g., as shown in FIG. 20) is checked by default since it is most often used. Selecting “Clear points before plotting” will cause the program to clear any existing plots from previous maps before plotting new information, and selecting “Only show flags” will produce a map only showing the plots that have corresponding flags. Finally, choosing “Plot to current time” causes the program to automatically grey out the “To” time field and will select the current computer time for the ending time frame.

Four control buttons are also included in the control screen of FIG. 21, namely, “Plot”, “Log”, “Clear” and “Reset”. When the “Plot” button is clicked, a map will be created. When the “Log” button is clicked, a “save file” interface is brought up and options for where to save the log file are provided to the dispatch user. Log files are saved in text (.txt.) format which can then be loaded through Notepad®, Excel® or Word® programs at the dispatch center user's convenience. When the “Clear” button is clicked, the existing map is cleared. This is recommended after each travel map is created. When the “Reset” button is clicked, the “To” (ending) time is brought to current computer time and check boxes are brought back to defaults. When the “Zoom” button is clicked, the existing map will be resized to the original size.

The control point software travel mapping facility includes a number of additional features. When the “plot” button is clicked, preset often-used addresses can be entered to appear in conjunction with routing information plotted on the map. In addition, addresses can be entered to form a route which is highlighted on the map and driving directions can be produced for display at the dispatch center console. It is also possible to print maps, routes and addresses using the “print” button provided along the right edge of the control panel 234 (as seen in FIGS. 20 and 21).

The Mobile Trak Control Point software can also be used to generate vehicle history maps or travel maps using either arrows or markers which may optionally include flag markers indicating speed. When the “vehicle history” map is created, mobile units are shown with appropriate markers and flags showing name, date and time, speed, direction and status if those reports are selected. Each plot can be clicked on the map and its flag will appear with appropriate information.

A number of troubleshooting options are also provided in the event of a Control Point program error. If information that is less than current is observed when generating the reports and plots, the internet connection can be checked to insure that the dispatch center 130 is connected to system 100 and is receiving current information. Secondly, the search time frames can be checked to make sure that the dispatch center user has not inadvertently made a mistake.

Broadly speaking, the mobile track system makes available a vehicle location service which can map the location of a monitored vehicle from the start of the day to the end of the day for tracking the fleet, storing information, tracking mileage and time- stamping information, all from a home or office computer. As best seen in FIG. 17 a monitored vehicle 228 can include a control head 118 located conveniently by the driver and preferably in a flexible mount. The control head 118 can be a Palm Pilot® brand personal digital assistant or a personal computer. The mobile unit or TRMD 117 mounts under a seat or a trunk as shown in FIG. 17 and in the illustrated embodiment a GPS receiver 120 is mounted in the vehicle's back window to retrieve GPS information for use in tracking vehicle location. Substantial savings and labor costs and vehicle operation costs can be achieved with effective use of the vehicle tracking information. The system permits the end user or customer operating the dispatch center 130 to know where each monitored vehicle 228 in their fleet is, in real time. The system is affordable, upgradable and simple to operate and provides simple to understand time stamped mapping for each vehicle where each monitored vehicle is tracked over time. Using the reporting software facilities, information can be stored for statistical analysis including routing information, mileage tracking, verification services and marketing information.

Additional software facilities sold in connection with the trademark Total Trak™ permit all of the above as well as providing an easy to use facility for communication with each monitored vehicle in the fleet, thus permitting users to send the right message to the right vehicle operator immediately. Simplified text messaging provides a simplified business form format (as described below), guaranteed delivery, confirmation of delivery and “copy to” service which, as noted above, can be accomplished using Palm Pilot® brand PDA's. The system will also permit users to send and receive wireless e-mail as part of the wireless text messaging service.

### VIII Customer Dispatch Center

I The Dispatch Center 130 Control Point Software runs on Microsoft Windows 98 or newer Windows based operating systems. It is written in Microsoft Visual Basic 6 and utilizes a database (Microsoft Access 2000) to store information and a software-mapping package (MapPoint 2002) or comparable mapping software, to display unit locations on a map. The software has manual and automatic maintenance functions. The database is automatically backed up and optimized routinely. Back-ups and optimizations can also be manually performed. Old records can be purged and units removed. The software is written is such a way that updated versions are usually still compatible with older database. The software has 3 main functions.

1)To fetch and store MDPP packet data. To send MDPP packets.

1)To provide an interface to access and use GPS data

2)To provide an interface to create, view and manipulate forms.

Communication The software can send and receive MDPP data packets through TCP/IP or serial communication. The program is written is such a way that any communications method can be used to send or receive MDPP packets. As long as the procedures return or accepts a complete MDPP packet, the means of communication is transparent to the overall workings of the program. For TCP/IP, a timer is used to specify how often the program should attempt communication. The timer can be set to any time interval desired for automatic communication or can be disabled completely if manually initiated communication is desired. When using TCP/IP for communication, the software connects to a Mobile Data Internet Controller 112 at a specified IP address. When a TCP/IP connection is successfully established, MDPP packets are then sent between the two systems with verification to ensure successful delivery. When using serial communication, the software is usually connected to a Mobile Unit 117, By sending and receiving control codes, the software can determine when data is available to receive and send data that is pending delivery. Packets are received and analyzed to determine their mode and delimiters and the data is extracted form them and saved into appropriate database tables. Currently, there are tables for all GPS data for units, most recent GPS data for units, status history for units (temperature, relays), forms data and inbox messages. Packets that are to be sent are stored in an outbox table and marked as pending delivery. Once they are sent out successfully, they are marked as delivered. Relevant source files: frmMain.frm, modMain.bas, modNet.bas, objPacket.cls.

GPS data

GPS data is attached to most packets that the Dispatch Center 130 Control Point Software receives and the information is denoted by the following delimiters:

&H99 Data and time (uncompressed)

&H96 GPS (uncompressed)

&H9B Compressed Date and time field and Mobile Status

&H9C Compressed GPS

When GPS and time delimiters are received, the data is extracted and stored into the appropriate tables.

The GPS mapping interface allows maps to be generated based on various specified criteria. A SQL query to the database is generated and executed to return the records for the selected units during the specified time period for travel and to return the current location information for selected units for current. Then, depending on the parameters that are set up, each data item is analyzed and the programs determines if that point should be displayed on the map and what information should be associated with it.

All interfacing to the map program is done through Microsoft's Mappoint Control or comparable mapping software. The unit's graphical representation (colored dots, arrows) can be chosen along with what information should be displayed along with each point. Status, GPS coordinates and GeoFences are available on both current and travel maps. Statuses are user configurable relay positions in the mobile unit 117 that are displayed in the information window. Depending of the information given by a &H9B delimiter, relay positions will be stated as on or off. The GPS option allows the actual GPS coordinates to be shown. GeoFences show the name of user defined regions that the unit may be in.

There is a tab that allows the current location for units to be displayed. Options are available to automatically refresh the display to show updated locations through the use of a user configurable timer and to limit display so only recently active vehicles are shown. The Travel tab allows for units movements to be displayed during a specified time frame. There are options for showing the distance that they have traveled, for showing units that are traveling within a specified speed range and for showing how long units have stopped. The distance that a unit has traveled is calculated by the Dispatch Center 130 Control Point Software from the first point and totaled through the last point for each vehicle. Further options allow for units to always be plotted to the current time and to only show plots that contain useful information. All this is determined by analyzing the data set that is returned by the SQL query.

The generated map parameters can be configured and manipulated in many ways. They can be loaded, saved and printed. Positions can be zoomed in and out on and the map's view can be scrolled around in all directions. Options are available to display travel route information on the map so that vehicles can be verified to follow them. This is all accomplished by using the Mappoint Control. Frequently visited destinations can be stored in the database to quickly add them to routes. Stops on the route can be ordered manually or optimized by the program for minimal travel time.

GeoFence points can be defined manually or by using a preplotted point as a reference. A GeoFence is a GPS coordinate with a specified radius. Whenever a unit's GPS position is within the radius of a GeoFence, the name of the area will be displayed in the information window if desired. The GeoFence information is stored in a table within the Access Database.

All information that is generated on the Travel tab can be saved to a log file. The log file can easily be referenced to the map by using the point id numbers. The log file is a tab delimited text file, this allows maximum flexibility as this type of file can be loaded into many different software packages for analysis and viewing.

Relevant Source Files: frmGPSnew.frm.

The GPS information can also be used to calculate mileage driven events for vehicles. Services can be defined from a specified date and the mileage traveled since that date is shown. A SQL command is generated and executed that returns all the records greater than or equal to the specified date and than the distance between all the points is calculated. Through this, the time when service should again be performed on that vehicle can be determined. Relevant source files: frmMileage.frm.

### IX. Mobile Business Forms

(A) Mobile Forms: Dispatch Center 130, OVERVIEW:

MD Forms is a process in which short business form templates can be designed on the users Dispatch Center 130, and sent to multiple mobile PDA/computers 118, connected to Mobile Units 117, over the MDPP wireless data network. Once form templates have been designed and sent to the user's PDA/computer 118, data in the templates fields can be created and edited by either the mobile user or the Dispatch Center 130 operator. As changes are made to the data in the templates fields, databases in both the PDA/computer 118 and the Dispatch Center 130 are automatically synchronized with each other, such that each database contains the same form information. Upon receipt of a new form document, the mobile unit 117 generates a 32 bit unique ID for the form document from the PDA/computers 118 database, and returns this Id to the host Dispatch Center 130 as a reference pointer to the form document in the PDA/computers 118 database. This ID is used as a common reference, between the PDA/computer 118 and the Dispatch Center 130, to a specific form document.

Form Templates, and Form Data is transmitted between the Dispatch Center 130 and the Mobile Unit 117 in the message fields of the MDPP Packet.

Form Templates are sent in the following structure:

| | | |
|---|---|---|
| MDPP Mode: | 2Ah | |
| Form Template Delimiters: | A0 + XXYY | where XX = 01 to |
| | | 0F (Form ID) |
| | | where YY = 01 to 20 |
| | | (number Fields in Hex) |
| | A1 + Form Title | |
| | A2 + Field Name | |
| BF + Field Name | | |

Form Data is sent in the Following structure:

| | | |
|---|---|---|
| MDPP Mode: | 2Bh | |
| Form Data Delimiters : | A0 + XX | where XX is the Form ID |
| | A1 + XXXXXXXX | where XXXXXXXX is the |
| | | unique form ID |
| | A2 + Field Data | |
| | BF + Field Data | |
| | C1 + XX | where XX is the form status |

(B) Operational Flow: Dispatch Center 130

Creation of Form Definition

Form Template Definitions are created and modified by the user's primary Dispatch Center 130, From the main menu bar of the dispatch center 130, the user selects the “Form Definitions” option. This opens the Template Definition screen. To modify an existing template, the menu item ‘Forms’ can be selected to show a list of currently defined templates, from which the user can select the desired form template to modify. Once the desired template is selected, it is displayed on the screen where the data fields and their associated field names can be added, modified, or removed to reflect the desired layout of Form Template.

If the Dispatch Center 130 user desires to create a new Form Template, they select the ‘Add’ option from the menu, which places data fields on the screen as desired. Once placed on the screen, the data fields may be moved, resized and named by the Dispatch Center 130 user as necessary to reflect the desired layout of the Form Template. Once the Form Template has been created, the dispatch center 130 user selects the ‘Save’ Option from the menu. An appropriate name for the Form Template is then entered, and a slot (1 to 16) in the form list is chosen. The selected slot determines the Form ID for this form template. The Form ID is used in all transactions to identify which Form Template is to be used for the form transaction. The Form Template is then saved to the Form_Def table in the Dispatch Centers 130 database for subsequent use.

Optionally, the Form Templates can be exported to a file for transfer to secondary Dispatch Centers 130 by selecting the ‘Export’ menu item . To send the Form Template to a PDA/computer 118 connected to a mobile unit 117, the user selects ‘Send Form Definition’ from the main menu of the Dispatch Center 130, This opens a window with selections for defined Form Templates and Mobile Units 117 in the users fleet. Once the user selects the desired Template and the desired Mobile Unit 117 to which to send the Form Template, the ‘Send’ button is clicked. This creates a formatted MDPP Packet from the selected Form Template, using the structure described above, and sends it to the selected Mobile Unit 117,

Creation of New Form:

Once Form Templates have been created and sent to the PDA/computer 118, the Form Template can be used to create a new form in the following manner. The Dispatch Center 130 user initiates a new form by selecting the ‘New Form’ option from the main menu of the Dispatch Center 130, This opens a window with a list of available templates and Mobile Units 117 to which the form can be sent. Selecting a Form Template from the list, opens the form as designed above and allows the Dispatch Center 130 user to enter data into the fields as needed. Once the desired form has been populated with data, the Dispatch Center 130 user selects a Mobile Unit 117 to which this form is to be sent, and clicks the send button. Form data is then inserted into the message fields of a MDPP Packet with the structure described above, and is sent to the selected Mobile Unit 117, The MsglD is temporarly set to to XX000000, where XX is the temporary Magi set by the Dispatch Center 130, and the Status of the form is set to 09, which indicates that the new form is pending delivery to the PDA/computer 118, When the form is received by the PDA/computer 118, the unit replies back to the sending Dispatch Center 130 with a permanent Msgld number XXYYYYYY, where XX is the temporary ID assigned by the Dispatch Center 130, and YYYYYY is the permanent ID generated by the PDA/computer 118, This permanent ID is a reference to where the form resides in the database of the PDA/computer 118, and a it is given a status code of 01,

When the Dispatch Center 130 receives this new MsglD and Status, the Forms table in the database is updated with the permanent ID, and new Status. The temporary ID is then set to 00, For the life of the form this permanent Msgld is used as a common reference to that particular form in both the PDA/computers 118 database and the Dispatch Centers 130 database. With the Status changing to 01 the active forms display is updated to reflect that the PDA/computer 118 has received the new form.

Reception of new Form From PDA/computer 118:

When the Dispatch Center 130 receives a form that was created by the PDA/computer 118, the Msgid is in the form of FFXXXXXX, where XXXXXX is the permanent Msgid created by the PDA/computer 118, When a Msgid of this format is detected, the new form is saved to the Forms tables with a Status of 11, The Active Forms screen is updated to reflect the reception of a new form, and the Status icon for the form blinks indicating that a new form has been received but not yet read by the Dispatch Center 130 user. The quick select box for that Mobile Unit 117 also blinks to indicate the presence of unread forms.

Form Modification:

Once a form has been created and sent by either a PDA/computer 118 connected to a Mobile Unit 117, or by the Dispatch Center 130 operator, it can be freely modified as desired by either Dispatch Center 130 operator or PDA/computer 118, When field data in a form is changed and saved, the Msgid and the changed fields are sent to the other party in formatted MDPP packets, as described above, thus keeping the PDA/computers 118 and the Dispatch Centers 130 databases in synchronization

Form Deletion:

Both the PDA/computer 118 and the Dispatch Center 130 have the ability to delete forms from both databases. The mobile can choose to delete a form by opening the desired form, and selecting the ‘Details’ button from the form screen, and the selecting the ‘Delete’ option from the details window. As above, in Form Modification, a formatted MDPP Packet is created with any changed data, and is sent to the Dispatch Center 130 with a status of ‘99’. This updates the Dispatch Centers 130 database and places the current form in a archived state. This action also permanently deletes the current form from the PDA/computers 118 database, and no further action can be performed on this form.

The can Dispatch Center 130 operator can delete a form by selecting and opening the desired form, then selecting the Delete option from the Forms Menu. As above, a formatted MDPP packet with the Msgld of this form and status of ‘99’ is sent to the mobile. When received by the PDA/computer 118, it deletes the form with Msgld from it's database. On the Dispatch Center 130, the forms status is also changed to ‘99’. This places the form in a archived state, but it remains undeleted from it's database until it is purged by the operator. By archiving the form, its' data can later be retrieved for additional uses, such as reports, invoices or any other purpose desired by the user.

(C) Mobile Forms: PDA/computer 118

Note: MDF-#### refers to line number in MDForms_src

MDC-#### refers to line number in MDComm_src

Overview:

The operation of MD Forms on a remote device, is via a PDA/computer for data collection, modification, and the display of MD Form documents. The PDA is connected to the mobile unit controller 162, which is contained as part of a mobile unit 117 in analog operation. It communicates form data information between the PDA/computer and the Dispatch Center 130 via mobile data central 110, and internet 112, controllers, and the internet . The PDA/computer 118 has two main software components, MDComm, which handles all data communication and MDPP packet processing between the PDA/computer 118 and the Mobile unit 117, and MDForms, which acts as the primary user interface for all MDForm documents. It also handles the storage of Form Templates that have been created by the primary Dispatch Center, and the form data associated with the various Form Templates. This information is stored in multiple data bases contained within the PDA's memory.

The PDA/computer has no ability to create Form Templates. The only templates available to this unit are those that have been sent by the primary Dispatch Center 130, Once Form Templates have been received from the Dispatch Center 130, the PDA/computer 118 can freely use those templates to create new MD Form documents, or modify ones that have already been sent to it. The application MDForms has the primary responsibility of assigning a permanent Msg to all forms that it receives or creates, and then returning this id to its' primary Dispatch Center 130,

(D) Operational Flow: MDComm

MDComm Overview

The MDComm application's primary purpose is to provide a conduit between any applications that require data transactions with the mobile unit 117, This is accomplished thru an RS-232 serial connection between the PDA/computer 118 and the Mobile Controller 117, Also included with the serial connection is a control line, which is used by the mobile controller to signal the PDA. This line is monitored by the PDA/computer 118 to determine if there is data in the mobile controller's data buffers that needs to be processed. Secondly, MDComm acts as a data integrity buffer to insure that the MDPP packets reach their destination.

MDComm PDA Data Reception From Mobile Controller 116:

When the Mobile Controller 116 contains data in its receive buffers, to be sent the PDA/computer 118, it supplies a ground (0 volts) on the control line mentioned above. If the PDA/computer 118 is in either a sleep state, or is running another application, this control input is monitored by the PDA's operating system. When the PDA/computer 118 senses this control as being active, it launches the MDComm application. When MDComm is launched, MDComm replaces the PDA's operating system as the exclusive event handler for this control input. After its initialization, MDComm monitors this control(see MDC-648) input to determine if the Mobile Controller 116 is requesting its attention. When it senses this line as active, it opens the serial port of the device and starts to listen for command strings from the Mobile Controller 116 (see section IV, table 6). Upon reception of a command string (see MDC-1030), MDComm parses this command to determine the content of the command. If the Mobile Controller 116, contains data in its buffers, it will send a string of “,RvXsYYmZZ.”, where X is the buffer in the mobile, YY is the serial number of the MDPP packet, and Zz is the MDPP mode of the packet.

The packet serial number is first checked against a list of recently received serial numbers, to determine if this packet has already been received (see MDC-1041). If the serial number appears in this list, a command string of “RzX” is sent to the mobile controller 116, (where X is the buffer in the mobile controller) to clear the data from the buffer. Otherwise, a command string of “RxX” is sent to the mobile controller to retrieve the MDPP message packet from its buffer (see MDC-1065). When received from the mobile controller, the MDPP message packet (see MDC-1155) is parsed based on the mode of the packet. Once all information is retrieved from the packet, it is formatted into an inter-application message. This message will then be sent to the appropriate application (see MDC-1241). In this case, the application is MDForms. MDForms will then process this message as necessary and, if applicable, take any returned information and compose an appropriate reply message(see MDC-1315). This process continues until the Mobile controller 117 contains no more data and it releases the control line.

MDComm PDA Data Transmission to Mobile Controller 116

When other applications have MDPP message packets to send to the Dispatch Center 130 or other destinations, they create a inter-application message containing , the destination, Mode, and data payload of the packet. When MDComm(see MDC-777) receives this message, the message is placed into it's “packets pending for transmit” database. It then returns control to the calling application. When the PDA/computer 118 is connected to the Mobile Controller 116, which activates the control line, as described above. This action starts the MDComm application. As above, MDComm opens its serial port and establishes a connection to the mobile. If there are packets pending for transmit (see MDC-913), they are sequentially retrieved from the “packets pending” database, then properly formatted into MDPP packets and sent to the Mobile Controller 116, The serial port is then monitored for a message indicating that the Remote Base System 124 has received a valid packet. The record associated with this packet, is updated in the MDComm database, indicating that it has been sent and was acknowledged, thereby allowing the next packet record to be processed. If the message “TiXsYYmZZ” is received by MDComm from the mobile controller, this indicates a transmission error and an attempt to resend the packet is made.

Some packet types are deleted from the data base as they are successfully sent, others such as MDforms require confirmation of delivery by the recipient. These packet records are not deleted until a “confirmed delivered message” is received form the recipient. After a predetermined amount of time, the packet record is flagged as unsent if no confirmation has been received. It will then wait to be re-sent during the next communication session with the mobile unit. This ensures that vital data will not be lost between the PDA/computer 118 and Dispatch Center 130,

(E) Operational Flow: MDForms

MDComm Overview

The MDComm application is the primary user interface for the processing of MDForm documents in the mobile environment. It manages the display, creation and modification of MDForm documents. Form Template definitions, received from the primary Dispatch Center 130, are stored in the MDefs database, and MDForm documents are stored in the Deforms database. As described above, communication with the Mobile Controller 116 is handled by inter-application messages that are sent to the MDComm application.

MDComm Form Template Reception form the Dispatch Center 130

Before a form can be used on the PDA/computer 118 device, it must be defined and sent to the PDA device by the primary Dispatch Center 130 user (see section VII Forms Template creation). When an inter-application message is received form MDComm, (se MDF-7197) it is checked to see if the message contains Form Data or Form Template information. If it is determined to be a template, the form number, which can be in the range of 1 to 16, and the number of form fields, are extracted from the FormID portion of the message. A database record is created with a number of fields, as determined above, and is populated with the names contained in the data fields of the message. MDDefs is then opened and the newly created record is stored in the database position as determined by the form number. The database is then closed, and control is returned to the MDComm application. At this point, the Form Template is saved and now available for use.

New MDForms Documents Created by PDA/computer 118 User

The user can create a new form by first selecting an existing Form Template from the templates list, which was previously sent by the Dispatch Center 130, The user then proceeds by selecting the “Select NEW” button. A blank form template is opened on the screen for user input. The user can now enter data in the fields as desired. Optionally the user can set a status for this form, by selecting the “details button” and then selecting a status from the drop down list. When data entry is complete and the user selects the DONE button on the data entry screen, a new database entry is created for storage of this form.

The operating system generates a 32 bit unique Id for this record. This ID never changes for the life of the record and is used to assign the permanent MsglD that is associated with the form (see MDF-7250). The user then selects the send button which creates a formatted inter-application message containing the destination MIN, MDPP mode, MDPP formatted data payload from fields which have data, and their associated field delimiters. This inter-application message is then sent to MDComm, which stores it for transmission to the Dispatch Center 130, This payload data contained in this message is shown as follows:

A0 h XX00 A1 h FFYYYYYY C1 h ZZ A2+Field1 data A3+Field2 data.

Where: A0=FormID Delimiter in hex

XX=FormID

A1=Msgid delimiter in hex

YYYYYY=Msgld

C1=Status delimiter in hex

ZZ=Status

New Forms Document Received From Dispatch Center 130

When an MDForms document is received from the MDComm application via an inter-application message, the Msgid is checked to see if it is a new document. This is accomplished by checking the first two digits for any value other than zero, with the remaining digits all being equal to zero. If this condition is true, then the form is flagged as new since it presently does not reside in the unit's database. A new form record is created, and the record is then populated with the FormID, the MIN of the form sender, and the data for each field in the form. The MDForms database is then opened and the new record is added to this database. The unique id for this record, as determined by the database, is now the permanent Msgid for this form. The Msgid is amended such that it now contains the temporary Msgid supplied by the Dispatch Center 130 and the permanent Msgid which was just generated by the database, ie XXYYYYYY, where XX is the temporary id and YYYYYY is the permanent id. This id, along with the senders MIN are returned to the MDComm application, which generates a reply message to the Dispatch Center 130, The Dispatch Center then uses this information to create a common reference for both databases. When the user next opens the MDForms application this form will appear in the list of active forms on the display.

An Updated Form Document is Received From Dispatch Center 130

As in the example above, when an MDForms document is received from the MDComm application via a inter-application message, the Msgid is checked to see if it is a new or existing document in the database. If the first two digits of the Msgid are 00, with the remaining digits being other than zero, then this condition indicates that the data received is updated information for an existing document in the database. The Deforms database is then opened and a record search is performed based upon the received Msgid. The record search results in locating a record containing the existing stored data of the desired form. Data fields from the new inter-application message are now used to replace the existing data in corresponding fields of this record. Once this update is complete, the record is saved to the database and the database is then closed. The newly updated form is now saved and control is returned to the MDComm application.

If the Dispatch Center 130 sends a form update with a form status of 99 (i.e., “Delete Message”), the form with the received Msgid will be deleted from the database and is no longer available to the user.

The User Views/updates a Mdform Document

To view or update a current form, the PDA user starts the MDForms application. Upon start up, the main screen containing all current forms is displayed. If the user wishes, they can select a form template from the drop down list of available templates. This will act as a filter, and only forms of that type of template will be displayed on the screen. When a form is selected from the screen, the MDForms database is searched for this selected form, and the is record is retrieved. From this record the Formid is retrieved and the MDDefs database is searched for that form template. The form template is then retrieved, and Field names with empty data fields are drawn to the screen. Next, the data fields are populated with data from the form record. The completed form is now displayed on the screen. If the user views the form and takes no other action on the form, no action will occur to the form when the user closes this screen. If the user changes or adds data to any field in the form, the changes to the affected fields are recorded. This continues until the user closes this form screen, at which point the changed fields along with their associative field delimiters, the FormID, the Msgid, and destination MIN are compiled into a data payload packet. This packet is then sent via a inter-application message to the MDComm application, which stores this packet for subsequent delivery to the Dispatch Center 130,

The User Deletes a Mdform Document

As in previous examples, when the user is viewing a Deforms document, they have the option of deleting this form from the database. The user selects the DETAILS button from the bottom the forms screen. This open a details window where the user can select the “DELETE” button. When this button is activated, an inter-application message is created with a payload packet containing the Msgid of this form and and a status of 99, This message is then sent to the MDComm application, and the form is deleted from the database and no longer available for use.

It will be appreciated that the present invention makes a available a high performance, economical, secure wireless data telemetry system well suited for use in a variety of applications including remote sensing, vehicle location, and time-stamped data collection and transmission.

Broadly speaking, system 100 and method of the present invention make available a wireless data telemetry system which efficiently sends information between a mobile remote unit and a controller base. Only changed information is transmitted.

System 100 is customizable in the sense that the user can take a data file stored on the user's own server network and analyze the data in any way they prefer so they can make customer reports themselves and, in the case of forms, generate their own custom forms.

System 100 also provides enhanced security, in that segments of files or documents are only sent over the air when needed, an entire file or document is seldom transmitted.

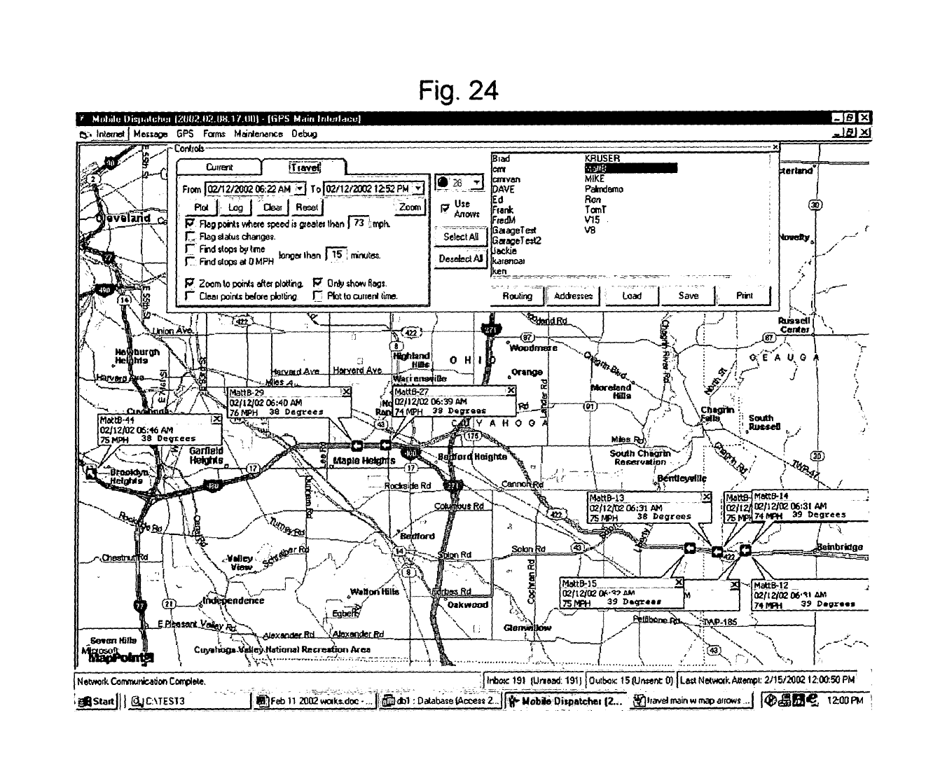

In addition, the novel software enabled facility for “geo-fencing” can provide specific locations and use patterns for monitored vehicles; for example, in a large corporation, one may need to analyze the traffic near a selected loading dock. The customer or user can define a geo-fence area to monitor movement near each loading dock and have a separate data entry in the geo-fencing for that dock. Geo-fencing is basically a simple way of taking a map plot, either produced by a mobile or by a pointer on a map, and giving the defined plot a name and other defined parameters. Parameters can be, for example, how large a circle or area around a point would be defined to fall within that place name or entity. Multiple plots or entities can be included in a larger geo-fenced plot, taking for instance a large (e.g., mile long) facility, and covering the entire facility with a blanket, so to speak, such that when any vehicle goes into that blanketed area, it is displayed as being within the named area. But then one may also narrow it down to a specific loading dock, so a geo-fence sub-area can be nested within a larger geo-fence area. When one enters a large geo-fenced area with nested sub areas, the monitored vehicle (e.g., 228) is documented as being within the geo-fenced area, and upon moving toward a smaller geo-fenced area nested within the larger area (e.g., a loading dock), the plot (e.g., like FIG. 24) documents not only the large geo-fenced area but also that specific loading dock, so a user at a dispatch center can look back at the records and say, for example, “yeah, he was there at 10:00 yesterday and he went to Loading Dock 1”. The geo-fencing definitions and reports are all customized in the Customer Service procedure included in setting up a given customer's private dispatch center; no one else shares in that information.

All the customer's data is stored at the dispatch center at the customer's location, not at the central controller or provider's location, so customers can add their own user specific forms and other programming without sharing that information on an open server. They can have their customer database working in conjunction with their software and not have to share that information on an open server. The custom forms are installed on unique server bases. The customer's data is stored in a database file with an open architecture, so they can write their own programs to it, export and import the data and interface it directly into their own system. The customers don't need to go outside their own facility to get AVL (or other) data, and since information is shared between the customer's dispatch center and the customer's other computers, that sharing is done internally instead of on a service provider's central controller server. Any information that's shared is private information and as the provider's central controller 110 has no access, thereby providing a high level of security. As a result, the customer or end user is more secure because their proprietary information is at their dispatch center 130 and not in the provider's central controller.

At the provider's central controller 110, only transient bits and pieces of information are stored. In the case of forms, the service provider at the central controller can't even re-compile the forms. So a provider can't even re-create what the customer has created because the provider does not have the customer's form definitions. When a mobile unit (e.g., 116 or 117) sends a form, the customer/dispatcher gives the form an I.D. and sends it back, but only sends the shared information so there's no correlation between the two. Financial transactions and the like can be processed with a relatively high level of security. Communication between the modular elements of the system is MIN-based so there's positive end-to-end verification on the transmission because each unit has a particular MIN or unique identifying serial number.

The trunking structure is very important because it allows the system to be expanded in a very inexpensive manner. The “smarts” are put in the modular mobile unit (e.g., 116 or 117) instead of the system yielding a structure that is very cost effective, in part from using standard analog radios or digital packet data transmission components.

Preferably, the modular mobile units (e.g., 116 or 117) and remote base units 124 are built from scratch. In analog system 100, no one pays for air time, so there is a large cost advantage because no separate carrier is paid for their services.

Additionally, system 100 is modular and adaptable or customizable in that other kinds of wireless links can be used, if need be. In a campus or private network, the system will work with virtually any analog radio system such as those now in use by large corporations or existing utilities, and without rebuilding the entire structure of these services. Large customers who already have an installed base of their own radios can simply obtain the modular Mobile Controller board (e.g., “Racom Mobile Controller” as shown in FIG. 6) and attach it to their own radios. Compatible analog radios are made by Kenwood™, Johnson™ and Motorola™ and the Racom Mobile Controller data connection is typically plugged into the back of those radios. The Racom Mobile Controller controls the radio channel selection and everything else, and the customer can use this on an exclusive use or private channel.

Similarly, the customer can choose to use a modular 1700 remote base controller 140 also connected to a third party manufacturer's radio.

The customer can choose connect through the provider's central controller 110 (or switch) or, for a large private environment, they may choose to purchase the switch 110.

Optionally, in a multi-level environment, the modular units can be configured to use the analog radios described above either with or without digital units (116) and cellular wireless networks, such as a cellular digital packet data (CDPD) network, as shown in FIG. 1. A multi-level environment would be appropriate for a large company or nationwide organization with both regional and nation-wide communication needs. The regional needs are well met by the embodiment of FIGS. 1-7 using either analog radio wireless links or digital packet data links. For national needs, an alternate level permits use of digital telephones along with analog radios with all of the mobile units 117, both in the region (i.e., when served by remote bases 124) and out of the region (i.e., when out of range of remote bases 124), using the same switch 110,

The analog and cellular connected mobile unit (not shown) communicates with the same central controller 110 as the analog connected mobile unit 117, So both can use the same switch and they're fully integrated. When using the cellular or packet data wireless link, however, data latency is expected to be longer and the ready availability of a private analog radio link is lost. Central controller 110 can do TCP/IP and serial Rs232 communication and can interface into the internet, cellular or analog simultaneously and is also able to interface into multiple frequency bands, (e.g., 900 MHZ). If there were a 900 MHz system in one city, one could have a 450 MHz system in another city and a 220 MHz system in another city; all come back to the same dispatcher center 130; each would be their own networks, but also could use the same central controller or switch 110,

System 100 is flexible and its adaptable because one can basically put any kind of information into MDPP packets and send them through the system. The user or customer creates a data base on both the dispatch and mobile ends that share common records so they can share the information.

Turning to another operational feature, if a user forgets to hook up control head 118 to the mobile unit (116 or 117), then when the user later connects to an e-mail server, system 100 automatically downloads any untransmitted form information through the internet. As soon as the user activates their e-mail, control head 118 provides a link and informs central controller 110 that e-mail is being sent, and if any forms were left untransmitted, control head 118 sends the stored and untransmitted form data to the customer's dispatch center 130 via the internet. If the user is on-line, they have access to the internet, but if they don't have internet access, their data is stored for later transmission through the mobile. Conversely, if the stored data doesn't go via the mobile unit (116 or 117), it goes via the internet. At the earliest opportunity, control head 118 will send the form information.

### X Alternative Embodiments

(A) Summary of New Features:

In another embodiment, new features are incorporated into the Mobile Data Mobile Unit 117A, Main Controller 110A and Internet Controller 112A.

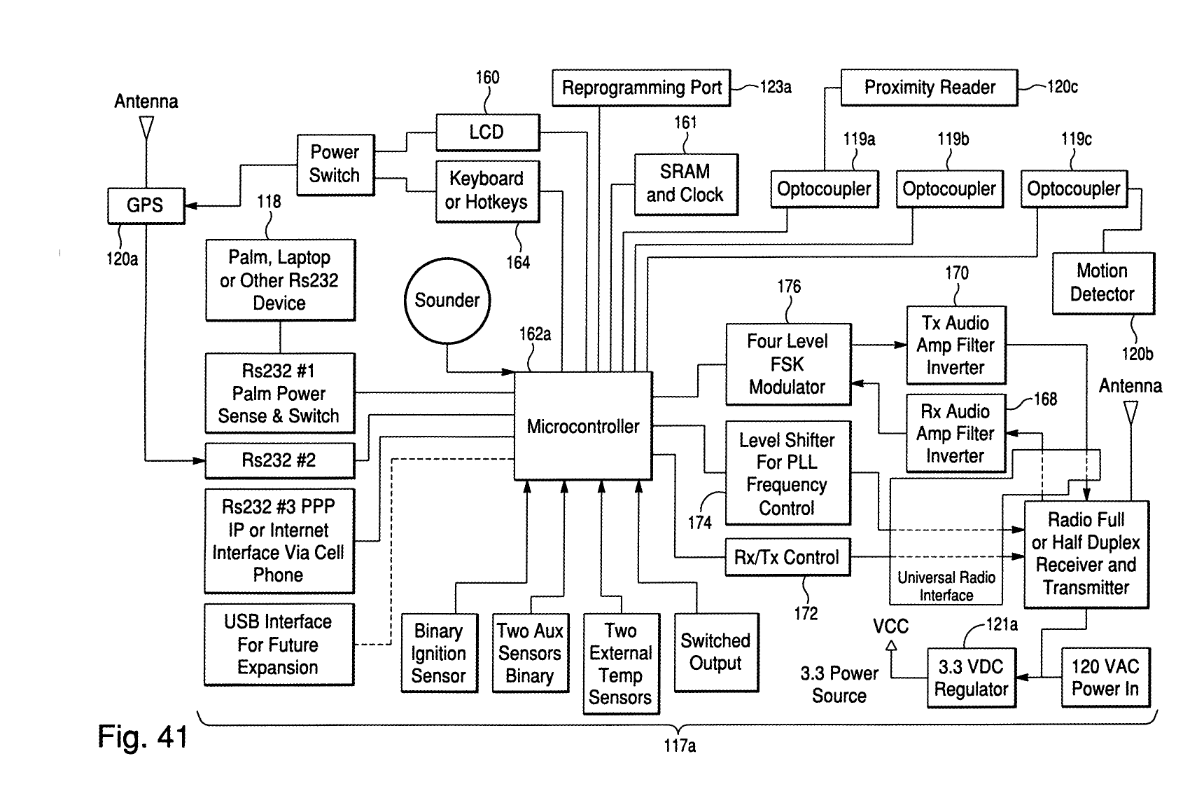

Referring now to FIG. 41, Mobile Unit Logic Controller 117A is on a single circuit board which contains components that were previously mounted externally to the board. The original design (of FIG. 7) operated with an external GPS receiver, and external ignition and sensor relays. The new Logic Controller 117A contains a resident GPS receiver 120A, 3.3 volt power regulator 121A, and up to three optocouplers (119A, 119B, 119C) for interfacing to ignition and external sensor devices (e.g., tamper detecting switches or sensors, not shown). The internally mounted GPS receiver 120A provides for greater reliability and GPS performance, while making the unit less vulnerable to tampering. The optocouplers (e.g., 119A) replace external relays used for ignition switching and sensor inputs. The optocouplers provide non-polarized sensor inputs with a higher input resistance, thereby requiring less current draw and loading upon the various sensor devices located in vehicles such as door pin switches and alarm contacts.

The Logic Controller CPU 162A has been upgraded to a new reprogrammable version, and a new programming port 123A has been added to this new circuit board design. In past designs, software upgrades involved physical replacement of the CPU. Now, software upgrades and feature changes can be made by reprogramming the CPU with a portable computer through data port 123A.

A new mobile operating feature now available is that of an auto intruder and theft alarm. Through the use of new software and the optocoupler sensor inputs (e.g., 119A), the Mobile Unit 117A can now be programmed to function as a vehicle alarm. One sensor input functions as an intrusion detector, while a second sensor input becomes an alarm control/reset input. When an alarm condition is detected, an alarm flag is set and is transmitted as part of an MDPP packet to the Main Controller 110A. The Main Controller processes the packet and sends an “alarm set” notification by way of an SMTP message to a radio paging/message center. The alarm notification is then received by a designated paging receiver, alerting the owner/driver of the alarm condition.

The Mobile Unit 117A also now incorporates circuits and software programs for gathering and transmitting power line monitoring and vehicle motion sensing information. This information is sent to the Dispatch Center (e.g., 130) to notify the customer of a power line or ignition line interruption, which may indicate possible tampering with the power wiring of the Mobile Unit 117A. Motion detector 120B and the vehicle motion sensing program also provide vehicle location monitoring when the unit is in a normal “Off Condition”. This allows a vehicle to be tracked if it is towed, or transported by a trailer. This feature enhances the auto intruder and theft alarm described above.

In the event the main power line to Mobile Unit 117A is interrupted, a tamper alert signal is generated and sent to Dispatch Center 130 immediately when power is restored. This causes a corresponding “Tamper Alert” notification to be displayed on the Dispatch Center screen. In normal operation, constant power is applied to the GPS receiver 120A, and a minimal amount of logic circuitry. This enables the mobile logic to always monitor speed and position. The Mobile Unit 117A is usually switched on & off by means of the vehicle ignition switch. If there is a failure in the vehicle ignition circuit due to tampering or other malfunction, Mobile Unit 117A will be automatically switched on, through an internal ignition bypass circuit, when movement is detected by the GPS & logic circuitry. This condition is displayed at the Dispatch Center 130 with a flag showing “Movement With Ignition Off”.

One other option allows Mobile Unit “on-off” control by way of a momentary contact. Instead of using a constant “ignition on” input, the unit can be switched on by a brief power pulse. Under this condition, Mobile unit 117A remains in the “on state” for a predetermined period of time. This “power on” state is then reinforced by the movement detector, or additional momentary power detection. This allows Mobile Unit 117A to be activated by a vehicle “brake light” circuit or other similar devices.

Pulse and Timer Control of Mobile Unit.

The original mobile unit 117 has a connection to the ignition switch of the vehicle, as shown in FIG. 7. This connection is used to power down the mobile unit 117 and put it to an inactive “stand-by” mode when the vehicle ignition was off. With this configuration, the mobile unit 117is mostly disabled when the vehicle ignition is off. In the embodiment of FIG. 41, other conditions (e.g., theft detection) enable the mobile unit 117A.

The ignition connection of the embodiment of FIG. 7 has been replaced with a pulse wire connection. When this pulsed wire has 12 volts applied to it, mobile unit 117A goes out of its power down mode and into full operation, starting a programmable shutdown timer. The timer programmable shutdown is used to power down mobile unit 117A and puts mobile unit 117A into an inactive “stand-by” mode when the timer times out. As long as power is on the pulsed wire the timer will stay at the programmed minutes set point. Detection of movement with GPS and alarm sensor inputs will also enable mobile unit 117A and start the programmable shutdown timer. The value of the programmable shutdown timer can be set to any time between 0.5 to 64 minutes. The pulse wire connection may be connected to the vehicle's ignition, brake, doors, lights or other switched points.

Temperature Sensors for Refrigeration and Freezer Trucks.

Two or more temperature sensors inputs have been added to mobile unit 117A, as shown in FIG. 41. These are typically used on refrigeration and freezer trucks. The temperature from the sensors can be transmitted at intervals of 0.5 to 64 minutes. The temperature sensors are of a one-bit bus configuration and can have be up to 50 feet of cable connection them to the mobile unit.

Proximity Reader.

Mobile unit 117A is optionally configured for use with a proximity reader 120C. This configuration will allow the mobile to read data from the proximity reader and transmit the data thru the mobile data system in real time mode.

Alarm inputs, theft detection with GPS and emergency button.

Using Mobile Unit 117A, theft detection is accomplished by detection of movement with GPS and alarm sensor inputs. If the ignition is off and the GPS shows movement, then Mobile unit 117A is programmed to generate a signal indicating vehicle is most likely being towed. Two alarm sensor inputs have also been added to mobile unit 117A. One alarm sensor input is the alarm trigger and the other alarm sensor input is the alarm deactivate user input. An emergency button or “panic” button has also been added. This is used by the user of the vehicle and activates the mobile unit 117A to request help in an emergency. When any alarm condition is detected (either GPS, from sensor inputs or emergency) mobile unit 117A will be enabled and start the programmable shutdown timer mentioned above.

MDPP Communication Through a Cell Phone and the Internet.

Mobile unit 117, shown in FIG. 7, uses radio frequency communication on our privately owned system in Ohio. This works well but limits our coverage to Ohio.

Another style of mobile unit connects through a Cell Phone and uses the Cell phone network to provide digital communications. A software stack and state machine for this unit provides for PPP, SLIP, LCP, PAP, IPCP, IP and UDP negotiations and protocols. The unit has an additional rs232 port that connects to the Cell phone and uses the MDPP packet contained within a UDP packet for data transmission. All features of the original mobile unit are also supported by this unit.

(B) Refinement of Dispatch Software.

A number of bug fixes and improvements have been incorporated into the software used in operating the Dispatch Center 130 in order to increase stability and functionality.

First, Dispatch Center 130 now includes preprogrammed algorithms to detect when a mobile data radio is tampered with by looking for status bit patterns and alerting the dispatcher with an on screen prompt and a recording in a log file when the status bit patterns occur. (See the file “objPacket.OBJ.txt” included as part of the program listings on the CD-ROM filed herewith).

The dispatch software can now provide the traditional functionality of a car alarm; a message can be sent to a pager when specific status bit patterns are received. (See the file “objPacket.OBJ.txt”).

E-mails or pages can be sent out when certain statuses or messages arrive.

An enhanced reporting feature has been added that features three standard reports; “Travel and Stops”, “Speeding” and “Status Changes”. (See the file “frmLogs.frm.txt” included as part of the program listings on the CD-ROM filed herewith).

Improved ability to store and report temperature data sent by sensors attached to the mobile data radio. (See the file “frmLogs.frm.txt”).

The dispatch software has been developed to use either Microsoft Access or Microsoft SQL databases, allowing for greater flexibility and speed when dealing with larger fleets of vehicles.

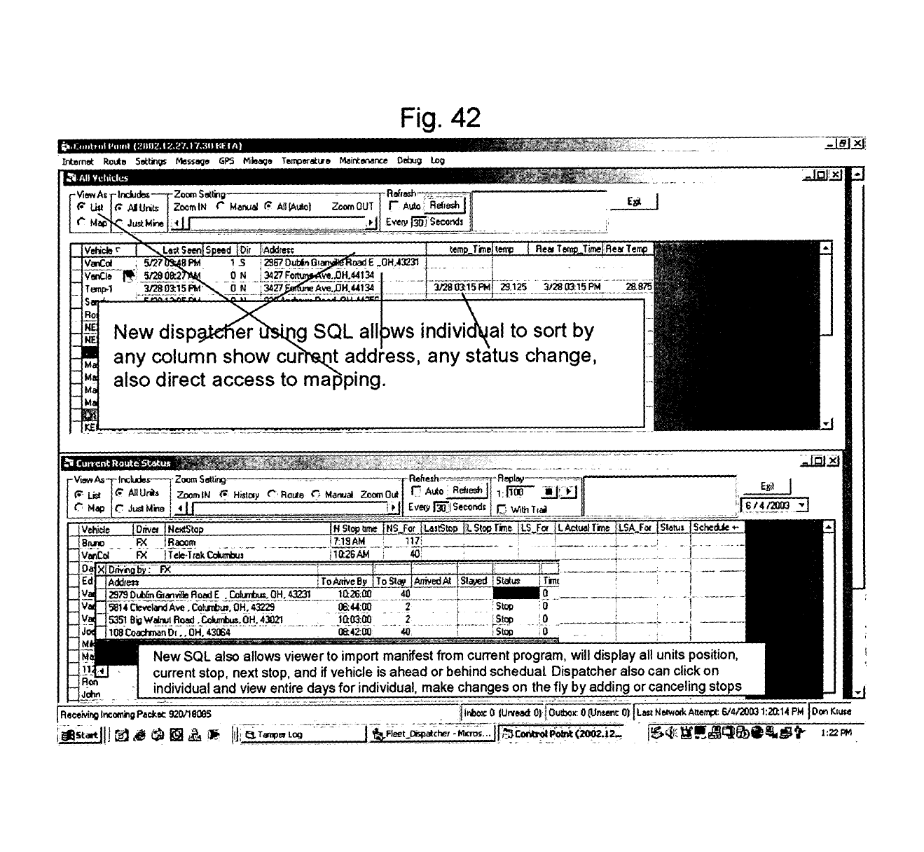

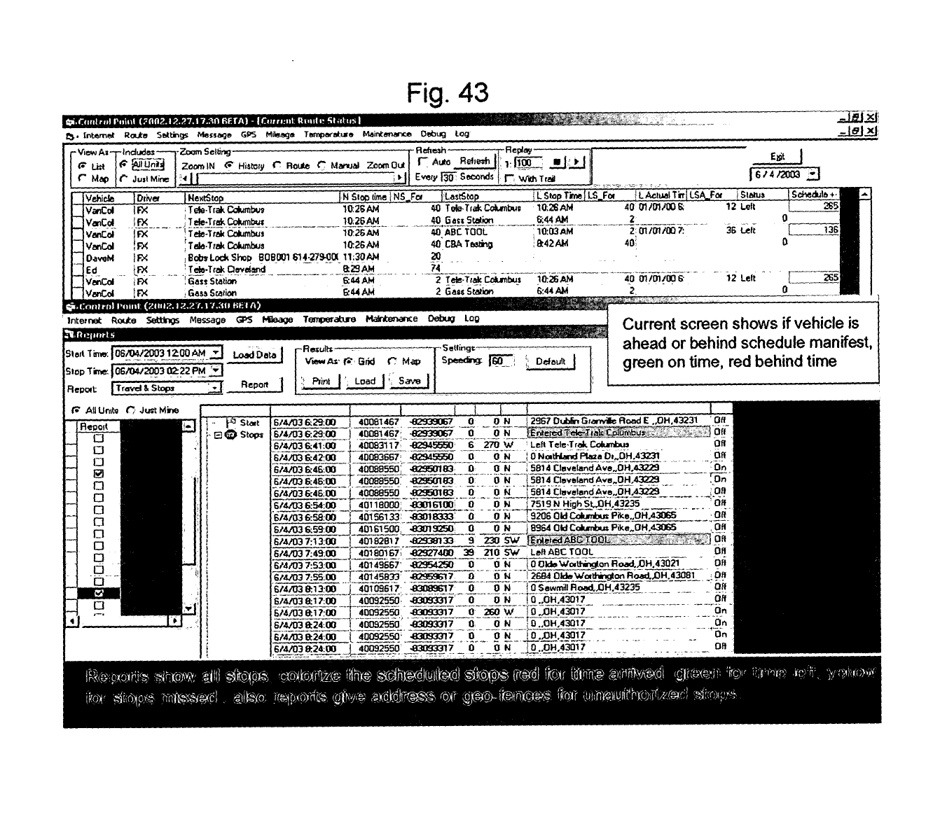

A greatly improved routing system has been developed to utilize the more powerful SQL database. It allows the scheduling and modifying of routes and the ability to watch a vehicle's progress along the route in real time and developing and displaying a history of travel, as best seen in the annotated screen shots of FIGS. 42 and 43,

Routines have been programmed for better stability on database backups and recoveries.

Enhancements to the Dispatch Server

The registration of dispatch MINs has been optimized to reduce the workload on itself and the main controller, thus improving efficiency.

Web Sites

The ability to plot locations of vehicles, as well as fleets has been improved and implemented.

A “programming” web site has been implemented for setting up the various web accounts.

Web sites run off of the main SQL database.

(C) New Free Form Forms Database (currently using MS SQL)

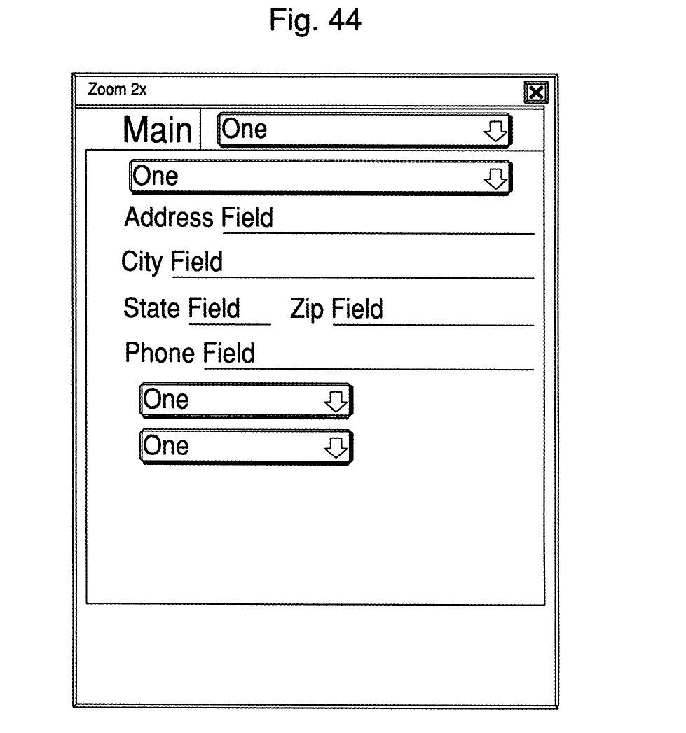

An improved method for creating or defining and distributing electronically processed forms is implemented at least in part, preferably, in the Microsoft SQL™ programming language and permits users to create pages that can be mixed and matched to fit most customer's needs. A user can bounce between different types of forms that have been selected for use, as best seen in the annotated PDA screen shots of FIGS. 44-51,

FIG. 44 is a user interface screen for a new forms method embodiment which illustrates use of a new forms program executed on a Palm™ personal digital assistant as control head 118, The revised forms program permits creation and modification of forms that are up to sixteen pages long, preferably having up to seven types of fields, namely, buttons, triggers, lists, dates, labels, text fields, and check boxes. In the preferred embodiment, the forms database is Microsoft SQL based, but can also be executed in Oracle™ and Fox Base™ brand databases. The forms database can be linked to end user or customer databases (for cost savings) and form data entries can use txt, tab, or comma for delimited import. Custom reports can be based on the fields defined in a given form and a form may include up to fifty fields per page.

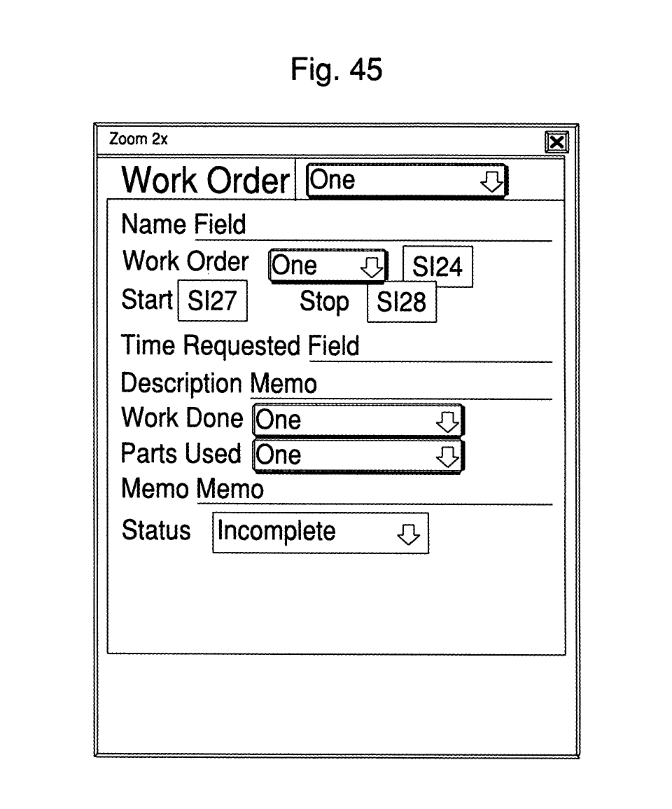

FIG. 45 is a user interface screen for the new forms method embodiment which illustrates use of data fields in the forms program executed on a Palm™ personal digital assistant, and shows a “type 1” field related to an internal terminal database. This database is internal to the mobile unit (e.g.118) and may be accessed by the user at any time without requiring a connection to the SQL server; update is done by a file update operation which can be over the air, but for large files is preferably done by a file transfer operation. Type 1 fields may include customer lists, units, and price sheets.

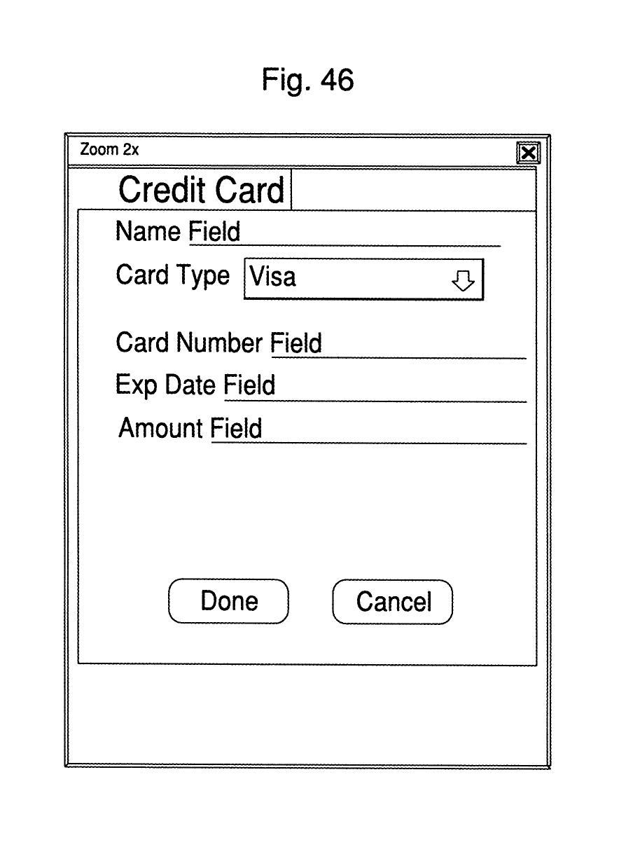

FIG. 46 is a user interface screen for the new forms method embodiment which illustrates use the forms program “drop down box” feature executed on a Palm™ personal digital assistant. The drop down box (shown with “Visa”) preferably incorporates a list with up to twelve items available for display once the down arrow symbol on the right side of the box is selected by the user. Typical form data for inclusion in a drop down box includes credit card types, numbers, dates, days, names, locations or other often-cited items well suited for inclusion on a list.

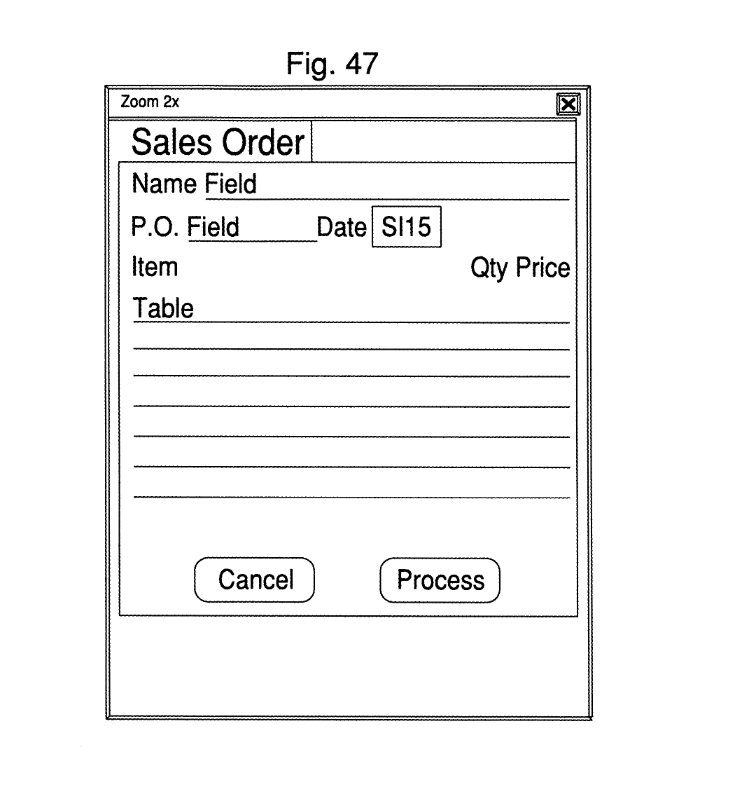

FIG. 47 is a user interface screen which illustrates use of the forms program “fixed field” feature; a fixed field, such as “P.O.” is an item preferably set by the SQL database and can't be changed by the user of the mobile unit (e.g., 118). Data types well suited for use in fixed fields include purchase order numbers, shipping (or sales) order numbers, order types and read-only data.

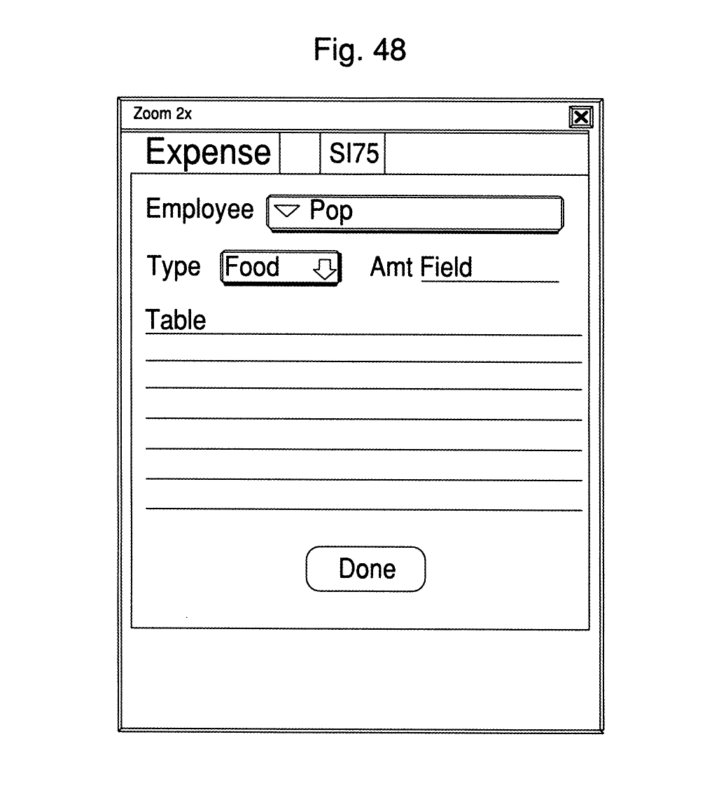

FIG. 48 is a user interface screen which illustrates use of the forms program “free field” feature. A free field allows the user to type or input any number or type of characters, and so is well suited for inputting notes, log entries and other miscellaneous unformatted information.

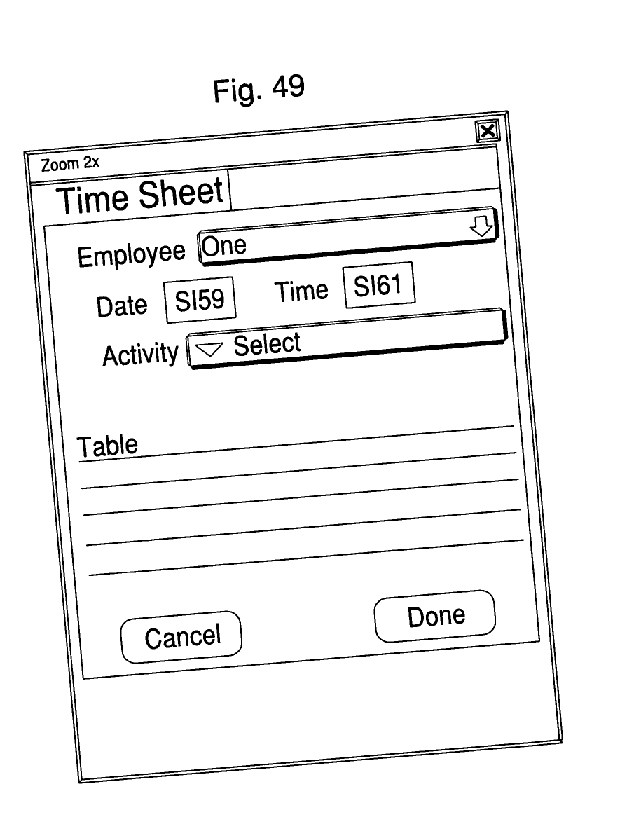

FIG. 49 is a user interface screen which illustrates use of the forms program SQL query feature. The “Activity” field, for example, asks for a query of the SQL database; suitable uses for this type of form field include: inventory checks, delivery time quotes, price checks, or other information requests.

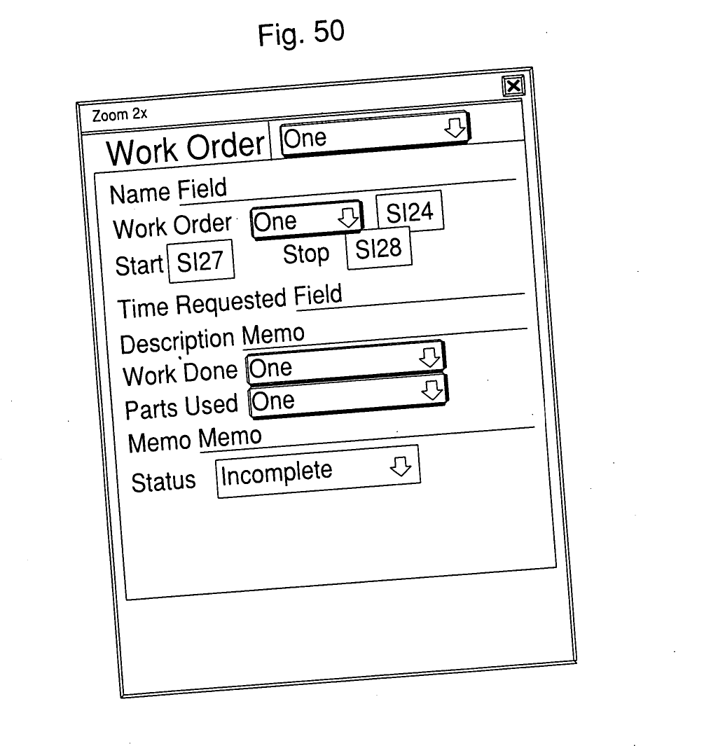

FIG. 50 is a user interface screen which illustrates use of the forms program clock time stamp feature. This feature uses the terminal's clock to time stamp a selected event such as a work order start time.

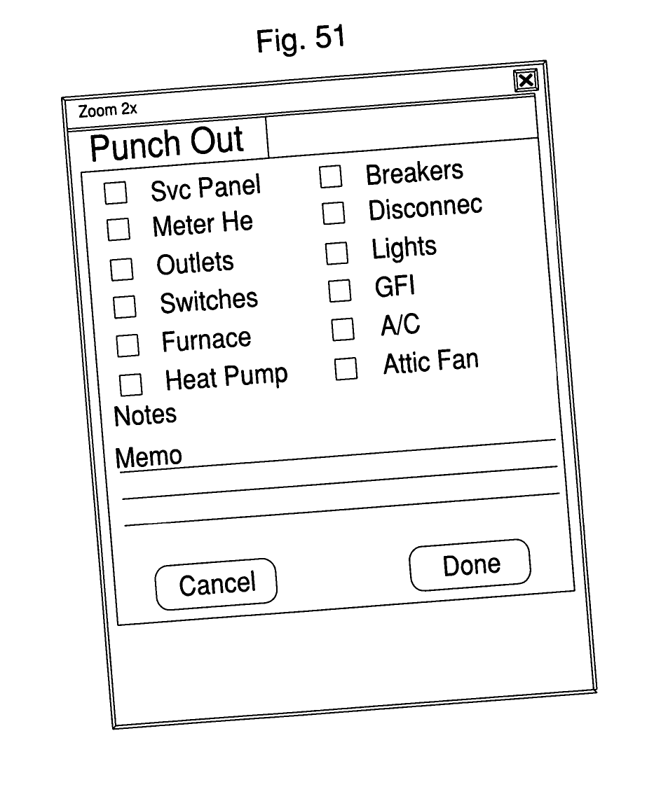

FIG. 51 is a user interface screen which illustrates use of the forms program “check box” feature; the exemplary construction punch list preferably provides a simple touch screen or “hot enter” capability.

Preferably, the pages or forms can be configured to accept and format user selected information supporting a number of business or administrative functions and are readily adapted to generate a variety of user-customizable data entry records such as: customer information forms, sales order forms, (PO) purchase order forms, inventory check forms, time sheet forms, credit card purchase forms, work order forms, expense forms, punch list forms and sales call information gathering forms.

The forms Database is configured with multiple field types, and currently includes seven field types:

1. Check Box

2. Clock Field

3. Database Query Field

4. Free Form Field

5. Fixed Field

6. Drop Down Box Field

7. Internal Terminal Database Field

In a preferred embodiment, the customer master database includes fifty to one hundred of each of these fields. Customers are allowed sixteen pages per form and fifty fields per page, to mix and match the field type creating their own custom forms. Any current database can be imported or scanned by the program allowing for continual updating of company information from the user's master database. Examples include: Product inventory, Backorder list, Company roster, Time sheets, Customer lists, Vendor information forms and Manifest forms.

This database is then synced with the mobile terminals, each terminal can contain its own internal database for look-up on the fly, for un-tethered use. Both the dispatcher and mobile databases are linked and allow flexible uses.

All form transactions can create and import files designed for automated updating of existing customer systems, including SQL, AS400, DB2, DB3, Excel, Lotus, Quattro, UNIX, and any other cvs, text, or delimited import.

Mobile Data—Forms

When the user starts the forms program, they are presented with a main screen. From this screen the user has the option to select a client from a list that is populated from a static database created on the user's host computer. When a user's client is selected from the list, appropriate fields on the form are populated from information in the database associated with the selected client. From this point, the user can select a form from a list of available forms loaded on a mobile device such as control head or Personal Digital Assistant (PDA) (e.g., 118). The user is then presented with a list of open forms of this type for the selected client. At this point, a new form can be opened, or an existing form can opened for further action. The forms database is then searched for the proper record, and the selected form is opened and populated with data from this record. Once the user is finished with the form, its contents are stored in the database, and the user is returned to the main screen.

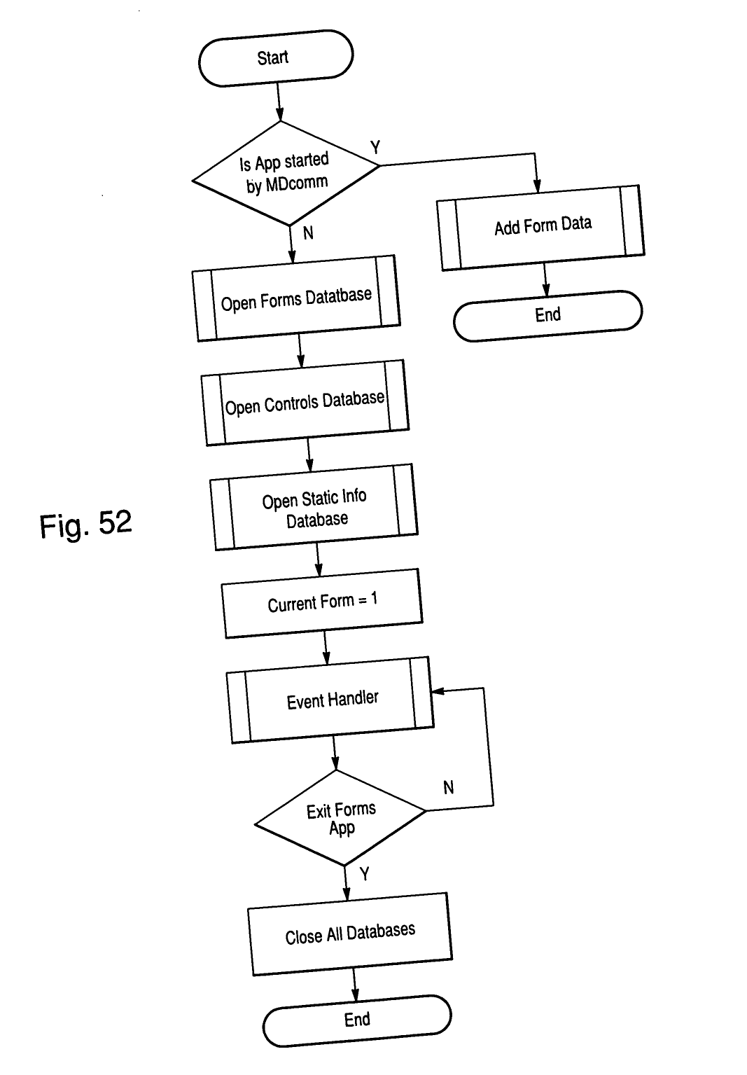

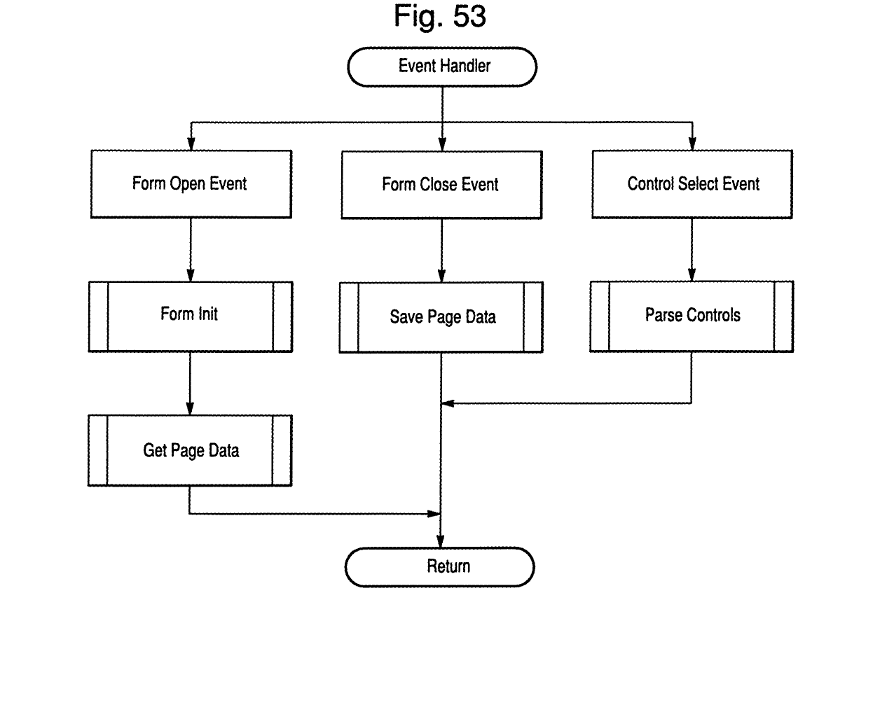

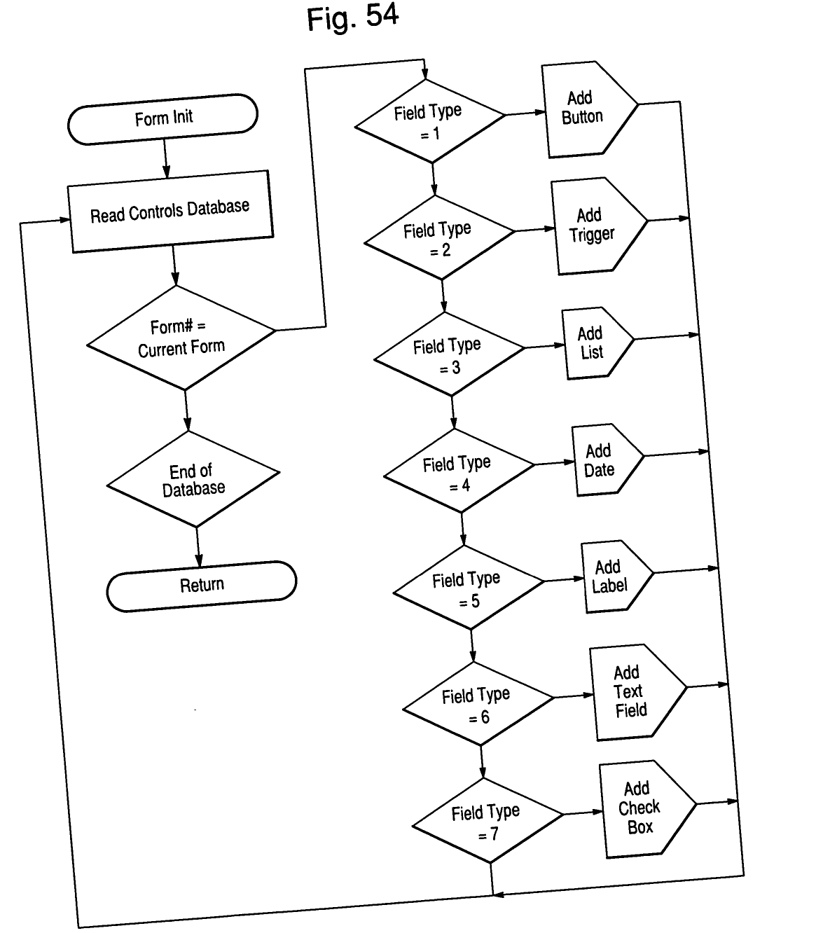

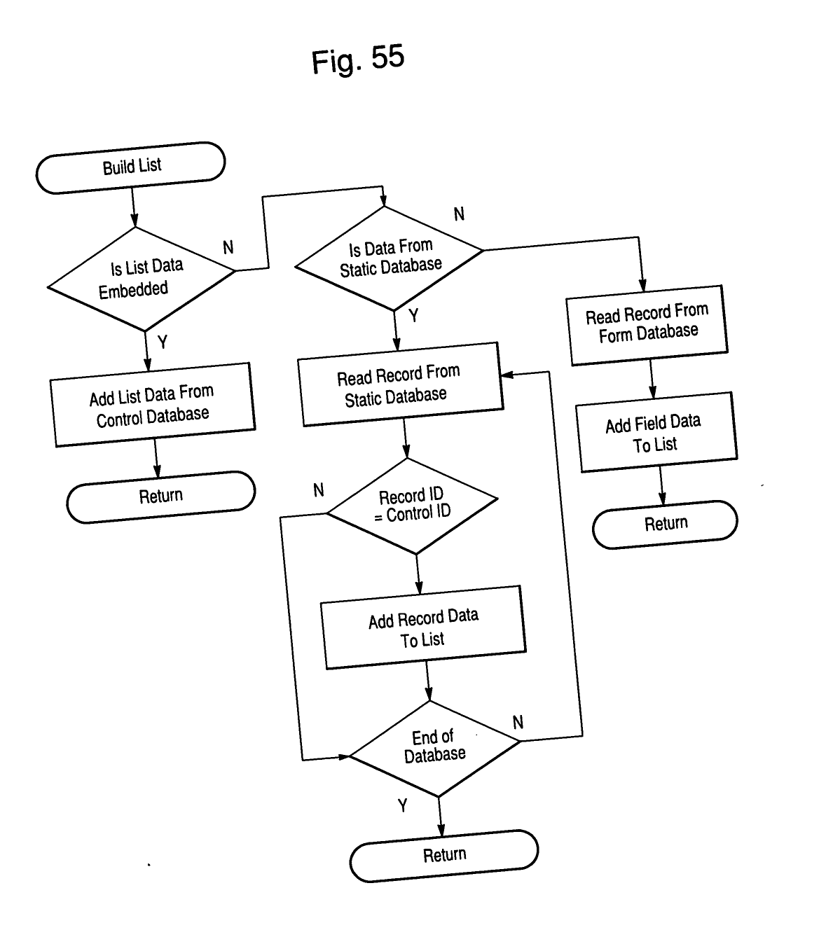

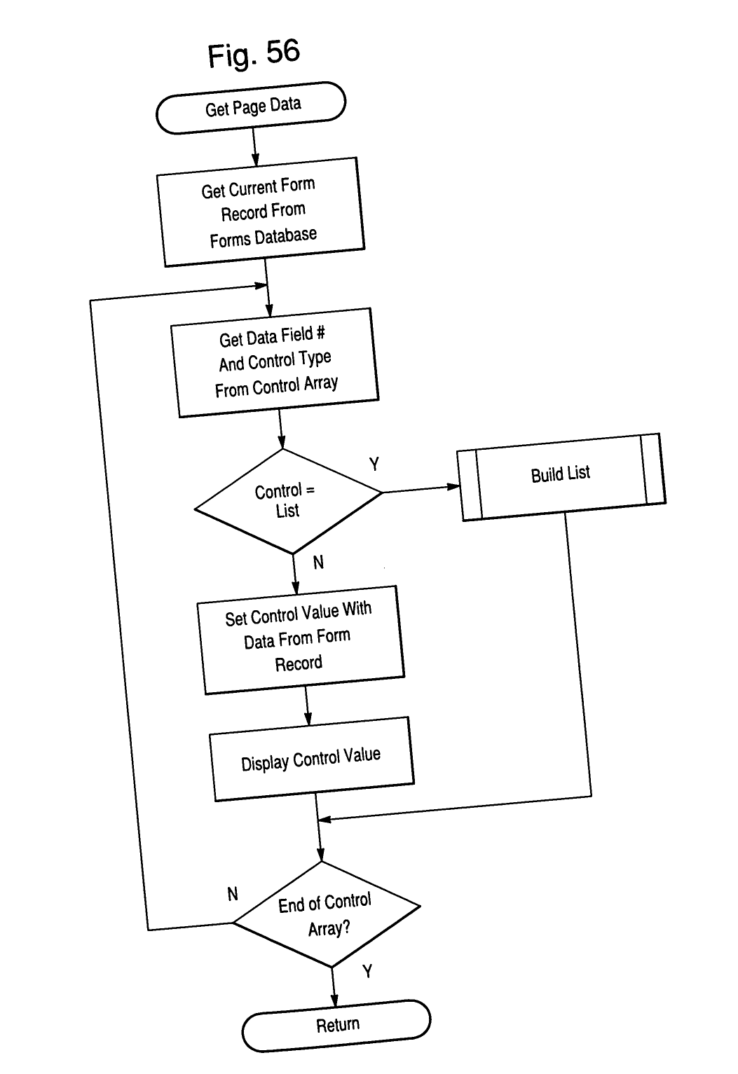

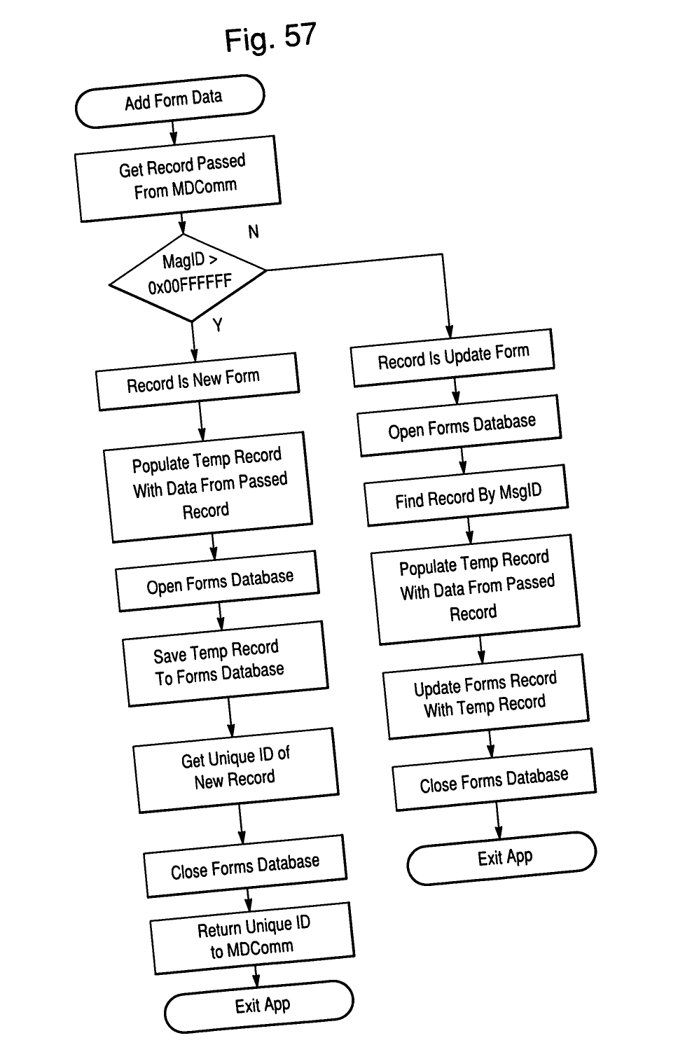

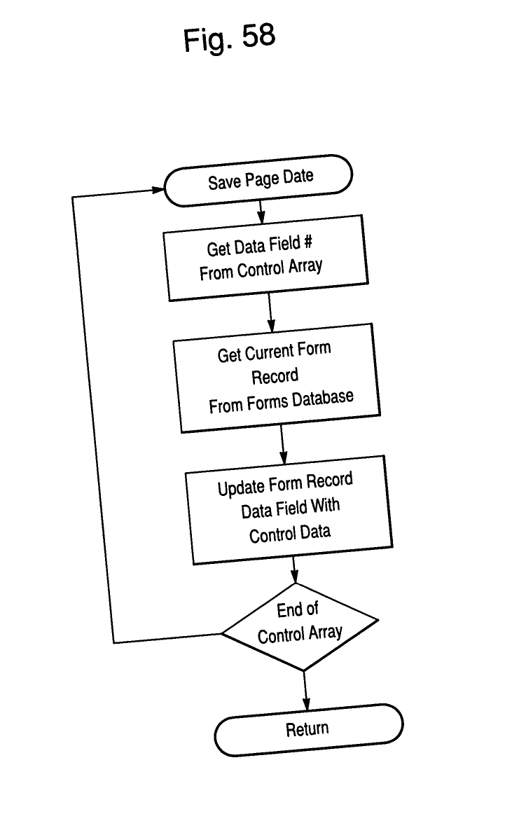

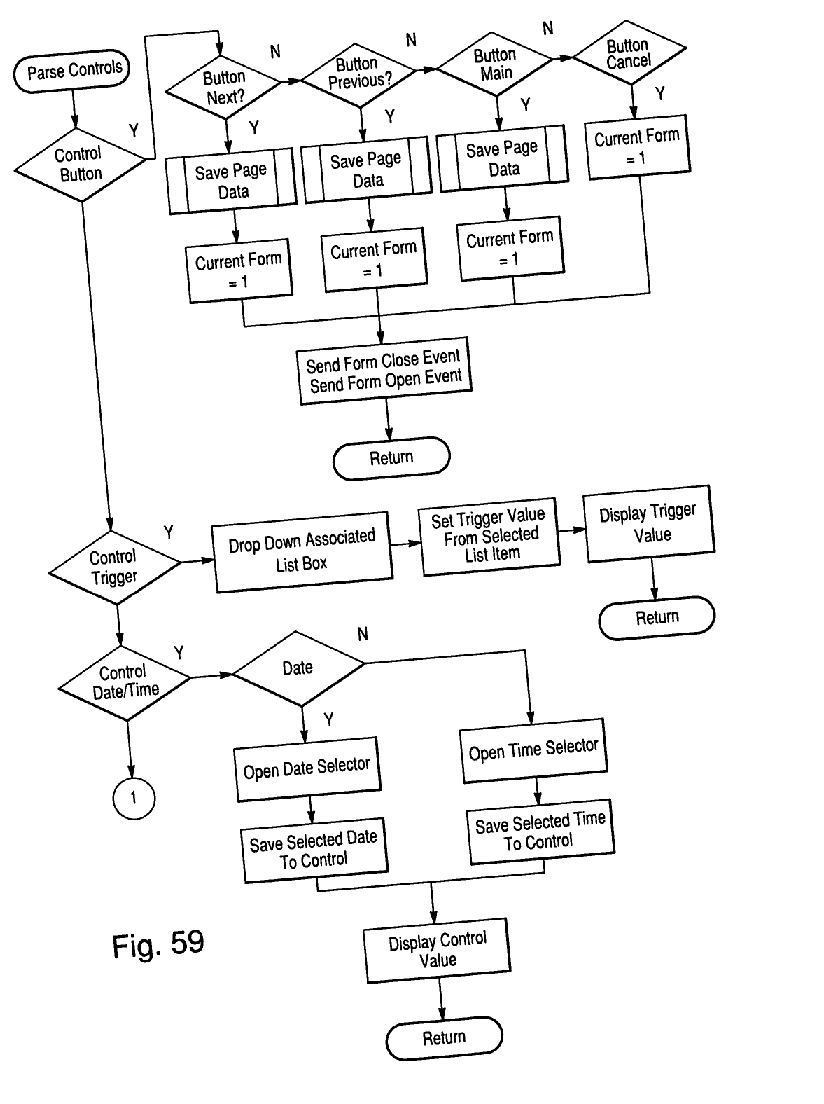

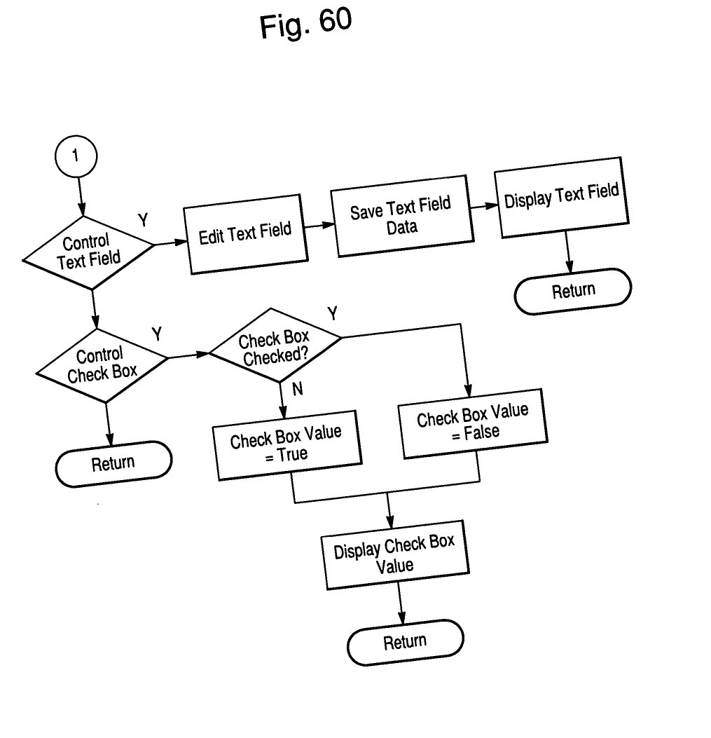

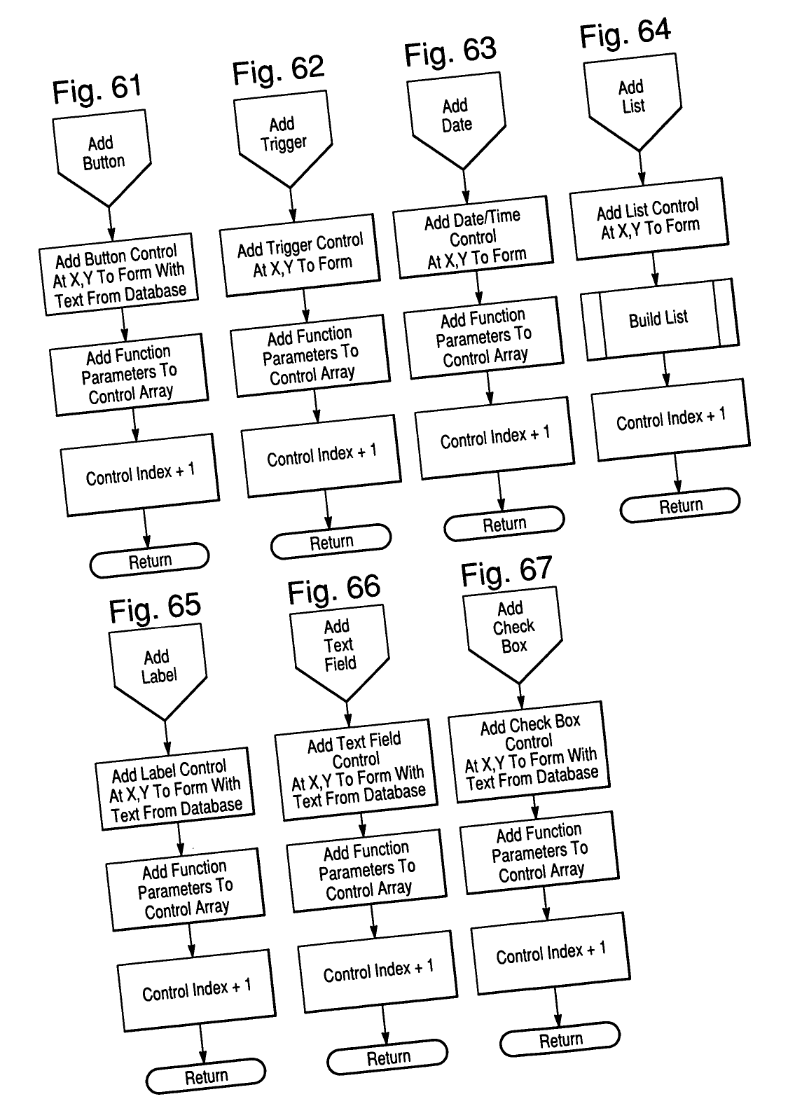

Referring now to the flow diagrams of FIGS. 52-67, the forms program uses three distinct databases, two of which are static, and the other Volatile. The first database (referred to as the “static info database” in the flow diagram of FIG. 52) contains informational data such as client information and inventory data. This information is created on the user's host computer and then loaded on to the mobile device 118 from the user's host computer. The second database (referred to as the “controls database” in the flow diagram of FIG. 52) contains information about the elements and layout of each form. This is also loaded on the mobile device 118 when the user updates the informational database. The third database (referred to as the “forms database” in the flow diagram of FIG. 52) is the only one that is directly modified by the Forms program, and includes all the data contained in each form. The third database is updated when the user changes fields in a form. These records are also used to create the data packets when information is sent over the air to the main database on the user's host computer. Preferably the three databases are encrypted and password protected.

Each form consists of a collection of controls stored in the Control database. Every control has unique properties and options that determine how it interacts with the databases and the user. This allows each control on the form to be customized to perform a wide range of actions. Depending on how the control is configured, it may perform some action on the current form or can open a sub-form which allows for a very complex form to be created with a very powerful user interface. Because these controls are directly coded in the program, forms can easily be modified to a user's various needs. The various types of controls that can be placed on a form at design time (or during form definition or creation) are as follows:

Label—Static text that is placed on the form to describe field names

Text Field—Text information that can be retrieved from the Informational Database or the Forms database. Options can be set to determine source field when the form loads and the destination field when form is saved. This can also be set to be non-editable by the user.

Date/Time Selector—when the user selects this control, a popup screen appears, allowing date or time to be displayed on the form.

Popup List—When selected, the user is presented with a list of item to select from. The items in contained in this list can created at design time or loaded from the informational database when the form opens.

Check Box—This is a simple yes/no selection

Button—Performs a predefined function base on type of button. These actions can either react with the database or be links to other forms or sub forms

Pre-defined function buttons can include the following functions: OPEN, CLOSE, NEW, SAVE, CANCEL, DELETE, ADD, CREDIT, and INVENTORY.

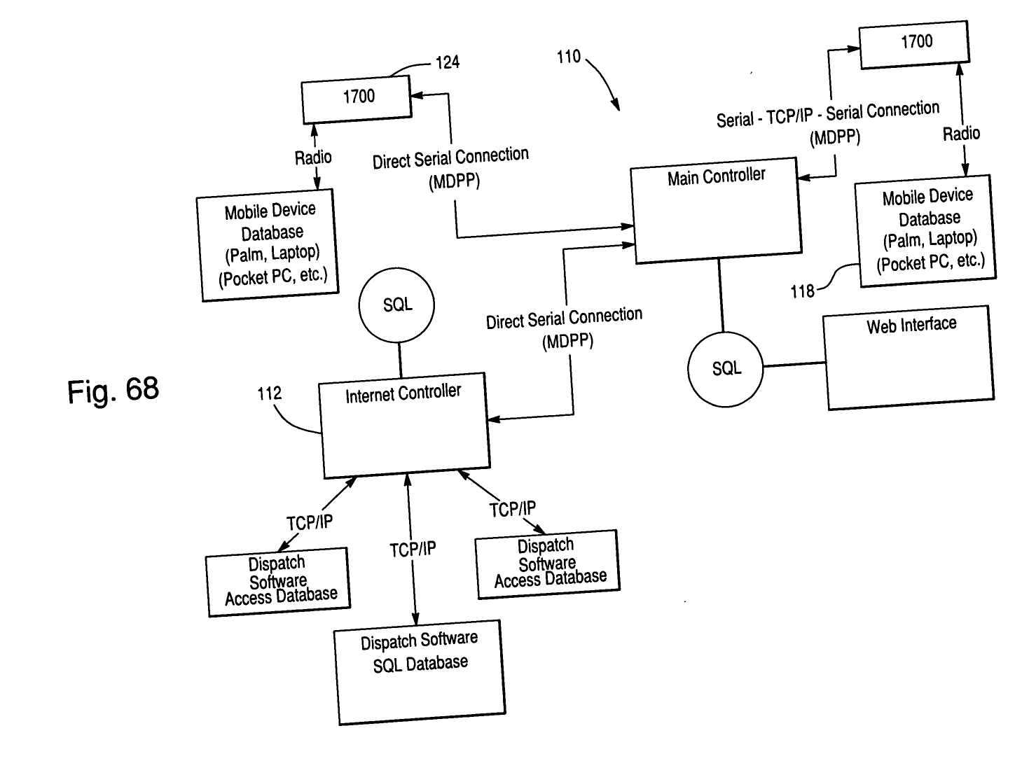

As best seen in FIG. 68, the form database is preferably stored in the Mobile device 118 and in each user's remote base system 124,

(D) Mobile Data—Forms

(1) Forms Design—

Form templates are created with a PC-based GUI program. Each form consists of a collection of controls stored in the Control database. Every control has unique properties and options that determine how it interacts with the databases and the user. This allows each control on the form to be customized to perform a wide range of actions. Depending on how the control is configured, it may perform some action on the current form or can open a sub-form that allows for a very complex form to be created with a very powerful user interface. Because these controls are not directly coded in the program code, forms can easily be modified to a user's various needs.

The various types of controls that can be placed on a form at design time (or during form definition or creation) are as follows:

Label—Static text that is placed on the form to describe field names

Text Field—(FIG. 48) Text information that can be retrieved from the Informational Database or the Forms database. Options can be set to determine the “source” field to be used when the form loads and the “destination” field when the form is saved. This can also be set to be non-editable by the user.

Date/Time Selector—(FIG. 50) when the user selects this control, a popup screen appears, allowing date or time to be displayed on the form.

Popup List—(FIG. 46) When selected, the user is presented with a list of items and can make a selection from the list. The items in contained in this list can created at design time or loaded from the informational database when the form opens.

Check Box—(FIG. 51) This is a simple yes/no selection

Button—(FIG. 46) Performs a predefined function based on the type of button. These functions or actions can either react with the database or be links to other forms or sub-forms. Pre-defined function buttons can include the following functions: OPEN, CLOSE, NEW, SAVE, CANCEL, DELETE, ADD, CREDIT, and INVENTORY.

For each page in a form, the user/designer selects the desired types of controls to be placed on the form and places them on a simulated screen that illustrates what the user of the Mobile Control Head 118 would see when using the forms program. Next, attributes for each control can be set. These attributes can determine whether the control is initially populated with data from a static database or the forms database itself (i.e. an existing form). Also this is used to determine the field in the forms database in which the data contained by the control will be stored. Depending on the type of control, other attributes may apply, such as fixed items for a popup list, or whether a field is editable bythe forms user. Once completed, this information is compiled into a Controls database structure which is then downloaded to mobile control head 118,

This database is used by the forms program to determine the layout and to determine, functionally, how the forms user interacts with each page in a form.

(2) Forms Database—

Referring now to the flow diagrams of FIGS. 52-67, the forms program uses three types of database structures, two of which are “static” and not editable by the control head user, and the other “volatile”. Depending on the operating system used by the Control Head 118, this data is stored in a single database file with separate tables for each type of data, or as in the Palm OS environment, as separate database files. The first type of data (referred to as the “static info database” in the flow diagram of FIG. 52) contains informational data such as client information and inventory data. This information is created on the user's host computer and then loaded on to the mobile device 118 from the user's host computer. The second type data (referred to as the “controls database” in the flow diagram of FIG. 52) contains information about the elements and layout of each form. This is also loaded on the mobile device 118 when the user updates the informational database. The third type (referred to as the “forms database” in the flow diagram of FIG. 52) is the only one that is directly modified by the Forms program, and includes all the data contained in each form. The third database is updated when the user changes field data in a form. These records are also used to create the data packets when information is sent over the air to the main database on the user's host computer. Preferably the three databases are encrypted and password protected with three levels of security. The first level of protection is a user-selectable password and timeout period, such that after a time period determined by the user, a control head user must enter a password to gain access to the program and its' data. The second level of protection requires that control head communicate with the Dispatch center 130 at a predetermined time period. When this time period expires the user will not have access to the program or its' data until communications with the Dispatch Center have resumed. This time period is programmed and stored in the Dispatch Center 130, and cannot be changed from the control head 118, Optionally, Dispatch Center 130 may set a “Time To Live” period for the forms program and its' data. If control head 118 does not communicate with the Dispatch Center 130 within the pre-programmed “time to live” time, the Forms program and its' associated data will be erased form the unit's memory. These three levels of security provide protection in the event the unit is lost, stolen or in case the user ceases his or her relationship with the company operating dispatch center 130,

(3) Forms User Operation Example—

When the user starts the forms program, they are presented with a main screen (FIG. 44). From this screen, the user has the option to select a client from a list that is populated from a static database created on the user's host computer. When a user's client is selected from the list, appropriate fields on the form are populated from information in the database associated with the selected client. From this point, the user can select a form from a list of available forms loaded on a mobile device such as control head or Personal Digital Assistant (PDA) (e.g., 118). The user is then presented with a list of open forms of this type for the selected client. At this point, a new form can be opened, or an existing form can be opened for further action. The forms database is then searched for the proper record, and the selected form is opened and populated with data from this record. Once the user is finished with the form, its contents are stored in the database, and the user is returned to the main screen. As best seen in FIG. 68, the form database is preferably stored in the Mobile device 118 and in each user's Dispatch Center 130,

### XI Overview of Exemplary Embodiments

Generally speaking, persons of skill in the art will appreciate that the method and apparatus of the present invention provides a number of improvements in mobile wireless data telemetry. Features of the exemplary embodiments described above include improvements in may areas

(A) Transmitting Form Data when in the Field:

In accordance with the present invention, a method for transmitting data for use in an electronically stored and processed document or form having blanks or data entry fields for insertion of details or information from a mobile wireless data entry terminal 117 to a remote location includes the method steps of:

(a) displaying a first electronically stored form having a first blank data entry field for insertion of details or information and a second blank data entry field to a user of the mobile wireless data entry terminal 117;

(b) detecting a first input change in one of the first data entry field and second data entry field (e.g., as shown in FIG. 44) in response to a first user action sensed by the mobile wireless data entry terminal; and

(c) transmitting solely the data corresponding to the first input change in the first or second data entry field from the mobile wireless data entry terminal to a wireless receiver (e.g., 134) at the remote location.

Optionally, the form data transmission method also includes some or all of the following steps:

(d) detecting a second input change in the other of the first data entry field and second data entry field in response to a second user action sensed by the mobile wireless data entry terminal;

(e) transmitting solely the data corresponding to the second input change in the first or second data entry field from the mobile wireless data entry terminal to the wireless receiver at the remote location;

(f) providing an electronically displayed new form selection field visible to the user of the mobile wireless data entry terminal;

(g) detecting a third input change in the new form selection field in response to a third user action sensed by the mobile wireless data entry terminal;

(h) creating a record for a new form definition in response to the third input change detection;

(i) detecting an input change in the new form definition in response to a fourth user action sensed by the mobile wireless data entry terminal;

(j) defining a first new form data entry field in response to the detected change in the new form definition; the first new form data entry field having a first new form data entry field name;

(k) displaying the first new form data entry field name to the user of the mobile wireless data entry terminal;

(l) storing the new form definition in a memory in the mobile wireless data entry terminal; and

(m) transmitting the new form definition from the mobile wireless data entry terminal to the wireless receiver at the remote location.

(B) Defining a Form Using Control Head 118 (e.g., a PDA) when in the Field:

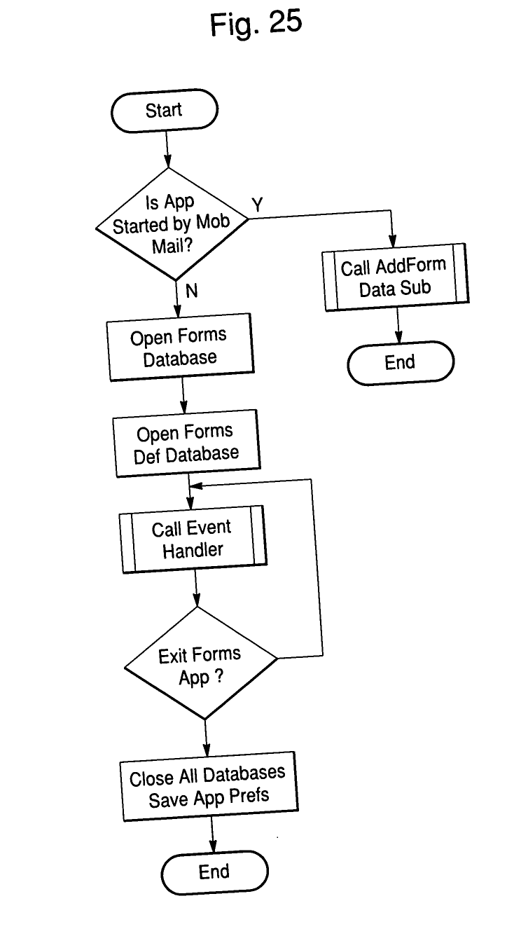

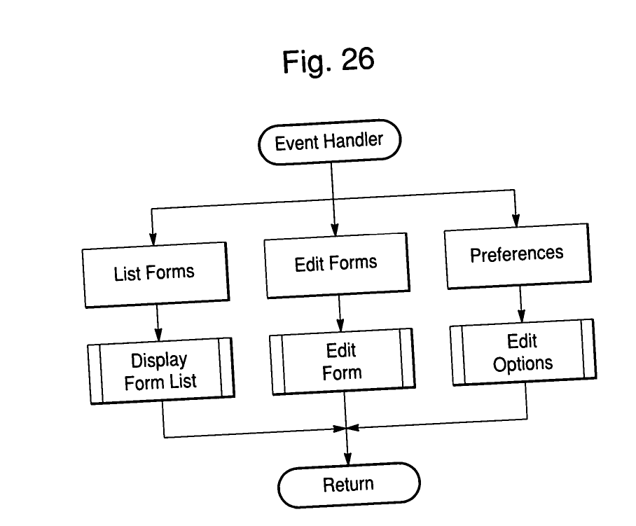

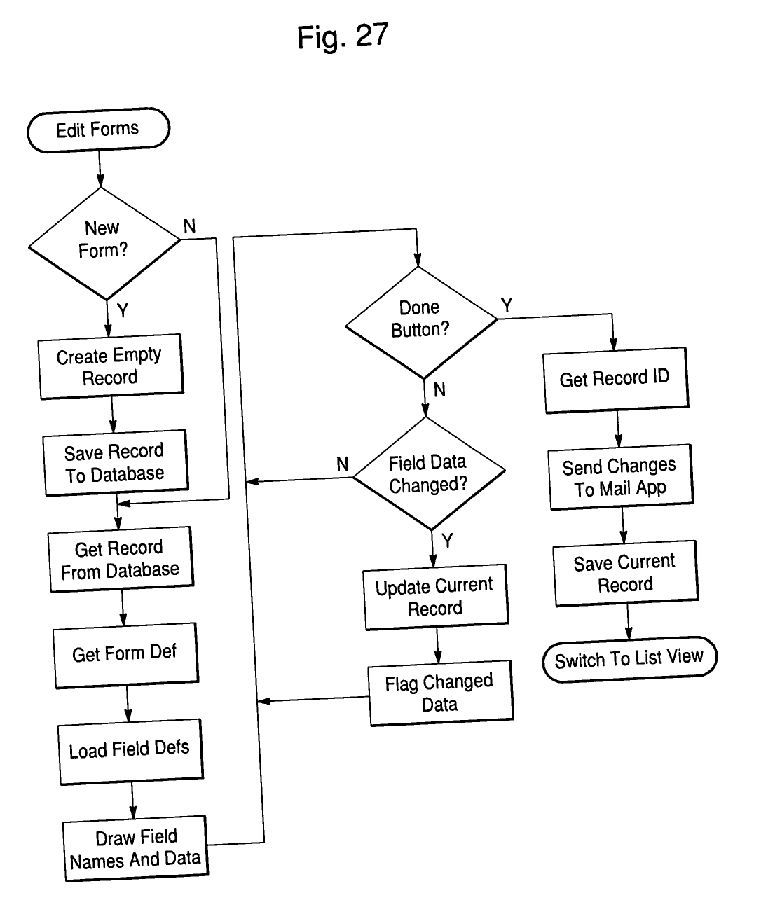

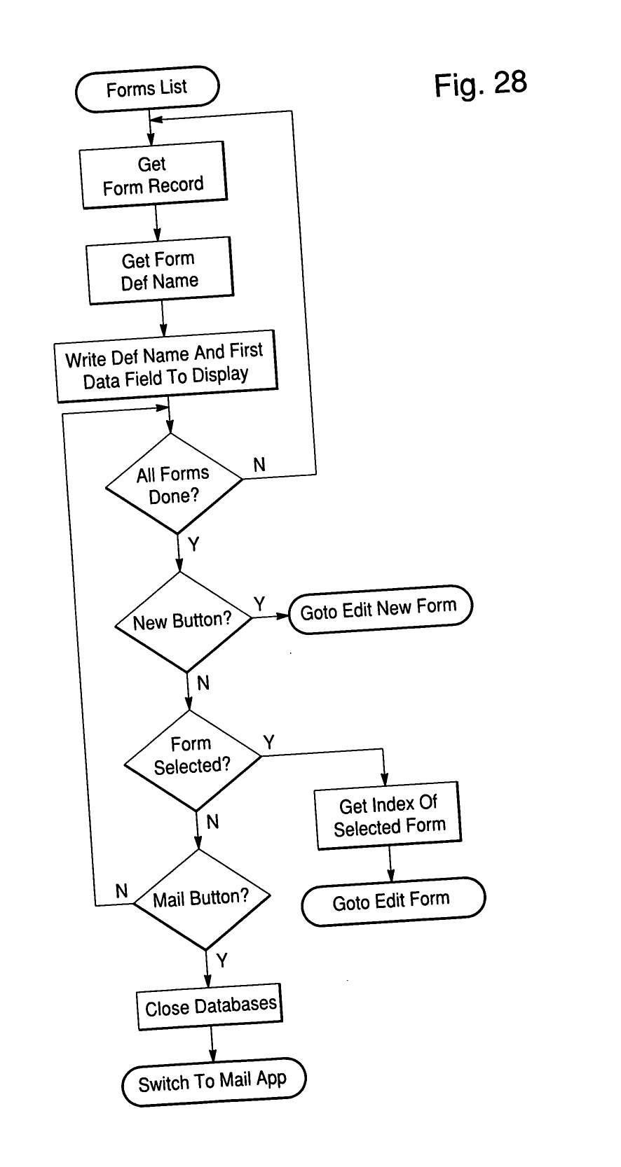

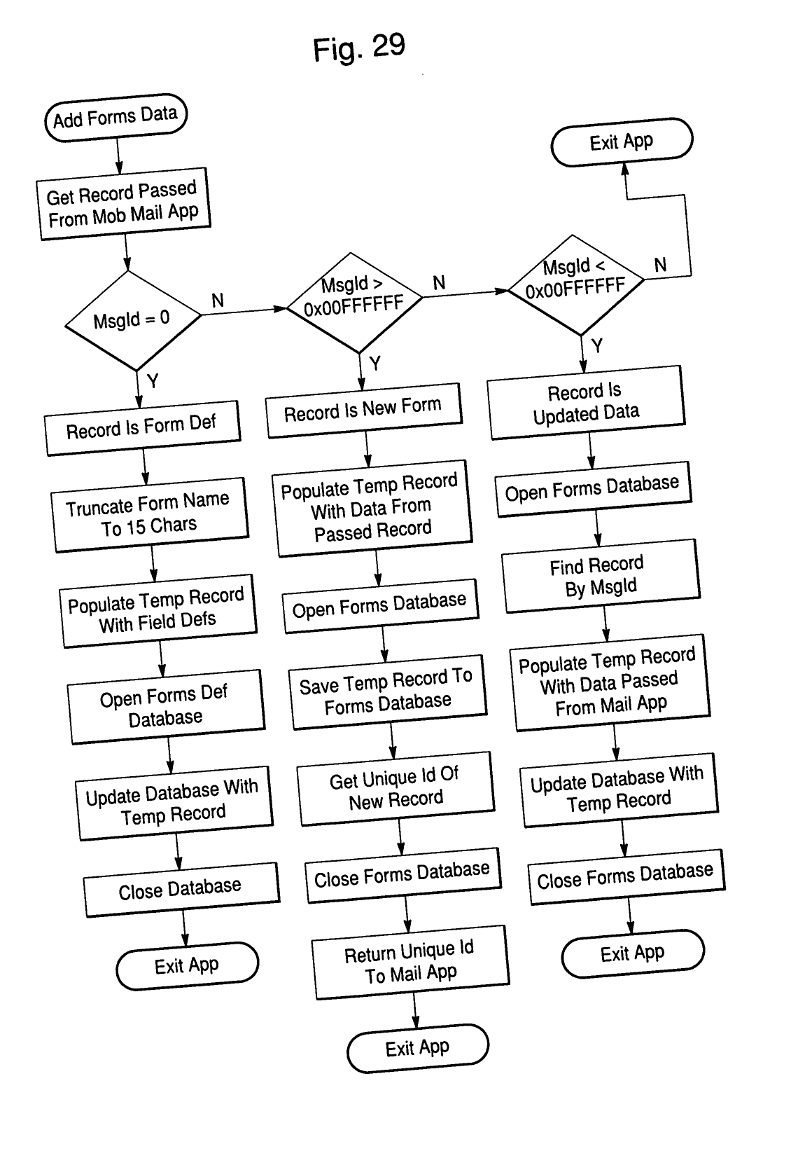

In accordance with the present invention, a method for defining an electronically stored and processed document or form having blanks or data entry fields for insertion of details or information when using a mobile wireless data entry terminal 117, in the field, is illustrated in FIGS. 25-29 and includes the method steps of:

(a) providing a mobile wireless data entry terminal including an RF transceiver for transmission over government licensed frequencies and a control head including a display permitting a user to see a displayed data entry field, wherein the control head is configured to sense user actions on the displayed data entry field (e.g., as shown in FIGS. 6, 7 and 41);

(b) providing an electronically displayed new form selection field visible to a user of the mobile wireless data entry terminal (e.g., as shown in FIGS. 44-51);

(c) detecting a change in the new form selection field in response to a first user action sensed by the mobile wireless data entry terminal;

(d) creating a record for a new form definition in response to the first user action; and

(e) displaying the new form definition including displayed criteria.

Optionally, the method for defining a form may also includes some or all of the following method steps:

(f) detecting a change in the new form definition in response to a second user action sensed by the mobile wireless data entry terminal;

(g) defining a first new form data entry field in response to the detected change in the new form definition; the first new form data entry field having a first new form data entry field name;

(h) displaying the first new form data entry field name to the user of the mobile wireless data entry terminal;

(i) storing the new form definition including the new form data entry field name in a memory in the mobile wireless data entry terminal;

(j) transmitting the new form definition from the mobile wireless data entry terminal to the wireless receiver (e.g., 134) at the remote location;

(C) Modifying an Existing Form:

In accordance with the present invention, a method for modifying or editing an electronically stored document or form having blanks or data entry fields for insertion of details or information when using a mobile wireless data entry terminal in the field, includes the method steps of:

(a) providing a mobile wireless data entry terminal 117 including an RF transceiver for transmission over FCC licensed frequencies and a control head including a display permitting a user to see a displayed data entry field, wherein the control head is configured to sense user actions on the displayed data entry field;

(b) providing an electronically displayed saved form selection field visible to a user of the mobile wireless data entry terminal;

(c) detecting a first user action indicating a selected form from the saved form selection field displayed on the mobile wireless data entry terminal;

(d) retrieving a record for the selected form in response to the first user action, the record includes a form definition for the selected form;

(e) displaying the selected form including displayed criteria on the mobile wireless data entry terminal; and

(f) detecting a second user action indicating a desire to modify the selected form definition; wherein the second user action detection step occurs in the mobile wireless data entry terminal.

Digital operation is similar, but utilizes packet data/CDPD/GPRS wireless mobile units that operate on existing wireless telecommunication digital networks, thus replacing the analog “RF transceiver for transmission over FCC licensed frequencies”. As in the above example, mobile GPS data in MDPP format is routed through these digital networks directly to the internet, where it is then sent to the same internet controller as above. From there it is processed by the central controller and routed to the proper customer dispatch center.

Optionally, the method for modifying an existing form may also include the some or all of the following method steps:

(g) detecting a desired change in the selected form in a first selected form data entry field in response to a third user action sensed by the mobile wireless data entry terminal;

(h) modifying the first selected form data entry field in response to the third user action to generate a modified selected form definition; the first selected form data entry field having a first selected form data entry field name;

(i) displaying the first selected form data entry field name to the user of the mobile wireless data entry terminal;

(j) storing the modified selected form definition including the first selected form data entry field name in a memory in the mobile wireless data entry terminal;

(k) transmitting the modified selected form definition from the mobile wireless data entry terminal to the wireless receiver at the remote location;

(l) receiving the modified selected form definition transmitted from the mobile wireless data entry terminal in the wireless receiver at the remote location; the remote location includes a dispatch center including a dispatch center computer;

(m) storing the modified selected form definition including the first selected form data entry field name in a memory in the dispatch center computer;

(n) providing an electronically displayed saved form selection field visible to a user of the dispatch center computer 130, wherein the modified selected form is indicated in the saved form selection field;

(o) detecting a fourth user action indicating the modified selected form has been selected by the dispatch center computer user;

(p) retrieving a record for the modified selected form in response to the fourth user action, the record includes the modified form definition for the selected form;

(q) displaying the modified selected form including displayed criteria on a display connected the dispatch center computer; and

(r) detecting a fifth user action indicating a desire to further modify the modified selected form definition; wherein the fifth user action detection step occurs in the dispatch center.

(D) Geo-Fencinq™ Vehicle Area Monitoring Methods:

In accordance with the present invention, a method for analyzing and displaying time-stamped position data from a mobile wireless data entry terminal having a unique mobile wireless data entry terminal identification indicator, includes the method steps of:

(a) sensing the location of the mobile wireless data entry terminal at a selected time and generating a location data field in response thereto;

(b) storing the location data and the selected time;

(c) generating an MDPP data packet including the location data field, the selected time, and the unique mobile wireless data entry terminal identification indicator;

(d) transmitting the data packet from the mobile wireless data entry terminal to a wireless receiver at a base station equipped with a computer having a display;

(e) defining at least one established norm for a selected parameter selected from mobile wireless data entry terminal location, time, and unique mobile wireless data entry terminal identification indicator;

(f) comparing at least one of the location data field, the selected time, and the unique mobile wireless data entry terminal identification indicator to the established norm; and

(g) generating an alarm data field in the event that the comparison step indicates a condition that does not conform to the established norm.

Optionally, the method may also include some or all of the following method steps:

(h) displaying a map (e.g., as shown in FIGS. 22-24) indicating the location of the vehicle with the vehicle being visually designated as not conforming to the established norm, wherein the step of displaying a map with the vehicle being visually designated as not conforming to the established norm includes displaying the vehicle on the map in a first selected color (e.g., red). Alternatively, the norm is vehicle location , and the alarm data field is generated in the event that the vehicle is not in a selected location.

In another alternative, the norm is vehicle location at a selected time, and the alarm data field is generated in the event that the vehicle is not in a selected location at the selected time.

In another alternative, the norm is vehicle location within a selected geographically bounded area (e.g., a circled area on a map), and the alarm data field is generated in the event that the vehicle is not in a selected geographically bounded area. The selected geographically bounded area is selected by a dispatch center user on the base station computer by identifying an enclosed selected area on a map displayed on the base station computer display.

In another alternative, the norm is vehicle location within a selected geographically bounded area at a selected time, and the alarm data field is generated in the event that the vehicle is not in a selected geographically bounded area at the selected time.

For any of these alternatives, the step of sensing the location of the mobile wireless data entry terminal preferably (but not necessarily) includes sensing signals of three or more Global Positioning System satellites. Other navigation instruments and methods could be used in place of the GPS system 120,

(E) Transmitting Position Data/applications:

In accordance with the present invention, a method for transmitting time-stamped position data from a mobile wireless data entry terminal 117 to a remote location includes the method steps of:

(a) sensing the position of the mobile wireless data entry terminal at a selected time and generating a location data field in response thereto;

(b) storing the position data field with a selected time data field;

(c) determining whether a selected person is present in a vehicle carrying the mobile wireless data entry terminal and, in response, generating a person present/absent data field;

(d) generating a data packet includes the position data field, the selected time data field, the person present/absent data field and a mobile wireless data entry terminal identification indicator; and

(e) transmitting the data packet from the mobile wireless data entry terminal to a wireless receiver at the remote location.

Optionally, the method may also include one or more of the following steps:

(f) comparing a selected parameter includes at least one of the position data field, the selected time data field, the person present/absent data field and the mobile wireless data entry terminal identification indicator to an established norm;

(g) generating an alarm signal in the event that the comparison step demonstrates that the selected parameter does not conform to the established norm; and

(h) transmitting the alarm signal from the mobile wireless data entry terminal to a wireless receiver at the remote location.

The step of sensing the position of the mobile wireless data entry terminal at a selected time may include sensing signals of three or more Global Positioning System satellites (i.e., using GPS receiver 120).

In another alternative, the step of determining whether a selected person is present in a vehicle carrying the mobile wireless data entry terminal includes determining whether an employee, medical patient or other passenger or person of interest is present in the vehicle at a selected time.

A method for transmitting time-stamped position data from a mobile wireless data entry terminal to a remote location includes the method steps of:

(a) sensing the position of the mobile wireless data entry terminal at a selected time and generating a location data field in response thereto;

(b) storing the position data field with a selected time data field;

(c) determining whether a vehicle carrying the mobile wireless data entry terminal is being tampered with and, in response, generating a vehicle tamper status data field;

(d) generating a data packet includes the position data field, the selected time data field, the vehicle tamper status data field and a mobile wireless data entry terminal identification indicator;

(e) transmitting the data packet from the mobile wireless data entry terminal to a wireless receiver at the remote location.

Here again, the step of sensing the position of the mobile wireless data entry terminal at a selected time preferably includes sensing signals of one or more Global Positioning System satellites.

In another alternative, the step of determining whether the vehicle carrying the mobile wireless data entry terminal is being tampered with includes detecting vehicle movement during an interval when the vehicle ignition is off and, in response, generating a signal indicating the vehicle is being moved.

Optionally, the position transmitting method further includes some or all of the following method steps:

(f) generating an alarm signal in response to detecting the vehicle movement during an interval when the vehicle ignition is off;

(g) actuating an audible car alarm in response to the alarm signal;

(f) comparing a selected parameter includes at least one of the position data field, the selected time data field, the vehicle tamper status data field and the mobile wireless data entry terminal identification indicator to an established norm; and

(g) generating an alarm signal in the event that the comparison step demonstrates that the selected parameter does not conform to the established norm.

(F) The MDPP Electronic Communications Protocol:

In accordance with the present invention (and referring to FIGS. 8-16b), an electronic communications protocol method for dynamically establishing and maintaining a communication link between transceivers, includes the steps of:

(a) either (i) selecting a transmit frequency from a stored list of preassigned government (e.g., FCC) licensed frequencies, or (ii) selecting a channel for a packet data/CDPD/GPRS wireless mobile unit operating on an existing wireless telecommunication digital network;

(b) transmitting (on either the transmit frequency or the digital channel), a packet including a first sequence of hex characters ordered as “01 h”, a twelve byte sequence including a numeric identification of the sending unit and a second sequence of hex characters ordered as “02 h”.

Preferably, the MDPP protocol method also includes the following method steps:

(c) transmitting, on the transmit frequency, within the twelve byte sequence, a mode field (preferably at least one byte), a spare byte selected from a MIN personality database, a base identification designator byte, three to six bytes including the numeric identification of the sending unit, and a one or two byte serial number;

(d) transmitting, on the transmit frequency, a one or two byte expansion code selected from the MIN personality database;

(e) transmitting, on the transmit frequency, a three byte identification code identifying the intended destination of the packet;

(f) transmitting, on the transmit frequency, a message field or data stream having a selected length of up to 900 bytes;

(g) transmitting, on the transmit frequency, a third sequence of hex characters ordered as “03 h”; and

(h) transmitting, on the transmit frequency, a two byte check sum field to complete the packet.

(G) New Forms Generation Method:

In accordance with the present invention (and referring now to FIGS. 52-68), a method for defining an electronically stored and processed document or form having blanks or data entry fields for insertion of details or information when using a mobile wireless data entry terminal 117A in the field, includes the method steps of:

(a) providing an electronically displayed “form open” selection field visible to a user of the mobile wireless data entry terminal;

(b) detecting a change in the “form open” selection field in response to a first user action sensed by the mobile wireless data entry terminal;

(c) reading a controls database in response to the first user action; and

(d) displaying a plurality of field types corresponding to selected form data entry fields for possible inclusion in the form definition (e.g., as shown in FIGS. 44-51).

Optionally, the forms generation method also includes one or more of the following method steps:

(e) detecting a change in the form in a selected field type in response to a second user action sensed by the mobile wireless data entry terminal;

(f) adding a first form field type to the form definition in response to the detected change in the form field type; the first one of the form field types having a first new form data entry field name;

(g) displaying the first new form data entry field name to the user of the mobile wireless data entry terminal;

(h) storing the new form definition including the first new form data entry field name in a memory in the mobile wireless data entry terminal; and transmitting the new form definition from the mobile wireless data entry terminal to a wireless receiver at a remote location.

The plurality of field types corresponding to selected form data entry fields for possible inclusion in the form definition preferably include field types permitting the user to add, at a minimum: a button, a trigger, a list, a date, a label, a text field or a check box.

Alternatively, the method may include the following method steps:

(e) detecting a change in the form in a selected field type in response to a second user action sensed by the mobile wireless data entry terminal;

(f) adding a first form field type to the form definition in response to the detected change in the form field type; the first one of the form field types having a first new form data entry field name;

(g) displaying the first new form data entry field name to the user of the mobile wireless data entry terminal;

(h) generating a packet including the first new form data entry field name; and

(i) transmitting the packet from the mobile wireless data entry terminal to a wireless receiver at a remote location.

(H) Data Security

For data within system 100, security of remote data and lost terminal equipment has three levels of protection. All data stored in a remote terminal or mobile unit 116 is encrypted. Simple password protection will protect against unauthorized access to any confidential encrypted data.

A “supervisor selectable time” feature is also available; if remote terminal or mobile unit 116 does not register on the system within a selected time interval (e.g. 30 minutes), the information contained in remote terminal 116 will be locked from that user's view until the remote terminal 116 accesses the system, or if the remote terminal 116 has been identified or marked as “deactivated”, then all information will remained unavailable to that user and the remote terminal 116 will be locked.

A “time to delete” feature is also available; for user selectable time, if remote terminal or mobile unit 116 does not register on system within a selected time interval (e.g. 72 Hours), the information contained in the remote terminal 116 will be deleted and a “full restore” procedure will be required before the remote terminal 116 can be made operational again.

(I) Importation of Text from Internal Programs to Dispatcher Program

Text (e.g., a manifest) may optionally be imported from most internal programs to a dispatcher program running in a given customer's dispatch center 130, During text importation, other information may be assigned; for example, driver information, schedule information, customer contact/account information, appointment/service time, and duration of appointment/service call information may all be assigned. Imported information is interfaced into a current information screen in a grid format as shown in FIGS. 42, 43, During importation, a geo-fence is automatically assigned around the geographic location or physical position of the appointment or service call.

(J) Displaying the Real and Scheduled Routes in Different Colors

At the dispatch center 130, incoming time and position information are processed as received from each remote terminal or mobile unit 116 and that time-stamped position information is compared with the permanent, temporary, or imported manifest. In the preferred embodiment, the actual or real route is displayed simultaneously with the scheduled route and both are displayed in visibly distinguishable colors (i.e., are color coded) in real time, and the remote terminal's time difference is displayed on the computer's screen grid. The color coding scheme assigned to the screen grid identifies drivers that are on-time, behind schedule or ahead of schedule are as follows:

Green Route display—on time (0 difference to manifest)

Red Route display—behind manifest (+time difference)

Yellow Route display—ahead of manifest (−time difference)

(K) UP to 10,000 Permanent Repeat Manifests Stored in Databases

Databases contain preset manifests with “start date” information and “repeat intervals” (e.g., from 1 to 365 days) that will load automatically and will program or preset a given driver's control head 118 with his or her assigned manifests on the proper days. Preset regular routes are stored in a database called “permanent routes.” A route with a “1 day” interval or frequency will schedule that driver every day to run that permanent route and a route with a “7 day” interval runs only every 7^{th} day (and so forth). All preset manifests contain permanent appointments or service calls. Temporary points may be added on any selected day, either for the current day or for an appointment in the future and run as a “one time” manifest, whereupon the temporary point(s) are deleted from the manifest's permanent route.

(L) Preset Terminal Territories

Each remote terminal or mobile unit 116 can be assigned a preset territory. The preset terminal territories are assignable using pre-programmed zip-code boundaries, county, parish or state boundaries. Alternatively, a selected area shaped as a polygon can be designated as a preset terminal territory; any enclosed area drawn on a map can be a territory for an assigned remote terminal 116.

(M) Temporary Manifest one day for Flexible Scheduling

In order to permit flexible scheduling, a dispatcher using the dispatch center 130 can import or create within the program a temporary manifest (e.g., one day). This would be used in companies whose appointments or service calls change every day, and have no fixed or repeating schedule.

(N) On-the-fly Schedule Additions and Subtractions to Manifests

A dispatcher using the dispatch center 130 can make real time or “on-the-fly” schedule changes (e.g., additions or subtractions) to both temporary and permanent manifests. These manifest changes are added or subtracted to the imported manifest and update the remote terminal's real time display.

(O) Geo-fence Adjustments to Permanent Manifest

A dispatcher using the dispatch software can also make “Geo-adjustments” to a permanent manifest, in which a pre-programmed geo-fence is adjusted in size and center point. In addition, pre-programmed contact information associated with that permanent manifest can be changed with the geo-fence.

(P) Driver Documentation Databases

A driver is defined as one or more persons using a remote terminal or mobile unit 116; a user of a dispatch center 130 may require rapid access to information about any one of the drivers in the field and so has access to “driver documentation databases” which provide information in the form of short term notes and information on driver qualifications, equipment or capabilities (e.g., this driver is a qualified master plumber, electrician, paramedic or cosmetologist). The driver documentation databases will accept text based free form data. Information is displayed for the dispatch center user in a color coded visual format such that the driver at a given remote terminal 116 can be identified along with pertinent (e.g., tech qualification) information for that driver, thereby permitting easy assignment of work among a plurality of drivers having multiple combinations of skill sets.

(Q) Mobile Terminal's up to Date Information with+−Times for all Stops

A user of a dispatch center 130 may require rapid access to information about any driver or terminal in the field and so each vehicle in current screen grid has a drop down box which will show that mobile terminal's up-to-date information with estimated +−times for all current, completed and future manifest stops.

This drop down box is called a “Grid quick click” and provides full documentation of a remote's current projected manifest and its actual manifest event times for each location. Each vehicle in a current screen grid as displayed in dispatch center 130 has a drop down box which will show that mobile terminal's up to the minute information with +—times for all current, completed and future manifest stops.

(R) End of day Reports Generator

An end of day reports generator is a software program preferably stored and executed within dispatch center 130; the reports compare actual driver performance to a projected manifest, color coding all projected stops, their location, times and duration, and then also displays any additional stops not showed in projected manifest, and their location, times and duration. The color coding is:

| | |
|---|---|
| Green | on time 0 difference to manifest |
| Red | behind manifest − difference |
| Yellow | ahead of manifest + difference |

Any stop not schedule will be documented but not color coded, making it stand out on report as an additional stop (e.g., lunch stop, break or unauthorized stop).

In as much as the present invention is subject to various modifications and changes in detail, the above description of preferred embodiments is intended to be exemplary only and not limiting. It is believed that other modifications, variations, substitutions and changes will be suggested to those skilled in the art in view of the teachings set forth herein, all of which are part of this invention and are within the intended broad scope of the following claims.

What is claimed is:

1. A method for transmitting data for use in an electronically stored and processed document or form having blanks or data entry fields for insertion of details or information from a mobile wireless data entry terminal to a remote location comprising the method steps of:
(a) displaying a first electronically stored form having a first blank data entry field for insertion of details or information and a second blank data entry field to a user of the mobile wireless data entry terminal;
(b) detecting a first input change in one of said first data entry field and second data entry field in response to a first user action sensed by the mobile wireless data entry terminal; and
(c) transmitting solely the data corresponding to said first input change in said first or second data entry field from the mobile wireless data entry terminal to a wireless receiver at the remote location.

2. The method for transmitting form data of claim 1, further comprising:
(d) detecting a second input change in the other of said first data entry field and second data entry field in response to a second user action sensed by the mobile wireless data entry terminal; and
(e) transmitting solely the data corresponding to said second input change in said first or second data entry field from the mobile wireless data entry terminal to said wireless receiver at the remote location.

3. The method for transmitting form data of claim 2, further comprising:
(f) providing an electronically displayed new form selection field visible to said user of the mobile wireless data entry terminal;
(g) detecting a third input change in said new form selection field in response to a third user action sensed by the mobile wireless data entry terminal;
(h) creating a record for a new form definition in response to said third input change detection;
(i) detecting an input change in said new form definition in response to a fourth user action sensed by the mobile wireless data entry terminal;
(j) defining a first new form data entry field in response to said detected change in said new form definition; said first new form data entry field having a first new form data entry field name; and
(k) displaying said first new form data entry field name to said user of the mobile wireless data entry terminal.

4. The method for transmitting form data of claim 3, further comprising:
(l) storing said new form definition in a memory in the mobile wireless data entry terminal.

5. The method for transmitting form data of claim 4, further comprising:
(m) transmitting said new form definition from the mobile wireless data entry terminal to said wireless receiver at the remote location.

6. A method for defining an electronically stored and processed document or form having blanks or data entry fields for insertion of details or information when using a mobile wireless data entry terminal in the field, comprising the method steps of:
(a) providing a mobile wireless data entry terminal including an RF transceiver for transmission over government licensed frequencies and a control head including a display permitting a user to see a displayed data entry field, wherein the control head is configured to sense user actions on said displayed data entry field;
(b) providing an electronically displayed new form selection field visible to a user of the mobile wireless data entry terminal;
(c) detecting a change in said new form selection field in response to a first user action sensed by the mobile wireless data entry terminal;
(d) creating a record for a new form definition in response to said first user action; and
(e) displaying said new form definition including displayed criteria.

7. The method for defining an electronically stored form of claim 6, further comprising:
(f) detecting a change in said new form definition in response to a second user action sensed by the mobile wireless data entry terminal;
(g) defining a first new form data entry field in response to said detected change in said new form definition; said first new form data entry field having a first new form data entry field name; and
(h) displaying said first new form data entry field name to said user of the mobile wireless data entry terminal.

8. The method for defining a data-entry form of claim 7, further comprising the step of:
(i) storing said new form definition including said new form data entry field name in a memory in the mobile wireless data entry terminal.

9. The method for defining a data-entry form of claim 7, further comprising the step of:
(i) transmitting said new form definition from the mobile wireless data entry terminal to said wireless receiver at the remote location.

10. A method for modifying or editing an electronically stored document or form having blanks or data entry fields for insertion of details or information when using a mobile wireless data entry terminal in the field, comprising the method steps of:
(a) providing a mobile wireless data entry terminal including a transceiver and a control head including a display permitting a user to see a displayed data entry field, wherein the control head is configured to sense user actions on said displayed data entry field;
(b) providing an electronically displayed saved form selection field visible to a user of the mobile wireless data entry terminal;
(c) detecting a first user action indicating a selected form from said saved form selection field displayed on said mobile wireless data entry terminal;
(d) retrieving a record for said selected form in response to said first user action, said record comprising a form definition for the selected form;
(e) displaying said selected form including displayed criteria on said mobile wireless data entry terminal; and
(f) detecting a second user action indicating a desire to modify said selected form definition; wherein said second user action detection step occurs in the mobile wireless data entry terminal.

11. The method for modifying or editing an electronically stored form of claim 10, further comprising:
(g) detecting a desired change in said selected form in a first selected form data entry field in response to a third user action sensed by the mobile wireless data entry terminal;
(h) modifying said first selected form data entry field in response to said third user action to generate a modified selected form definition; said first selected form data entry field having a first selected form data entry field name; and
(i) displaying said first selected form data entry field name to said user of the mobile wireless data entry terminal.

12. The method for modifying a data-entry form of claim 11, further comprising the step of:
(j) storing said modified selected form definition including said first selected form data entry field name in a memory in the mobile wireless data entry terminal.

13. The method for defining a data-entry form of claim 12, further comprising the step of:
(k) transmitting said modified selected form definition from the mobile wireless data entry terminal transmitter to a wireless receiver at a remote location; wherein said transmitting step is accomplished either by transmission over an analog FM communications channel or by transmission over a digital packet data network channel.

14. The method for defining a data-entry form of claim 13, further comprising the step of:
(l) receiving said modified selected form definition transmitted from the mobile wireless data entry terminal in said wireless receiver at said remote location; said remote location comprising a dispatch center including a dispatch center computer.

15. The method for defining a data-entry form of claim 13, further comprising the step of:
(m) storing said modified selected form definition including said first selected form data entry field name in a memory in the dispatch center computer.

16. The method for defining a data-entry form of claim 13, further comprising the steps of:
(n) providing an electronically displayed saved form selection field visible to a user of the dispatch center computer, wherein said modified selected form is indicated in said saved form selection field;
(o) detecting a fourth user action indicating said modified selected form has been selected by said dispatch center computer user;
(p) retrieving a record for said modified selected form in response to said fourth user action, said record comprising said modified form definition for the selected form;
(q) displaying said modified selected form including displayed criteria on a display connected said dispatch center computer; and
(r) detecting a fifth user action indicating a desire to further modify said modified selected form definition; wherein said fifth user action detection step occurs in the dispatch center.

17. A method for analyzing and displaying time-stamped position data from a mobile wireless data entry terminal having a unique mobile wireless data entry terminal identification indicator, comprising the method steps of:
(a) sensing the location of the mobile wireless data entry terminal at a selected time and generating a location data field in response thereto;
(b) storing said location data and said selected time;
(c) generating a data packet comprising said location data field, said selected time, and said unique mobile wireless data entry terminal identification indicator;
(d) transmitting said data packet from the mobile wireless data entry terminal to a wireless receiver at a base station equipped with a computer having a display;
(e) defining at least one established norm for a selected parameter selected from mobile wireless data entry terminal location, time, and unique mobile wireless data entry terminal identification indicator;
(f) comparing at least one of said location data field, said selected time, and said unique mobile wireless data entry terminal identification indicator to said established norm; and
(g) generating an alarm data field in the event that said comparison step indicates a condition that does not conform to said established norm.

18. The method of claim 17, further comprising the steps of:
(h) displaying a map indicating the location of said vehicle with said vehicle being visually designated as not conforming to said established norm.

19. The method of claim 18, wherein said step of displaying a map with said vehicle being visually designated as not conforming to said established norm comprises displaying said vehicle on the map in a first selected color.

20. The method of claim 19, wherein said first selected color is red.

21. The method of claim 17, wherein said norm is vehicle location, and wherein said alarm data field is generated in the event that said vehicle is not in a selected location.

22. The method of claim 17, wherein said norm is vehicle location at a selected time, and wherein said alarm data field is generated in the event that said vehicle is not in a selected location at said selected time,

23. The method of claim 17, wherein said norm is vehicle location within a selected geographically bounded area, and wherein said alarm data field is generated in the event that said vehicle is not in a selected geographically bounded area.

24. The method of claim 23, wherein said selected geographically bounded area is selected by a dispatch center user on said base station computer by identifying an enclosed selected area on a map displayed on said base station computer display.

25. The method of claim 17, wherein said norm is vehicle location within a selected geographically bounded area at a selected time, and wherein said alarm data field is generated in the event that said vehicle is not in a selected geographically bounded area at said selected time.

26. The position transmitting method of claim 17, wherein the step of sensing the location of the mobile wireless data entry terminal comprises sensing signals of three or more Global Positioning System satellites.

27. A method for transmitting time-stamped position data from a mobile wireless data entry terminal to a remote location comprising the method steps of:
(a) sensing the position of the mobile wireless data entry terminal at a selected time and generating a location data field in response thereto;
(b) storing said position data field with a selected time data field;
(c) determining whether a selected person is present in a vehicle carrying the mobile wireless data entry terminal and, in response, generating a person present/absent data field;
(d) generating a data packet comprising said position data field, said selected time data field, said person present/absent data field and a mobile wireless data entry terminal identification indicator;
(e) transmitting said data packet from the mobile wireless data entry terminal to a wireless receiver at the remote location.

28. The position transmitting method of claim 27, wherein the step of sensing the position of the mobile wireless data entry terminal at a selected time comprises sensing signals of three or more Global Positioning System satellites.

29. The position transmitting method of claim 27, wherein the step of determining whether a selected person is present in a vehicle carrying the mobile wireless data entry terminal comprises determining whether an employee is present in the vehicle at a selected time.

30. The position transmitting method of claim 27, wherein the step of
determining whether a selected person is present in a vehicle carrying the mobile wireless data entry terminal comprises determining whether a medical patient is present in the vehicle at a selected time.

31. The position transmitting method of claim 27, wherein the step of
determining whether a selected person is present in a vehicle carrying the mobile wireless data entry terminal comprises determining whether a passenger is present in the vehicle at a selected time.

32. The position transmitting method of claim 27, further comprising the steps of:
(f) comparing a selected parameter comprising at least one of said position data field, said selected time data field, said person present/absent data field and said mobile wireless data entry terminal identification indicator to an established norm; and
(g) generating an alarm signal in the event that said comparison step demonstrates that said selected parameter does not conform to said established norm.

33. The position transmitting method of claim 32, further comprising the steps of:
(h) transmitting said alarm signal from the mobile wireless data entry terminal to a wireless receiver at the remote location.

34. A method for transmitting time-stamped position data from a mobile wireless data entry terminal to a remote location comprising the method steps of:
(a) sensing the position of the mobile wireless data entry terminal at a selected time and generating a location data field in response thereto;
(b) storing said position data field with a selected time data field;
(c) determining whether a vehicle carrying the mobile wireless data entry terminal is being tampered with and, in response, generating a vehicle tamper status data field;
(d) generating a data packet comprising said position data field, said selected time data field, said vehicle tamper status data field and a mobile wireless data entry terminal identification indicator;
(e) transmitting said data packet from the mobile wireless data entry terminal to a wireless receiver at the remote location.

35. The position transmitting method of claim 34, wherein the step of sensing the position of the mobile wireless data entry terminal at a selected time comprises sensing signals of one or more Global Positioning System satellites.

36. The position transmitting method of claim 34, wherein the step of
determining whether the vehicle carrying the mobile wireless data entry terminal is being tampered with comprises detecting vehicle movement during an interval when the vehicle ignition is off and, in response, generating a signal indicating the vehicle is being moved.

37. The position transmitting method of claim 35, further comprising
(f) generating an alarm signal in response to detecting said vehicle movement during an interval when the vehicle ignition is off.

38. The position transmitting method of claim 37, further comprising
(g) actuating an audible car alarm in response to said alarm signal.

39. The position transmitting method of claim 27, further comprising the steps of:
(f) comparing a selected parameter comprising at least one of said position data field, said selected time data field, said vehicle tamper status data field and said mobile wireless data entry terminal identification indicator to an established norm; and
(g) generating an alarm signal in the event that said comparison step demonstrates that said selected parameter does not conform to said established norm.

40. An electronic communications protocol method for dynamically establishing and maintaining a communication link between transceivers, comprising the steps of:
(a) selecting a transmission channel;
(b) transmitting, on said transmission channel, a packet comprising a first sequence of hex characters ordered as “01 h”, a twelve byte sequence including a numeric identification of the sending unit and a second sequence of hex characters ordered as “02 h”.

41. The electronic communications protocol method of claim 40, further comprising:
(c) transmitting, within said twelve byte sequence, a two byte mode field, a spare byte selected from a MIN personality database, a base identification designator byte, six bytes comprising said numeric identification of said sending unit, and a two byte serial number.

42. The electronic communications protocol method of claim 41, further comprising:
(d) transmitting a two byte expansion code selected from said MIN personality database.

43. The electronic communications protocol method of claim 42, further comprising:
(e) transmitting a three byte identification code identifying the intended destination of the packet.

44. The electronic communications protocol method of claim 43, further comprising:
(f) transmitting a data stream having a selected length of up to 900 bytes.

45. The electronic communications protocol method of claim 44, further comprising:
(g) transmitting a third sequence of hex characters ordered as “03 h”.

46. The electronic communications protocol method of claim 45, further comprising:
(h) transmitting a two byte check sum field to complete the packet.

47. A method for defining an electronically stored and processed document or form having blanks or data entry fields for insertion of details or information when using a mobile wireless data entry terminal in the field, comprising the method steps of:
(a) providing an electronically displayed form open selection field visible to a user of the mobile wireless data entry terminal;
(b) detecting a change in said form open selection field in response to a first user action sensed by the mobile wireless data entry terminal;
(c) reading a controls database in response to said first user action; and
(d) displaying a plurality of field types corresponding to selected form data entry fields for possible inclusion in the form definition.

48. The method for defining an electronically stored form of claim 47, further comprising:
(e) detecting a change in said form in a selected field type in response to a second user action sensed by the mobile wireless data entry terminal;
(f) adding a first form field type to said form definition in response to said detected change in said form field type; said first one of said form field types having a first new form data entry field name; and
(g) displaying said first new form data entry field name to said user of the mobile wireless data entry terminal.

49. The method for defining a data-entry form of claim 48, further comprising the step of:
(h) storing said new form definition including said first new form data entry field name in a memory in the mobile wireless data entry terminal.

50. The method for defining a data-entry form of claim 48, further comprising:
(h) transmitting said new form definition from the mobile wireless data entry terminal to a wireless receiver at a remote location.

51. The method of claim 47, wherein said plurality of field types corresponding to selected form data entry fields for possible inclusion in the form definition include a field type permitting the user to add a button.

52. The method of claim 47, wherein said plurality of field types corresponding to selected form data entry fields for possible inclusion in the form definition include a field type permitting the user to add a trigger.

53. The method of claim 47, wherein said plurality of field types corresponding to selected form data entry fields for possible inclusion in the form definition include a field type permitting the user to add a list.

54. The method of claim 47, wherein said plurality of field types corresponding to selected form data entry fields for possible inclusion in the form definition include a field type permitting the user to add a date.

55. The method of claim 47, wherein said plurality of field types corresponding to selected form data entry fields for possible inclusion in the form definition include a field type permitting the user to add a label.

56. The method of claim 47, wherein said plurality of field types corresponding to selected form data entry fields for possible inclusion in the form definition include a field type permitting the user to add a text field.

57. The method of claim 47, wherein said plurality of field types corresponding to selected form data entry fields for possible inclusion in the form definition include a field type permitting the user to add a check box.

58. The method of claim 47, wherein said plurality of field types corresponding to selected form data entry fields for possible inclusion in the form definition include field types permitting the user to add a button, a trigger, a list, a date, a label, a text field or a check box.

59. The method of claim 47, further comprising the method steps of:
(e) detecting a change in said form in a selected field type in response to a second user action sensed by the mobile wireless data entry terminal;
(f) adding a first form field type to said form definition in response to said detected change in said form field type; said first one of said form field types having a first new form data entry field name;
(g) displaying said first new form data entry field name to said user of the mobile wireless data entry terminal;
(h) generating a packet including said first new form data entry field name; and
(i) transmitting said packet from the mobile wireless data entry terminal to a wireless receiver at a remote location.

60. A method for protecting electronically stored and processed information when using a mobile wireless data entry terminal in the field, comprising the method steps of:
(a) providing a mobile wireless data entry terminal including a first RF transceiver and a control head including a memory and a display permitting a user to see a displayed data entry field, wherein said wireless data entry terminal has a unique identifier;
(b) providing a dispatch center including a computer, said dispatch center computer being configured to transmit and receive data via a second RF transceiver;
(c) prompting the mobile wireless data entry terminal control head user to input a password and disabling the wireless data entry terminal control head if said user does not input a password that is identical to a previously programmed password stored in said wireless data entry terminal control head memory, wherein said wireless data entry terminal control head is enabled only if said user does input a password that is identical to said previously programmed password;
(d) if enabled, transmitting a registration signal from said mobile wireless data terminal to said dispatch center; said registration signal comprising at least said wireless data entry terminal unique identifier; and
(e) initiating a timer to measure the elapsed time between when said registration signal is transmitted and the occurrence of at least one predetermined subsequent event, wherein detecting that a reply signal is received from said dispatch center comprises a first predetermined subsequent event.

61. The information protection method of claim 60, further comprising:
(f) receiving said registration signal in said dispatch center and, in response, determining the time of receipt and storing said wireless data entry terminal unique identifier and the time of receipt; and
(g) transmitting a dispatch center confirmation signal to said wireless data entry terminal acknowledging said wireless data entry terminal registration signal.

62. The information protection method of claim 60, wherein detecting that a first selected interval has elapsed since said registration signal was transmitted is a second predetermined subsequent event, and, in response,
(f) transmitting a subsequent registration signal from said mobile wireless data terminal to said dispatch center; said registration signal comprising at least said wireless data entry terminal unique identifier.

63. The information protection method of claim 62, wherein said first selected interval is less than one second.

64. The information protection method of claim 60, further comprising:
(f) disabling the mobile wireless data entry terminal in the event no confirmation signal is received from said dispatch center within a second selected interval.

65. The information protection method of claim 64, wherein said second selected interval is thirty minutes.

66. The information protection method of claim 60, further comprising:
(f) deleting all stored data within the control head unit in the event no confirmation signal is received within a third selected interval.

67. The information protection method of claim 66, wherein said third selected interval is seventy-two hours.

68. The information protection method of claim 66, further comprising:
(g) re-enable said mobile wireless data entry terminal control head only when said mobile wireless data entry terminal is physically returned to said dispatch.

69. A method for importing and modifying an electronically stored and processed manifest having data entry fields for insertion of information pertaining to appointments in a geographic customer service area when using a mobile wireless data entry terminal in the field, comprising the method steps of:
(a) providing an electronically displayable manifest and storing said manifest on a dispatch center computer;
(b) combining said manifest with selected information stored elsewhere, said selected information comprising at least one of the following: driver information, schedule information, customer contact information, account information, appointment time, and duration of appointment; and
(c) displaying said manifest with said selected information in a current information screen for a dispatch center user.

70. The manifest display method of claim 69, further comprising:
(d) automatically displaying a map indicating a bounded customer service area and a location of a vehicle assigned to carry out the appointments described in said manifest.

71. The manifest display method of claim 70, further comprising:
(e) sensing the location of the mobile wireless data entry terminal at a selected time and generating a location data field in response thereto;
(f) storing said location data and said selected time;
(g) generating a data packet comprising said location data field, said selected time, and said unique mobile wireless data entry terminal identification indicator;
(h) transmitting said data packet from the mobile wireless data entry terminal to a wireless receiver at dispatch center;
(i) choosing, from said manifest, at least one established norm for a selected parameter, said parameter being selected from: mobile wireless terminal location, time, and unique mobile wireless terminal identification indicator;
(j) comparing at least one of said location data field, said selected time, and said unique mobile wireless data entry terminal identification indicator to said established norm;
(k) generating an alarm data field in the event that said comparison step indicates a condition that does not conform to said established norm; and
(l) displaying, on said map, an indication that said vehicle is not conforming to said established norm.

72. The manifest display method of claim 71, wherein the established norm is a schedule defined in said manifest.

73. The manifest display method of claim 72, wherein displaying step (I) comprises
displaying a vehicle's route in green when the vehicle's driver is on time according to the manifest, displaying a vehicle's route in red when the vehicle's driver is behind the manifest schedule and displaying a vehicle's route in yellow when the vehicle's driver is ahead of the manifest schedule.

74. A method for processing and displaying an electronically stored manifest having blanks or data entry fields for insertion of details or information about appointments in a customer service area when using a mobile wireless data entry terminal in the field, comprising the method steps of:
(a) providing, on a dispatch center computer, a database containing a plurality of electronically stored pre-set manifests, said manifests including a start date and a repeat interval;
(b) combining said manifest with selected information comprising at least one of the following: driver information, schedule information, customer contact information, account information, appointment time, and duration of appointment;
(c) providing, in a first vehicle with a first driver, a mobile wireless data entry terminal having a control head with a memory and a display;
(d) selecting those manifests pertaining to said selected driver for a selected date;
(e) transmitting only the selected manifests to said selected driver on or before selected date.

75. The manifest processing method of claim 74, wherein said selecting step (d) comprises assigning said selected driver to a pre-set territory within the customer service area.

76. The manifest processing method of claim 74, wherein said selecting step (d) comprises assigning said selected driver a temporary manifest for a selected limited period.

77. The manifest processing method of claim 74, wherein said selecting step (d) comprises assigning a selected driver a changed manifest, and said transmitting step (e) comprises transmitting the changed manifest immediately to the driver, while he or she is traveling.

78. The manifest processing method of claim 74, wherein said selected driver changes said manifest and transmits the changed manifest immediately to the dispatch center.

79. The manifest processing method of claim 78, wherein said driver changes comprise changes to the customer service area or changes to customer contact information.

80. The manifest processing method of claim 74, wherein said database contains a plurality of electronically stored pre-set driver characteristics,

81. The manifest processing method of claim 80, wherein said database of driver characteristics includes information on special skills for each driver,

82. The manifest processing method of claim 81, wherein said selecting step (d) comprises assigning a selected driver skill to a selected customer appointment.

83. The manifest processing method of claim 74, further comprising:
(f) during the day, sensing the location of the driver's mobile wireless data entry terminal at selected times and generating time stamped location data summarizing the day's travel, in response thereto;
(g) storing said time-stamped location data;
(h) transmitting said time stamped location data from the mobile wireless data entry terminal to a wireless receiver at dispatch center;
(i) comparing said manifest to said time-stamped location data;
(j) generating a “difference” indication in the event that said comparison step indicates that said driver's route was ahead of schedule or behind schedule, as compared to the manifest; and
(k) displaying, on said dispatch center display, a map including an indication that said driver's route was ahead of schedule or behind schedule, as compared to the manifest.
